(19) United States
(12) Patent Application Publication
(10) Pub. No.: US 2011/0019693 A1
(43) Pub. Date: Jan. 27, 2011

(54) ADAPTIVE NETWORK SYSTEM WITH ONLINE LEARNING AND AUTONOMOUS CROSS-LAYER OPTIMIZATION FOR DELAY-SENSITIVE APPLICATIONS

(75) Inventors: Fangwen Fu, San Diego, CA (US); Akiomi Kunisa, San Diego, CA (US)

Correspondence Address: MCDERMOTT WILL & EMERY LLP, 600 13TH STREET, N.W., WASHINGTON, DC, 20005-3096, US

(73) Assignees: Sanyo North America Corporation, San Diego, CA (US); Sanyo Electronic Co., Ltd., Osaka (JP)

(21) Appl. No.: 12/508,535

(22) Filed: Jul. 23, 2009

(51) Int. Cl. H04J 3/22

(52) U.S. Cl. 370/469

(57) ABSTRACT

A network system providing highly reliable transmission quality for delay-sensitive applications with online learning and cross-layer optimization is disclosed. Each protocol layer is deployed to select its own optimization strategies, and cooperates with other layers to maximize the overall utility. This framework adheres to defined layered network architecture, allows layers to determine their own protocol parameters, and exchange only limited information with other layers. The network system considers heterogeneous and dynamically changing characteristics of delay-sensitive applications and the underlying time-varying network conditions, to perform cross-layer optimization. Data units (DUs), both independently decodable DUs and interdependent DUs, are considered. The optimization considers how the cross-layer strategies selected for one DU will impact its neighboring DUs and the DUs that depend on it. While attributes of future DU and network conditions may be unknown in real-time applications, the impact of current cross-layer actions on future DUs can be characterized by a state-value function in the Markov decision process (MDP) framework. Based on the dynamic programming solution to the MDP, the network system utilizes a low-complexity cross-layer optimization algorithm using online learning for each DU transmission.

### FIELD OF DISCLOSURE

The present disclosure relates to network systems with advanced cross-layer optimization mechanism for delay-sensitive applications, and more specifically, to network systems that dynamically adapt to unknown source characteristics, network dynamics and/or resource constraints, to achieve optimized performance.

### BACKGROUND AND SUMMARY OF THE DISCLOSURE

In layered network architectures, such as the Open Systems Interconnection (OSI) model, each layer autonomously controls and optimizes a subset of decision variables (such as protocol parameters) based on information (or observations) obtained from other layers, in order to provide services to the layer(s) above. The functionality of each layer is specified in terms of services received from lower layer(s) and services provided to layer(s) above. The layered architectures allows a designer or implementer of the protocol or algorithm at a particular layer to focus on the design of that layer, without being required to consider all the parameters and algorithms of the rest of the stack. The layered architecture is widely deployed in current network designs.

Throughout this disclosure, unless indicated otherwise, the following terms are defined as below:
Wireless user: a transmitter and receiver pair in a wireless network system.
Upper layer: the highest hierarchical layer, such as the application layer.
Lower layer: the bottom layer or the lowest hierarchical layer, such as the physical layer.
Intermediate layer(s): any layer or layers hierarchically below the application layer and above the physical layer, such as MAC layer, network layer, etc., or any combination thereof.

In some conventional network systems, each layer often optimizes its strategies and parameters individually, without information from other layers. This generally results in sub-optimal performance for the users/applications, especially in wireless networks.

Other conventional network systems jointly adapt transmission strategies at each layer, but with drawbacks. One type of solutions is called application-specific solutions, which consider the lower layers as a “black box” and adapt the application layer strategies based on information fed back from the lower layers (e.g. information about the network congestion, packet loss rates etc.). Such approach, however, often ignores the adaptability of lower layers (e.g. transport layer, network layer, MAC layer and physical layer). Another type of conventional solutions dedicate the power of optimization to a centralized optimizer, such as a specific layer (such as the application layer or the MAC layer) or middleware, to drive the adaptation of network parameters and algorithms, by permitting the specific layer or middleware to access internal protocol parameters of other layers. This type of solutions violates the layered network architecture because they require each layer to forward the complete information about its protocol-dependent dynamics and possible protocol parameters and algorithms, to the middleware or system-level monitors. This violation of the layered network architecture creates dependencies among the layers. When a design change occurs in one layer, such change not only affects the concerned layer, but also other layers, thereby requiring a complete redesign of the entire networks and protocols and leading to a high implementation cost.

Furthermore, when conventional approaches jointly adapt transmission strategies at each layer, they often oblige each layer to take actions, such as selecting protocol parameters and algorithms, dictated by a central optimizer. The layers have no freedom to adapt their own actions to the environmental dynamics, such as source and channel characteristics, experienced by each layer. Hence, inherently, each layer loses the authority to design and select its own suite of protocols and algorithms independently, thereby inhibiting the upgrade of the protocols and algorithms at each layer.

Moreover, performance of network systems is affected by factors such as the environment in which the systems operate, system designs, actions by wireless users, time-varying network conditions, application characteristics, etc. Examples of the time-varying network conditions include channel conditions at the physical layer, allocated time/frequency bands at the MAC layer, etc., and examples of application characteristics include packet arrivals, delay deadlines, distortion impacts, etc. For instance, in a wireless network, a wireless user (a transmitter and receiver pair) needs to consider the dynamic wireless network “environment” shaped by the repeated interaction with other users, the time-varying channel conditions and the time-varying traffic characteristics.

The transmission of certain types of data, such as delay-sensitive applications like video streaming, pose challenges to network systems, is subject to stringent requirements and resource constraints, such as hard delay deadlines, various distortion impacts, various packet sizes, tight requirements on power usage, etc. In addition, the quality of transmission is subject to impacts from changes in time-varying network conditions, and need to maintain stable transmission quality irrespective of environment changes. Delays, dropped frames, distorted data, all affect the enjoyment of video streaming. While some network systems are configured to address known environmental interferences, they are insufficient in handling interferences caused by a dynamically changing environment.

Accordingly, there is a need for network systems that can maintain desirable transmission qualities for delay-sensitive applications, by dynamically adjusting the optimization process adaptive to changes from environment. There also is a need for network systems that allow each layer to make autonomous optimization decisions, without violating the layered network architecture. There is an additional need for reliable network systems that adapt to both the heterogeneous and dynamically changing characteristics of delay-sensitive applications and the underlying time-varying network conditions.

This disclosure describes embodiments of a novel network system that address one or more of these needs. In one embodiment, an exemplary network system according to this disclosure provides highly reliable transmission quality for delay-sensitive applications with cross-layer optimization adaptive to environmental changes. In another embodiment, an exemplary network system according to this disclose enables each layer to learn environmental dynamics experienced by that layer, select its own optimization strategies, and cooperate with other layers to maximize the overall utility. This learning framework adheres to defined layered network architecture, and allows layers to determine their own protocol parameters, and exchange only limited information with other layers.

According to one embodiment, an exemplary system considers both the application characteristics and network dynamics, and determines decomposition principles for cross-layer optimization that adheres to the existing layered networks architecture and illustrates the necessary message exchange between layers over time to achieve optimal performance.

In still another embodiment, an exemplary network system considers both the heterogeneous and dynamically changing characteristics of delay-sensitive applications and the underlying time-varying network conditions, to perform cross-layer optimization. Data units (DUs), both independently decodable DUs and interdependent DUs, whose dependencies are captured by a directed acyclic graph (DAG), are considered. Cross-layered optimization is performed by formulating, for each layer, a layer optimization subproblem for each DU and two mater problems. These two master problems correspond to the resource price update implemented at the lower layer, such as physical layer or MAC layer, and the impact factor update for neighboring DUs implemented at the application layer, respectively. Necessary message exchanges between layers are defined for achieving the optimal cross-layer solution. The optimization considers how the cross-layer strategies selected for one DU will impact its neighboring DUs and the DUs that depend on it. In one embodiment, while attributes of future DUs, such as distortion impact, delay deadline, etc., as well as the network conditions are often unknown in the considered real-time applications, in one embodiment, the impact of current cross-layer actions on the future DUs can be characterized by a state-value function in the Markov decision process (MDP) framework. Based on the dynamic programming solution to the MDP, the exemplary system utilizes a low-complexity cross-layer optimization algorithm using online learning for each DU transmission. In one embodiment, online optimization is performed based on information of previous transmitted DUs and past experienced network conditions, and is performed in real-time to cope with unknown source characteristics, network dynamics and resource constraints.

An exemplary communication node for transmitting multiple data units includes a communications device configured to transmit and/or receive data, and a controller configured to form a signal coupling with the communication device. The controller operates according to a multi-layer protocol hierarchy including an upper protocol layer and at least one lower protocol layer hierarchically below the upper layer. For transmitting a respective data unit, the controller is programmed to: (a) at each of the at least one lower protocol layer: determine an optimal action that adjusts parameters of the lower protocol layer to achieve optimized performance of the communication node, according to prospective transmission parameters for transmitting the respective data unit; (b) generate a best response corresponding to the prospective transmission parameters, wherein the best response represents a result of optimization by taking the optimal action at the lower protocol layer; and (c) at the upper protocol layer: determine optimal transmission parameters for transmitting the respective data unit based on the best response; and initiate transmission of the data unit according to the optimal transmission parameters. The communications device transmits the data unit according to the optimal transmission parameters. In one aspect, the controller may assign the calculated optimal transmission parameters as the prospective transmission parameters and repeat steps (a) through (c). In another aspect, each data unit represents one picture frame or one group of picture frames for video transmission. In still another aspect, the transmission parameters include scheduling parameters specifying a starting time for transmitting each data unit and an ending time for transmitting each data unit.

For each respective data unit, the controller may calculate a neighboring impact representing an influence from transmission of the respective data unit to transmission of at least one data unit to be transmitted subsequent to the respective data unit. In one aspect, the neighboring impact may be calculated as a linear function of a starting transmission time and an ending transmission time of the respective data unit. According to one embodiment, the linear function is −μᵢ₋₁xᵢ+μᵢyᵢ, where i is an index of data units; xᵢ is the starting transmission time of data unit i, yᵢ is the ending transmission time of data unit i; μ is an impact factor vector each element μᵢ of which represents the amount of impacts incurred by data unit i to other data units when decreasing the starting transmission time xᵢ or increasing the stopping time yᵢ; and the update of μᵢ is given by μᵢ^{k+1}=max(μᵢ^{k}+βᵢ^{k}(yᵢ−xᵢ₊₁),0), where βᵢ^{k} is an iteration number satisfying

$${\sum }_{k = 1}^{∞} {β}_{i}^{k} = ∞ , {\sum }_{k = 1}^{∞} {( {β}_{i}^{k} )}^{2} < ∞ ,$$

where k is an iteration index.

In another aspect, the neighboring impact is a state value function mapping a state sᵢ of data unit i to total impacts of a respective data unit i to subsequent data units. The state sᵢ may be an amount of transmission time of data unit i occupied by a previous data unit, and is calculated as sᵢ=max(yᵢ₋₁−tᵢ,0), where yᵢ₋₁ is the time when the transmission of data unit i−1 is completed, and t is the time when data unit i is ready for transmission.

According to another aspect of this disclosure, the controller is further configured to calculate a neighboring impact representing an influence to the respective data unit from transmission of a previous data unit to be transmitted prior to the respective data unit; calculate a neighboring impact representing an influence from transmission of the respective data unit to a subsequent data unit to be transmitted subsequent to the respective data unit; and determine the optimal transmission parameters for transmitting the respective data unit based on the best response, the neighboring impact from the previous data unit and the neighboring impact to the subsequent data unit.

At the lower protocol level, the controller may determine the optimal action based on the prospective transmission parameters and expected distortions resulting from the prospective transmission parameters, and the expected distortions may be calculated based on a predefined distortions function and the prospective transmission parameters.

In a further aspect, for data units including a group of interdependently decodable data units with known attributes describing characteristics of the data units, the controller, for transmitting interdependently decodable data unit in the group, is configured to: at each of the at least one lower protocol layer: for each respective interdependently decodable data unit, determine the best response and the optimal action of the lower protocol layer according to (1) the prospective transmission parameters for transmitting the interdependently decodable data unit determined by the upper protocol layer, and (2) preset prospective transmission parameters for transmitting other interdependently decodable data unit in the group; and at the upper protocol layer: determine the optimal transmission parameters for transmitting the interdependently decodable data unit based on the determined best response; and initiate transmission of the interdependently decodable data unit according to the optimal transmission parameters. The attributes of the data units may include at least one of a delay deadline, a distortion impact from the loss of each data unit, data units available for transmission, and size information of each data unit for transmission.

For each respective data unit, the optimal transmission parameters may be determined on the fly without knowing complete attributes describing characteristics of data units to be transmitted subsequent to the respective data unit; and the controller, at the higher layer, determines the optimal transmission parameters for transmitting the respective data unit based on (1) the best response and (2) an estimation function for estimating an impact to subsequent data units from transmission scheduling of the respective data unit.

It is understood that embodiments, steps and/or features described herein can be performed, utilized, implemented and/or practiced either individually or in combination with one or more other steps, embodiments and/or features. It is further understood that inventions according to this disclosure may be implemented using one or more data processors and suitable software incorporating concepts disclosed herein.

Additional advantages and novel features of the present disclosure will be set forth in part in the description which follows, and in part will become apparent to those skilled in the art upon examination of the following, or may be learned by practice of the present disclosure. The embodiments shown and described provide an illustration of the best mode contemplated for carrying out the present disclosure. The disclosure is capable of modifications in various obvious respects, all without departing from the spirit and scope thereof. Accordingly, the drawings and description are to be regarded as illustrative in nature, and not as restrictive. The advantages of the present disclosure may be realized and attained by means of the instrumentalities and combinations particularly pointed out in the appended claims.

### BRIEF DESCRIPTION OF THE DRAWINGS

The present disclosure is illustrated by way of example, and not by way of limitation, in the accompanying drawings, wherein elements having the same reference numeral designations represent like elements throughout and wherein:

FIG. 1 shows an exemplary network system upon which the present invention may be implemented;

FIG. 2 illustrates interactions between exemplary states, internal actions and external actions of protocol layers in a cross-layer optimization architecture;

FIG. 3 shows further details of states, actions and state transitions of layers in exemplary cross-layer optimization architecture;

FIGS. 4A and 4B depict a block diagram of an exemplary communication node implementing cross-layer optimization;

FIGS. 5A and 5B are a schematic block diagram of an exemplary communication node implementing layered learning adaptive to changes in environmental dynamics;

FIG. 6 is a schematic flow chart showing the operations of the system of FIGS. 5A and 5B, with time reference;

FIG. 7 illustrates operations of the lower optimization and upper optimization;

FIG. 8 is a flow chart showing exemplary steps performed for solving a CK-CLO problem for independent DUs using algorithm 2;

FIG. 9 shows an exemplary DAG for video frames;

FIG. 10 is a flow chart showing exemplary steps performed for solving the CK-CLO problem for independent DUs using algorithm 3; and

FIG. 11 shows a flow chart illustrating the operation for online optimization using learning.

### DETAILED DESCRIPTIONS OF ILLUSTRATIVE EMBODIMENTS

In the following description, for the purposes of explanation, numerous embodiments and specific details are set forth in order to provide a thorough understanding of the present disclosure. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and multiple prime notations are used to indicate similar elements in alternate embodiments. In other instances, well-known structures and devices are shown in block diagram form in order to avoid unnecessarily obscuring the present disclosure. It will be apparent, however, to one skilled in the art that concepts of the disclosure may be practiced or implemented without these specific details.

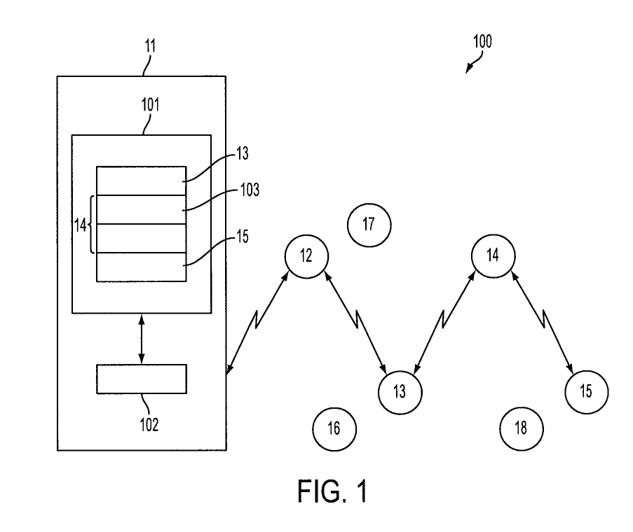

FIG. 1 illustrates an exemplary network system 100 upon which the present invention may be implemented. Network system 100 includes a plurality of communication nodes 11-18. Each communication node 11-18 may be any suitable types of communication devices capable of communicating with other devices in a wired or wireless manner or the combination thereof. Examples of communication nodes include computers, mobile phones, routers, base stations, etc.

For illustration purpose, communication node 11 is shown as a mobile node including a wireless communication device 102 and a controller 101. By way of example, controller 101 may be implemented using microprocessors, memory, software, etc. or any combination thereof, as will be appreciated by those of skill in the art. For simplicity of illustration, additional devices and circuitries, such as memory chips, storage systems, displays, etc., are not shown. Wireless communications device 102 may include wireless modems, wireless local area network (LAN) devices, cellular telephone devices, transceivers, etc., as well as suitable antenna(s), if necessary. It will be understood that other communication nodes also include suitable wired or wireless communications devices/controllers as well, which are not shown in FIG. 1 for clarity of illustration.

Under the control of controller 101, one or more routes are established between node 11 and 15 for transferring data therebetween. While a single route is illustrated it is understood that any number of routes may be used. The routes used for transferring data may include any number of intermediate nodes depending upon network size and proximity between the nodes. Each intermediate node along a route is typically referred to as a “hop.” The routes may be one-hop or multiple-hops routes. The way in which controller 101 establishes routes depends upon the particular routing protocol being implemented in system 100.

Data communications within system 100 follow a preset architecture, such as the open system interconnection (OSI) architecture. The OSI is a network protocol hierarchy which includes seven different hierarchical control layers including, from highest to lowest, the application layer, presentation layer, session layer, transport layer, network layer, data link layer, and physical layer. Generally, in the OSI model control is passed from one layer to the next at an originating node or terminal starting at the application layer and proceeding to the physical layer. The data is then sent across the network, and when it reaches the destination terminal/node, it is processed in reverse order back up the hierarchy (i.e., from the physical layer to the application layer).

In communication node 100, controller 101 operates in accordance with a multi-layer protocol hierarchy 103 to provide an integrated framework for QoS operations. Generally, the multi-layer protocol hierarchy includes an upper protocol layer 13, such as the application layer; one or more intermediate protocol layers 14, such as MAC layer, network layer, etc.; and a lower protocol layer 15, such as the physical layer.

### Autonomous Cross-Layer Optimization and Online Learning

An embodiment of this disclosure embodies autonomous cross-layer optimization in exemplary network system 100, which allows each layer in the protocol hierarchy to learn network dynamics experienced by that layer and make autonomous decisions to maximize the wireless user's utility by optimally determining what information should be exchanged among layers. This cross-layer framework preserves the current layered network architecture. Since the user interacts with the wireless environment at various layers of the protocol stack, the cross-layer optimization problem is solved in a layered fashion such that each layer adapts its own protocol parameters and exchanges information (messages) with other layers in order to cooperatively maximize the performance of the wireless user. Detailed operation of autonomous cross-layer optimization in network system 100 is now described.

For purpose of illustration, an autonomous wireless user, such as communication node 11, transmits its time-varying traffic to another communication node over a one-hop wireless network, such as wireless LAN, cellular network, etc., utilizing cross-layer optimization. The wireless user autonomously adapts its transmission strategies at the APP, MAC and PHY layers in order to maximize its utility. Since one-hop network is utilized, the transmission strategies at the transport layer and network layer are not considered. However, it is understood that the same concept may be implemented in multiple-hop networks by addressing strategies in additional layers.

In the exemplary network system, there are L participating layers in the protocol stack. Each layer is indexed lε{1, . . . , L} with th layer 1 corresponding to the lowest participating layer (e.g. PHY layer) and layer L corresponding to the highest participating layer (e.g. APP layer). If one layer does not participate in the cross-layer design, it can simply be omitted. The exemplary network system performs cross-layer adaptation of the L layers in order to maximize its own utility. The exemplary cross-layer optimization framework is general and can be applied in different wireless network settings and can involve a variety of network protocols.

In the first embodiment, the exemplary system 100 is used to transmit delay-sensitive applications. An example is wireless multimedia data streaming. The channel access can be based on selected protocols, such as time division multiple access (TDMA), or asynchronous code division multiple access (A-CDMA), etc.

In the PHY layer, the wireless user may experience the channel noise (e.g. additive Gaussian noise) and interference from the other users, due to imperfect synchronization or code design. In cellular networks, interference can also be incurred from neighboring cells. It is understood that other types of interference may occur.

The channel quality experienced by the wireless user is represented by the Signal to Interference and Noise Ratio (SINR) which is determined by the transmission power, channel noise and interference. When the power allocation is known, the channel quality is often modeled as a finite state Markov chain (FSMC). In this example, the channel quality is modeled as an FSMC with the state transition being controlled by the power allocation. Given the SINR, the wireless user also adapts the modulation schemes to determine the service provided to the upper layers.

In the MAC layer, if the channel access is based on TDMA, the amount of time allocated to the wireless user during one time slot depends on the scheduling algorithm deployed in the network, e.g. the predetermined scheduling in 802.11e HCF, or the repeated resource competition. In the resource competition scenario, the wireless user will need to autonomously and dynamically compete for transmission time with other users. In both resource management scenarios, an FSMC having as states the amount of time allocated to the wireless user may be used to model the resource allocation process. However, the state transition of the FSMC is determined by the user's strategies to compete for the network resources with other wireless users (e.g. the bid strategy in the resource auction game in the MAC layer). If the resource allocation is predetermined, the process is then controlled by a constant action. This model can capture the dynamics experienced by a user due to the multi-user interaction. If the channel access is based on A-CDMA, the wireless users can access the channel all the time. The state transition is a special case of FSMC with the state being constant. Besides the resource allocation, the MAC can also perform error control algorithms such as Automatic Repeat request (ARQ) or Forward Error Correction (FEC) to improve the service provided to the upper layers.

In the APP layer, it was assumed that the wireless user generates delay-sensitive traffic. The delay-sensitivity is represented by the delay deadlines after which the packets will expire and thus, they will not contribute to the wireless user's application quality. The number of packets with the various delay deadlines available for transmission are modeled as an FSMC. Since the transmission strategies at the lower layers determines the amount of packets to be transmitted and the source coding algorithms determines the amount of packets to arrive for transmission, the state transition is then controlled by the transmission strategies at the lower layers and the source coding algorithms.

In practice, the dynamic network “environment” is shaped by the repeated interaction of a wireless user with the other users operating in the same network, the time-varying channel conditions and, for delay-sensitive applications, the time-varying traffic characteristics. This dynamic wireless network environment is often difficult to characterize a priori.

In order to achieve satisfactory performance, the exemplary network system jointly adapts the transmission strategies across all the three layers such that the user's utility is maximized, and at the same time adheres to the constraints imposed by the layered network architecture. Furthermore, a proposed network system deploys a layered learning approach to learn the impact of the dynamics on the user utility. This layered learning algorithm allows each layer to autonomously learn the experienced dynamics and other necessary information from other layers, such that the cross-layer strategies can be optimized cooperatively, in an on-line fashion. In this disclosure, for the purpose of illustration, reinforcement learning techniques, such as actor-critic learning, are used to learn the impacts from network dynamics. It is understood that different learning techniques, such as policy learning, Q-learning, actor-critic learning, policy space methods, etc., any new and future learning techniques, or any combinations thereof, may be applied in the exemplary network system to lean the impact from the network dynamics on each respective layer, as described in this disclosure.

In this embodiment, we consider one wireless station transmitting its delay-sensitive traffic to another wireless station (e.g. base station) over a one-hop time-varying wireless network, such as a wireless LAN, cellular network, etc. In this disclosure, one transmitter and receiver pair is referred to as a wireless user. We focus on how a single wireless user can autonomously optimize its cross-layer transmission strategies at various layers of the OSI stack in order to maximize the quality of the supported applications. The structure of the cross-layer optimization can be characterized by defining the states and actions at each layer, and the dependencies within the state transition and utility function. In this illustrative embodiment, since an example using a single hop network is described, we will mainly focus on the cross-layer optimization for the transmission strategies at the APP, MAC and PHY layers. It is understood that the same concepts may be implemented in a multiple-hops network and/or more than three protocol layers. An illustration of the considered cross-layer optimization is now described.

### A. Illustrative Cross-Layer Optimization Example

For simplicity of illustration, system 100 is time-slotted and the wireless user makes decision at the beginning of each time slot. The length of one time-slot is denoted by ΔT and can be determined based on how fast the environment changes.

### PHY Layer Model

The wireless user transmits the delay-sensitive data over a frequency-flat fading wireless channel. The channel gain at time slot k is represented by v^{k}. The wireless user experiences the channel noise, such as additive Gaussian noise, with variance σ², which is time-invariant, and incurred interference I^{k} from the other users. Given the power allocation a_{PHY}^{k}εA_{PHY}, where A_{PHY} is a set of possible power allocations, the Signal-to-Noise Ratio (SNR) is computed as

$${SNR}^{k} = \frac{{v}^{k} {a}^{k} PHY}{{σ}^{2}}$$

when there is no interference from other users, and the Signal-to-Interference and Noise Ratio (SINR) is computed as SINR^{k}=v^{k}a_{PHY}^{k}/(σ²+I^{k}) when there is interference from other users. The SNR or SINR may be defined as the state of the wireless channel at time slot k, and denote it as s_{PHY}^{k}.

Since the interference I^{k} in the multi-user system depends on other users' power allocation, which is the response to the power allocation a_{PHY}^{k-1} of the considered user at time slot k−1, in this disclosure we model the channel state s_{PHY}^{k} as an Finite State Marko Chain (FSMC) model, whose state transition probability p(s_{PHY}^{k}|s_{PHY}^{k-1},a_{PHY}^{k-1}) is determined by the power allocations a_{PHY}^{k-1}. Given the channel state s_{PHY}^{k}, the wireless user can also choose different modulation and coding schemes (which are denoted by b_{PHY}^{k}εB_{PHY}, with B_{PHY} being the set of possible modulation and coding schemes) in order to provide different trade-offs between an increased transmission rate and an increased reliability. This trade-off can be characterized by a quality of service (QoS) set, which is given by

$${}_{PHY} ( {s}_{PHY}^{k} ) = \{ \begin{matrix}( {t}_{PHY} , {ɛ}_{PHY} ) \vert {t}_{PHY} = {f}_{PHY}^{t} ( {s}_{PHY}^{k} , {b}_{PHY}^{k} ) , \\ {ɛ}_{PHY} = {f}_{PHY}^{ɛ} ( {s}_{PHY}^{k} , {b}_{PHY}^{k} ) , {b}_{PHY}^{k} ∈ {B}_{PHY}\end{matrix} \} , \qquad ( 1 )$$

where t_{PHY} represents the transmission time per packet and ε_{PHY} represents the packet loss rate, and ƒ_{PHY}^{t} and ƒ_{PHY}^{ε} are functions mapping the current state s_{PHY}^{k} and modulation and coding scheme b_{PHY}^{k} into the transmission time per packet t_{PHY} and packet loss rate ε_{PHY}. The exact forms of ƒ_{PHY}^{t} and ƒ_{PHY}^{ε} depend on the particular applications.

### MAC Layer Model

In the MAC layer, we consider that the channel access is based on TDMA, and the amount of time allocated to the wireless user during one time slot depends on the scheduling algorithm deployed in the network, such as the predetermined scheduling in 802.11e Hybrid Coordination Function (HCF), or a repeated resource competition. In the resource competition scenario, the wireless user will need to autonomously and dynamically compete for transmission time with other users. In both resource management scenarios, we can use an FSMC having as states the amount of time allocated to the wireless user during one time-slot to model the resource allocation process. The state at time slot k is denoted by s_{MAC}^{k}. The state transition probability p(s_{MAC}^{k+1}|s_{MAC}^{k},a_{MAC}^{k}) of the FSMC is determined by the user's strategy a_{MAC}^{k}εA_{MAC}. The strategy a_{MAC}^{k} can be a TSPEC request, the bid strategy in the resource auction game or empty when the resource allocation is predetermined. This model can capture the dynamics experienced by a user due to the multi-user interaction. Besides the resource allocation, the MAC can also perform error control algorithms such as Automatic Repeat-reQuest (ARQ) to improve the service provided to the upper layers. The maximum number of the retransmission for each packet is denoted by b_{MAC}^{k}εB_{MAC}. Then, given the QoS set [symbol] _{PHY}(s_{PHY}^{k}) provided by the PHY layer, the QoS set determined by the MAC layer and provided to the APP layer is then given by

$${𝒵}_{MAC} ( {s}_{PHY}^{k} , {s}_{MAC}^{k} ) = \{ \begin{matrix}( {t}_{MAC} , {ɛ}_{MAC} ) \vert \begin{matrix}{t}_{MAC} = {f}_{MAC}^{t} ( {s}_{MAC}^{k} , {b}_{MAC}^{k} , {Z}_{PHY} ) \\ {ɛ}_{MAC} = {f}_{MAC}^{ɛ} ( {s}_{MAC}^{k} , {b}_{MAC}^{k} , {Z}_{PHY} )\end{matrix} , \\ {b}_{MAC}^{k} ∈ {B}_{MAC} , {Z}_{PHY} ∈ {𝒵}_{PHY} ( {s}_{PHY}^{k} )\end{matrix} \} , \qquad ( 2 )$$

where the exact form of f_{MAC}^{t} and f_{MAC}^{ε} are given in equation.

### APP Layer Model

In the APP layer, the wireless user generates delay-sensitive traffic. The delay-sensitivity is represented by the delay deadlines after which the packets will expire and thus, they will not contribute to the wireless user's application quality. The state of the APP layer s_{APP}^{k} is defined as the number of packets with the various delay deadlines available for transmission. Specifically, s_{APP}^{k}=[μ₁^{k}, . . . , μₙ^{k}], where μᵢ^{k} represents the number of packets with life-time i time slots (i.e. the packets will expire after i time slots, if they are not transmitted). At each time slot, given the QoS Z_{MAC}^{k}ε [symbol] _{MAC}(s_{PHY}^{k},s_{MAC}^{k}) provided by the MAC layer, the APP layer can deploy the scheduling algorithm b_{APP}^{k}εB_{APP} (i.e. determining which packets will be transmitted) and will receive the utility g_{APP}^{k}=f_{APP}(s_{APP}^{k},b_{APP}^{k},Z_{MAC}^{k}). We assume that the transition of the state s_{APP}^{k} follows the FSMC model and the transition of the state s_{APP}^{k} is determined by the QoS Z_{MAC}^{k} provided by the MAC layer, the scheduling algorithm b_{APP}^{k}εB_{APP} and the incoming packets. The incoming packets are determined by the source coding algorithm a_{APP}^{k}εA_{APP}. Hence, the state transition at the APP layer is given by p(s_{APP}^{k+1}|s_{APP}^{k},a_{APP}^{k},b_{APP}^{k},Z_{MAC}^{k}).

### B. Structure of Cross-Layer Optimization

With the above example in mind, the states and actions can be defined at each layer, and the transition probability thereof can be derived. The cross-layer optimization problem is formulated as a MDP. We assume that there are L participating layers in the protocol stack. If one layer does not participate in the cross-layer design, it can simply be omitted. Hence, we consider here only the L participating layers. Each layer is indexed lε{1, . . . , L} with layer 1 corresponding to the lowest participating layer (e.g. PHY layer) and layer L corresponding to the highest participating layer (e.g. APP layer). For example, if L=3, then layer 1 corresponds to the PHY layer, layer 2 corresponds to the MAC layer and layer 3 corresponds to the APP layer.

### States and Actions

When considering the layered architecture of current networks, we define a state sₗεsₗ for each layer l. For instance, a state may be defined as the QoS of each layer. The state of the wireless user is denoted by sεS, with S=S₁× . . . ×S_{L}.

In a layered architecture, a wireless user takes different transmission actions in each state of each layer. The transmission actions can be classified into two types at each layer l: an external action aₗεAₗ (where Aₗ is the set of possible external actions available at layer l) is performed to determine what the next state should be (i.e. state transition) such that the future reward will be improved, and an internal action bₗεBₗ (where Bₗ is the set of the possible internal actions available at layer l) is performed to determine a service provided to the upper layers for the packet(s) transmission in current time slot. In this example, a service is defined as the QoS provided to the upper layers for the packet(s) transmission in current time slot. The external actions of the wireless user at all the layers are denoted by a=(a₁, . . . , a_{L})εA, where A=A₁× . . . ×A_{L}. The internal actions of the wireless user across all the layers are denoted by b=(b₁, . . . , b_{L})εB, where B=B₁× . . . ×B_{L}. The action at layer l is the aggregation of external and internal actions, denoted by ξₗ=(aₗbₗ)εXₗ, where Xₗ=Aₗ×Bₗ. The joint action of the wireless user is denoted by ξ=(ξ₁, . . . , ξ_{L})εX=X₁× . . . ×X_{L}.

The following table shows exemplary internal actions and external actions for protocol layers:

| Protocol | Exemplary | Exemplary |
|---|---|---|
| Layer | Internal Action(s) | External Action(s) |
| Physical Layer | Modulation | Power Allocation |
| | Channel Coding | |
| MAC Layer | Retransmission | Resource Acquisition (such as |
| | Forward Error Control | acquiring the amount of |
| | | transmission time, acquiring |
| | | the amount of spectrum) |
| Application | Packet Scheduling | Source Coding Algorithm |
| Layer | | (such as quatization) |

### QoS at Layers 1, . . . , L−1

In the layered network architecture, each layer selects its own internal actions which, combined with the service (i.e. QoS level) provided by the lower layers, determine the QoS level supported to the upper layer (which is referred to as the upward message). Details of this calculation will be discussed shortly.

The set of QoS levels at layer l is computed as

$${𝒵}_{l} ( {s}_{1} , … , {s}_{l} ) = \{ \begin{matrix}( {t}_{l} , {ɛ}_{l} ) \vert {t}_{l} = {f}_{l}^{t} ( {s}_{l} , {b}_{l} , {Z}_{l - 1} ) , \\ {ɛ}_{l} = {f}_{l}^{ɛ} ( {s}_{l} , {b}_{l} , {Z}_{l - 1} ) , \\ {b}_{l} ∈ {B}_{l} , \\ {Z}_{l - 1} ∈ {𝒵}_{l - 1} ( {s}_{1} , … , {s}_{l - 1} )\end{matrix} \} , \qquad ( 3 )$$

where ƒₗ^{t} and ƒₗ^{ε} are the functions mapping the state and internal action of layer l and QoS provided by layer l−1 into the transmission time per packet and packet loss rate at layer l. In this disclosure, we assume that the functions ƒₗ^{t} and ƒₗ^{ε} preserve the partial order relationship. If Zₗ₋₁≦Z′ₗ₋₁, then tₗ=ƒₗ^{t}(sₗ,bₗ,Zₗ₋₁)≦t′ₗ=ƒₗ^{t}(sₗ,bₗ,Z′ₗ₋) and εₗ=ƒₗ^{ε}(sₗ,bₗ,Zₗ₋₁)≦ε′ₗ=ƒₗ^{ε}(sₗ,bₗ,Z′ₗ₋₁) for any sₗ and bₗ.

### State Transition

In the time-varying environment, the state transition at each layer (except the APP layer) depends on the experienced dynamics and the external action performed at that layer. In this disclosure, since, given the current state, transmission strategies can be determined independently of the past history of the transmission strategies and environment, the state transition probability is denoted by p(s′|s,ξ). Based on the structure of actions, the transition probability for the cross-layer optimization can be decomposed as

$$p ( {s}^{′} \vert s , ξ ) = {\prod }_{l = 1}^{L - 1} p ( {s}_{l}^{′} \vert {s}_{l} , {a}_{l} ) p ( {s}_{L}^{′} \vert {s}_{L} , {a}_{L} , {b}_{L} , {Z}_{L - 1} ) , \qquad ( 4 )$$

where Z_{L-1} is the QoS provided by layer L−1, which depends on the states and internal actions of all layers 1, . . . , L−1. In other words, the state transition at layer lε{1, . . . , L−1} (i.e. any lower layer) depends only on its current state sₗ and its external action aₗ. In contrast, the state transition at layer L is determined using both the external action a_{L}, the internal actions b and states S at all the layers (depending on the internal actions (b₁, . . . , b_{L-1}) and states (s₁, . . . , s_{L-1}) through the QoS Z_{L-1}). We should note that, although the state transition in the lower layers (l<L) is independent of other layers' state, the external action selection at that layer will depend on the message (e.g. the future reward generated by the upper layer) exchanged with the other layers.

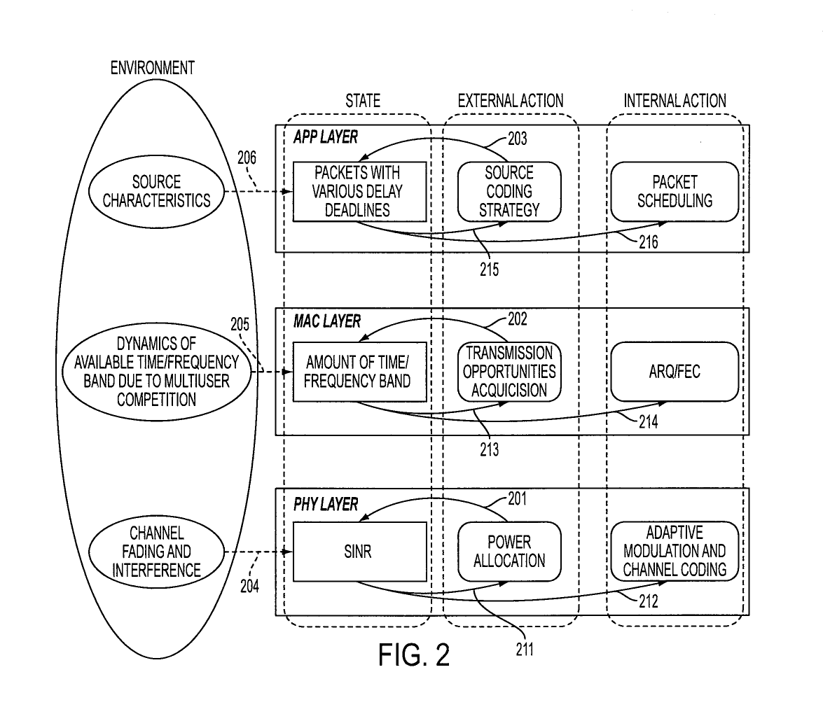

FIG. 2 illustrates interactions between exemplary states, internal actions and external actions of protocol layers in a cross-layer optimization architecture. As shown in FIG. 2, for APP layer, the state, external action and internal action are defined as packets with various delay deadlines, source coding strategy and packet scheduling, respectively. For MAC layer, the state, external action and internal action are defined as amount of time/frequency band, transmission opportunities acquisition and ARQ/FEC, respectively. For PHY layer, the state, external action and internal action are defined as SINR, power allocation and adaptive modulation and channel coding, respectively. Each layer is subject to environment dynamics, such as source characteristics, dynamics of available time/frequency band due to multiuser competition, channel fading and interference, etc. As illustrated by arrows 211-216, both the external action and the internal action for each layer are determined based on a current state. As illustrated by arrows 201-206, a state transition at each layer is determined based on the experienced dynamics and external actions performed by each layer. The objective of the wireless user is to jointly adapt the transmission strategies across all the three layers such that the user's utility is maximized.

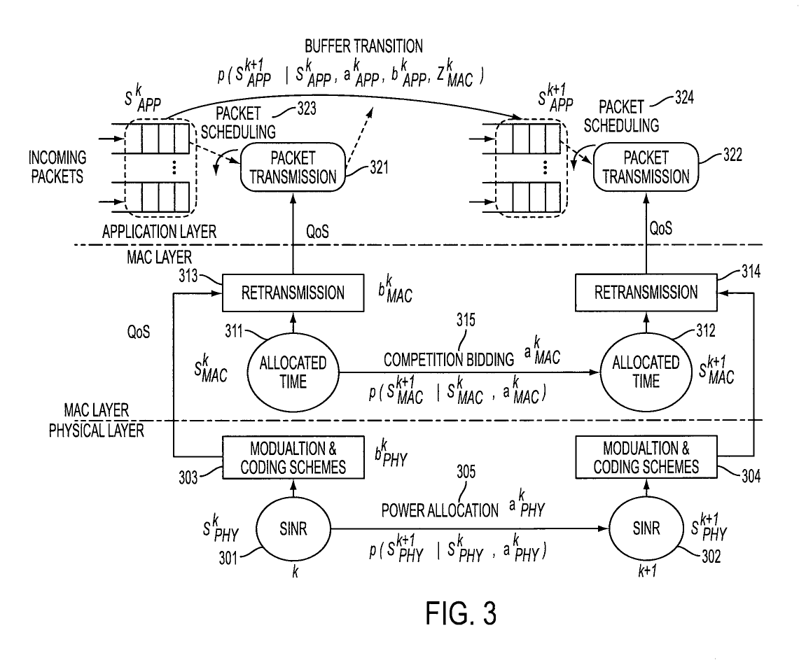

FIG. 3 shows further details of states, actions and state transitions of layers in exemplary cross-layer optimization architecture. For PHY layer, states 301, 302 for time slots k and k+1 are SINR. Based on state 301, an external action 305, which is power allocation, is determined and performed. The performed power allocation decides a state transition which causes the change from state 301 to state 302. Internal actions 303, 304 corresponding to time slots k and k+1 are determined based on state 301, 302, respectively. The QoS of the physical layer corresponding to time slots k and k+1 is generated based on internal actions 303, 304.

Similarly, for MAC layer, states 311, 312 for time slots k and k+1 are allocated time. Based on state 311, an external action 315, which corresponds to competition bidding, is determined and performed. The performed power allocation decides a state transition which causes the change from state 311 to state 312. Internal actions 313, 314 corresponding to time slots k and k+1 are retransmission and are determined according to state 311, 312, respectively. The QoS of the MAC layer corresponding to time slots k and k+1 is generated based on internal actions 313, 314.

For APP layer, states 321, 322 for time slots k and k+1 are how many packets are available for transmission at the current time slot, and internal actions 323, 324 correspond to packet scheduling. Based on state 321, an external action, which is source coding parameters, is determined and performed. The external action and packet scheduling 323 decide a state transition which causes the change from state 321 to state 322.

### C. Utility Function

The application gain obtained in layer L is based on the state s_{L}, internal action b_{L} and QoS Z_{L-1}, and it is denoted by g(s_{L},b_{L},Z_{L-1}). We also assume that g(s_{L},b_{L},Z_{L-1})≧g(s_{L},b_{L},Z′_{L-1}), if Z_{L-1}≦Z′_{L-1}. This assumption means that, within one time slot, given the state and internal action at layer L both the lower transmission time per packet (i.e. larger transmission rate) and lower packet loss rate lead the wireless user to transmit more packets successfully and thus, obtain a higher gain. Since the QoS level Z_{L-1} is determined by the states and internal actions at layers 1, . . . , L−1, the application gain is also interchangeably denoted by g(s,b). The transmission cost at layer l, cₗ(sₗ,aₗ), represents the cost of performing the external actions, e.g. the amount of power allocated to determine the channel conditions at the PHY layer or the cost spent to acquire wireless resources (time/frequency bands) at the MAC layer. In general, the transmission cost is a function of the external action and the state of layer l. Based on the transition model and action structure, the utility form is decomposed as

$$R ( s , ξ ) = g ( {s}_{L} , {b}_{L} , {Z}_{L - 1} ) - {\sum }_{l = 1}^{L} {λ}_{l} {c}_{l} ( {s}_{l} , {a}_{l} ) , \qquad ( 5 )$$

where λₗ are positive parameters which trade off between the application quality and cost incurred by performing certain actions. These parameters can be determined by the wireless user based on its resource constraints or by the network coordinator based on the costs of utilizing the network resources. These parameters can also be learned online. In this example, we assume that these parameters are known to the wireless users, and we focus on the internal and external action selection for utility maximization.

Specifically, we assume that the wireless user will maximize the expected discounted accumulative reward, which is defined as

$$E \{ {\sum }_{k = 0}^{∞} {( γ )}^{k} R ( {s}^{k} , {ξ}^{k} ) \} , \qquad ( 6 )$$

where γ is a discounted rate, with 0≦γ<1. We use a discounted accumulated reward with a higher weight on the current reward. The reasons for this are as follows: (i) for delay-sensitive applications, the data needs to be sent out as soon as possible to avoid missing its hard delay deadlines (otherwise, the packets will be useless), and (ii) since a wireless user may encounter unexpected environmental dynamics in the future, it may value its immediate reward higher than the long term reward.

The transmission strategies at each layer can be obtained by jointly maximizing the expected discounted reward defined in Eq. (6). This optimization problem can be formulated as an MDP, which can be deployed as a layered MDP framework that allows rigorous characterization of the evolving environmental dynamics and formulation of a systematic cross-layer optimization framework, which complies with the layered network architecture implemented in current wireless networks. This framework also is applicable when the network dynamics are unknown (i.e. the state transition probability has a known form, but the exact value of the probability is not known a priori). A layered learning algorithm is developed. The algorithm adheres to the current layered network architecture, and is able to optimally respond to the dynamics experienced at the various layers.

According to an embodiment of this disclosure, the application gain g(s_{L},b_{L},Z_{L-1}) can be computed without needing to know the exact internal actions performed in the lower layers, as long as a specific set of QoS is provided to the highest layer L. We note that layer L does not select QoS level Z′_{L-1} if it is dominated by Z_{L-1} (i.e. there exists a QoS level Z_{L-1} such that Z_{L-1}≦Z′_{L-1}). Hence, layer L−1 only needs to provide the QoS levels to the upper layer that are not dominated by any other QoS level. We refer to the set of dominant QoS levels as the optimal QoS frontier. The algorithm for generating the optimal QoS frontier will be described shortly.

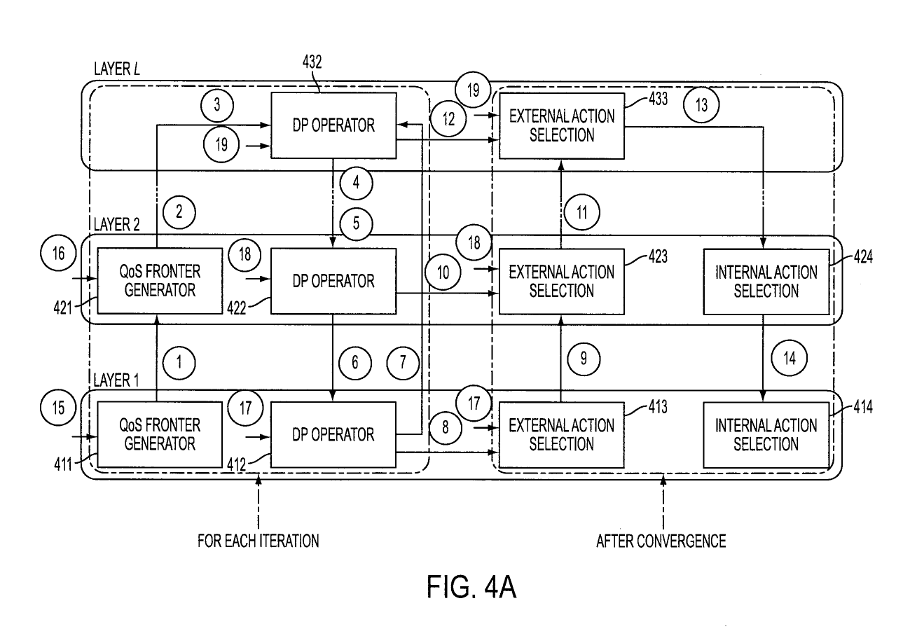

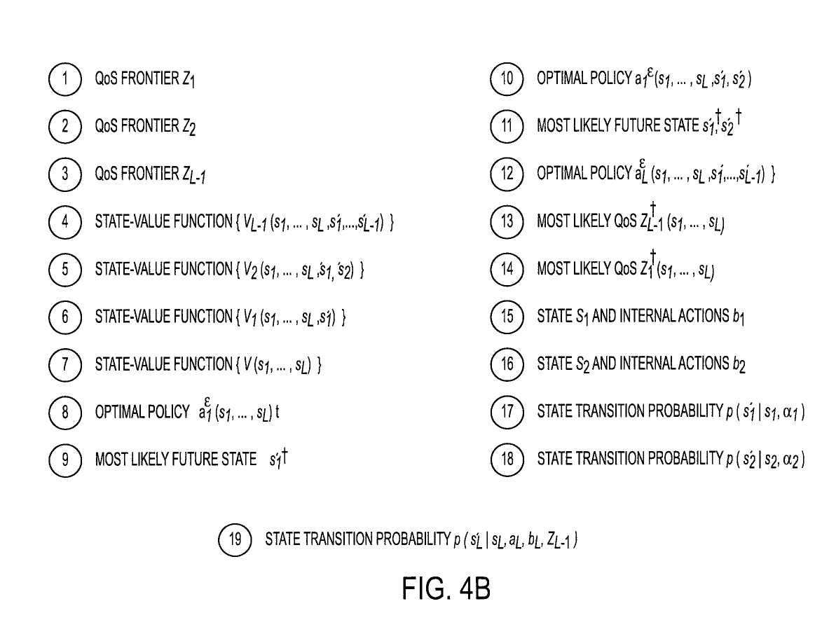

FIGS. 4A and 4B depict a block diagram of an exemplary communication node implementing cross-layer optimization, which allows each layer in the protocol hierarchy to learn network dynamics experienced by that layer and make autonomous decisions to maximize the wireless user's utility by optimally determining what information should be exchanged among layers. This cross-layer framework preserves the current layered network architecture. As discussed earlier, the cross-layer optimization problem is solved in a layered fashion such that each layer adapts its own protocol parameters. Specific types of information (messages) are exchanged with other layers in order to cooperatively maximize the performance of the wireless user. The information exchanged between the layers includes one or more of QoS frontier, state-value functions, most likely future states, optimal policies, states and internal actions, etc. Details of the exchanged information and interactions between layers are described below.

The exemplary communication node includes an upper layer L, such as the APP layer, a lower layer 1, such as the PHY layer, and one or more intermediate layers (collectively denoted as layer 2) between layer L and layer 1. Layer 1 includes a QoS frontier generator 411, a dynamic programming (DP) operator 412, an external action selector 413 and an internal action selector 414. Each layer 2 includes a QoS frontier generator 421, a dynamic programming (DP) operator 422, an external action selector 423 and an internal action selector 424. Layer L includes a DP operator 432 and an external action sector 433. The DP operators, external action selectors, internal action selectors and QoS frontier generators may be implemented using one or more controllers in combination with instruction codes which, upon execution by the controller, performing actions prescribed by the instruction codes.

Each layer is provided with a QoS frontier generator configured to generate a set of QoS as follows:

The set of QoS levels at layer l is computed as

$${𝒵}_{l} ( {s}_{1} , … , {s}_{l} ) = \{ \begin{matrix}( {t}_{l} , {ɛ}_{l} ) \vert {t}_{l} = {f}_{l}^{t} ( {s}_{l} , {b}_{l} , {Z}_{l - 1} ) , \\ {ɛ}_{l} = {f}_{l}^{ɛ} ( {s}_{l} , {b}_{l} , {Z}_{l - 1} ) , \\ {b}_{l} ∈ {B}_{l} , \\ {Z}_{l - 1} ∈ {𝒵}_{l - 1} ( {s}_{1} , … , {s}_{l - 1} )\end{matrix} \} ,$$

where ƒₗ^{t} and ƒₗ^{ε} are the functions mapping the state and internal action of layer l and QoS provided by layer l−1 into the transmission time per packet and packet loss rate at layer l. The functions ƒₗ^{t} and ƒₗ^{ε} preserve the partial order relationship, i.e. if Zₗ₋₁≦Z′ₗ₋₁, then tₗ=ƒₗ^{t} (sₗ,bₗ,Zₗ₋₁)≦t′ₗ=ƒₗ^{t}(sₗ,bₗ,Z′ₗ₋) and εₗ=ƒₗ^{ε}(sₗ,bₗ,Zₗ₋₁)≦ε′ₗ=ƒₗ^{ε}(sₗ,bₗ,Z′ₗ₋₁) for any sₗ and bₗ.

During the calculation process, there are many possible QoS levels that do not support the optimal utility. To avoid the propagation of these QoS levels, an efficient method may be utilized to compute the QoS frontier at each layer using the following algorithm:

$\begin{matrix}\text{Input:} {}_{l - 1} , {s}_{l} , and {B}_{l} . \\ \text{Initialize:} {}_{l} = Ø , flag = 0. \\ \begin{matrix}\text{Loop 1:} & For each {b}_{l} ∈ {B}_{l} \\ \text{Loop 2:} & For each {Z}_{l - 1} ∈ {}_{l - 1} \\ & flag = 0 ; \\ & Compute {Z}_{l} = {\vec{f}}_{l} ( {s}_{l} , {b}_{l} , {Z}_{l - 1} ) . \\ \text{Loop 3:} & For each {Z}_{l}^{′} ∈ {}_{l} \\ & If {Z}_{l}^{′} {≦}^{d} {Z}_{l} \\ & flag = 1 ; break ; \\ & endif \\ & endfor \text{//loop} 3 \\ & if flag == 0 \\ & {}_{l} = {}_{l} ⋃ \{ {Z}_{l} \} . \\ & endif \\ & endfor \text{//loop} 2 \\ & endfor \text{//loop} 1\end{matrix}\end{matrix}$

The QoS frontier generator only keeps the QoS levels which are not dominated by any other QoS levels and only provides these QoS levels to the upper layer. All the QoS levels dominated by the QoS levels at the frontier are deleted.

Next, we prove the following lemma which determines what QoS levels one layer needs to provide to its upper layer.

Lemma 1: At each time slot, each layer l=1, . . . , L−1 only needs to compute the optimal QoS frontier to its upper layer.

Proof: From the above discussion, to maximize the application gain g(s_{L},b_{L},Z_{L-1}), layer L only selects the QoS level Z_{L-1}ε [symbol] _{L-1}(s₁, . . . , s_{L-1}), which is on the optimal QoS frontier [symbol] _{L-1}(s₁, . . . , s_{L-1}). We only need to prove that, if layer l only provides the optimal QoS frontier [symbol] ₗ(s₁, . . . , sₗ) to its upper layer l+1, then it also only requires layer l−1 to provide the optimal QoS frontier [symbol] ₗ₋₁(s₁, . . . , sₗ₋₁).

Since the functions ƒₗ^{t} and ƒₗ^{ε} preserve the partial order relationship, if Zₗ₋₁≦Z′ₗ₋₁, then we have Zₗ≦Z′ₗ, where Zₗ,Z′ₗ are generated based on the QoS levels Zₗ₋₁,Z′ₗ₋₁, respectively. Hence, the QoS level Z′ₗ will never be provided to the upper layer l+1, since it is not on the optimal QoS frontier. Furthermore, layer l does not need to know the QoS level Z′ₗ₋₁, which means that layer l−1 only needs to provide its optimal QoS frontier.

As illustrated in FIGS. 4A and 4B, QoS frontier generator 411 of layer 1 generates a set of QoS frontier 1 based on an internal action and a state of layer 1, and sends the calculated QoS frontier 1 to the next layer above layer 1. Similarly, QoS frontier generator 421 of each layer 2 generates a set of QoS frontier 2 based on an internal action and a state of layer 2, and sends it to the next upper layer. At layer L, a set of QoS frontier 3 is received from the layer immediately below layer L.

Details of DP operators are now described. As discussed earlier, the transmission strategies at each layer can be obtained by jointly maximizing the expected discounted reward defined in Eq. (6). This optimization problem can be formulated as an MDP. To solve the MDP problem, several centralized algorithms have been proposed to find the optimal policy which maximizes the discounted sum of future rewards. The key step in these solutions is the dynamic programming (DP) operator

$${max}_{ξ ∈ χ} \{ R ( s , ξ ) + γ {\sum }_{{s}^{′} ∈ 𝒮} p ( {s}^{′} \vert s , ξ ) V ( {s}^{′} ) \} , \qquad ( 7 )$$

where V(S) is the state-value function, which is defined as the accumulated discounted reward that can be received when starting from state s. According to an embodiment of this disclosure, the centralized DP operator is decomposed into multiple layered DP operators as shown in FIGS. 4A and 4B, such that the operations of the DP operators and protocol stacks adhere to the current layered network architecture. A layered DP operator allows each layer to optimize its own policy autonomously, based on the information exchanged with the other layers.

D. Decomposition into Layered DP Operators

For each layer, a layered DP operator is provided for performing own DP operator based on the downward messages provided to it by its above layer. Considering the structure of the cross-layer optimization, the DP operator in Eq. (7) can be rewritten as follows:

$$V ( {s}_{1} , … , {s}_{L} ) = {max}_{a ∈ A , b ∈ B} [ \begin{matrix}g ( s , b ) - {\sum }_{l = 1}^{L} {λ}_{l} c ( {s}_{l} , {a}_{l} ) + \\ γ {\sum }_{{s}_{1}^{′} ∈ {S}_{1} , … , {s}_{L}^{′} ∈ {S}_{L}} p ( {s}_{1}^{′} \vert {s}_{1} , {a}_{1} ) … \\ p ( {s}_{L}^{′} \vert s , {a}_{L} , b ) V ( {s}_{1}^{′} , … , {s}_{L}^{′} )\end{matrix} ] , \qquad ( 8 )$$

As discussed earlier, each layer lε{1, . . . , L−1} only needs to provide the optimal QoS frontier to its upper layer. Then, layer L selects one QoS level Z_{L-1} from the optimal QoS frontier [symbol] _{L-1}(s₁, . . . , s_{L-1}) provided by layer Z_{L-1}. The QoS level Z_{L-1}ε [symbol] _{L-1}(s₁, . . . , s_{L-1}) corresponds directly to the internal actions that layers l=1, . . . , L−1 should select to support this QoS level. Then, the DP operator in Eq. (8) can be equivalently rewritten as

$$V ( {s}_{1} , … , {s}_{L} ) = {{max}_{a ∈ A , {b}_{L} ∈ {B}_{L} ,}}_{{Z}_{L - 1} ∈ {𝒵}_{L - 1} ( {s}_{1} , … , {s}_{L - 1} )} [ \begin{matrix}g ( {s}_{L} , {b}_{L} , {Z}_{L - 1} ) - {\sum }_{l = 1}^{L} {λ}_{l} c ( {s}_{l} , {a}_{l} ) + \\ γ {\sum }_{{s}_{1}^{′} ∈ {S}_{1} , … , {s}_{L}^{′} ∈ {S}_{L}} p ( {s}_{1}^{′} \vert {s}_{1} , {a}_{1} ) … \\ p ( {s}_{L}^{′} \vert {s}_{L} , {a}_{L} , {b}_{L} , {Z}_{L - 1} ) V ( {s}_{1}^{′} , … , {s}_{L}^{′} )\end{matrix} ] . \qquad ( 9 )$$

The DP operator in Eq. (9) maximizes over the optimal QoS frontier [symbol] _{L-1}(s₁, . . . , s_{L-1}) provided by layers 1, . . . , L−1.

The decomposition of Eq. (9) into the layered DP operators is now described. First, the equation is maximized over the internal and external actions at layer L and QoS level provided by layer L−1. Then, the DP operator becomes

$$V ( {s}_{1} , … , {s}_{L} ) = {max}_{{a}_{1} ∈ {A}_{1} , … , {a}_{L - 1} ∈ {A}_{L - 1}} \{ \begin{matrix}- {\sum }_{l = 1}^{L - 1} {λ}_{l} c ( {s}_{l} , {a}_{l} ) + \\ \begin{matrix}{\sum }_{{s}_{1}^{′} ∈ {S}_{1} , … , {s}_{L - 1}^{′} ∈ {S}_{L - 1}} p ( {s}_{1}^{′} \vert {s}_{1} , {a}_{1} ) … p ( {s}_{L - 1}^{′} \vert {s}_{L - 1} , {a}_{L - 1} ) \times \\ \underbrace{[ {{max}_{{a}_{L} ∈ {A}_{L} , {b}_{L} ∈ {B}_{L} ,}}_{{Z}_{L - 1} ∈ {𝒵}_{L - 1} ( {s}_{1} , … , {s}_{L - 1} )} [ \begin{matrix}g ( {s}_{L} , {b}_{L} , {Z}_{L - 1} ) - {λ}_{L} c ( {s}_{L} , {a}_{L} ) + \\ γ {\sum }_{{s}_{L}^{′} ∈ {S}_{L}} p ( {s}_{L}^{′} \vert {s}_{L} , {a}_{L} , {b}_{L} , {Z}_{L - 1} ) \\ V ( {s}_{1}^{′} , … , {s}_{L}^{′} )\end{matrix} ] ]}_{layered DP operator at layer L}\end{matrix}\end{matrix} \} , \qquad ( 10 )$$

The output of the layered DP operator at layer L is the state-value function V(s₁, . . . , s_{L},s′₁, . . . , s′_{L-1}), and optimal external action a*_{L}(s₁, . . . , s_{L-1},s′₁, . . . , s′_{L-1}), optimal internal action b*_{L}(s₁, . . . , s_{L-1},s′₁, . . . , s′_{L-1}), and optimal QoS level Z*_{L-1}(s₁, . . . , s_{L-1},s′₁, . . . , s′_{L-1}).

After performing the layered DP operator at layer L, we can further maximize over the external actions at layer L−1 and the DP operator in Eq. (10) becomes

$$\begin{matrix}V ( {s}_{1} , … , {s}_{L} ) = {max}_{{a}_{1} ∈ {A}_{1} , … , {a}_{L - 1} ∈ {A}_{L - 1}} \\ \{ \begin{matrix}- {\sum }_{l = 1}^{L - 1} {λ}_{l} c ( {s}_{l} , {a}_{l} ) + \\ {\sum }_{{s}_{1}^{′} ∈ {S}_{1} , … , {s}_{L - 1}^{′} ∈ {S}_{L - 1}} p ( {s}_{1}^{′} \vert {s}_{1} , {a}_{1} ) … p ( {s}_{L - 1}^{′} \vert {s}_{L - 1} , {a}_{L - 1} ) \\ \underbrace{V ( {s}_{1} , … , {s}_{L} , {s}_{1}^{′} , … , {s}_{L - 1}^{′} )}_{output of DP operator at layer L}\end{matrix} \} \\ = {max}_{{a}_{1} ∈ {A}_{1} , … , {a}_{L - 2} ∈ {A}_{L - 2}} \\ \{ \begin{matrix}- {\sum }_{l = 1}^{L - 2} {λ}_{l} c ( {s}_{l} , {a}_{l} ) + \\ {\sum }_{{s}_{1}^{′} ∈ {S}_{1} , … , {s}_{L - 2}^{′} ∈ {S}_{L - 2}} p ( {s}_{1}^{′} \vert {s}_{1} , {a}_{1} ) … p ( {s}_{L - 2}^{′} \vert {s}_{L - 2} , {a}_{L - 2} ) \times \\ \underbrace{{max}_{{a}_{L - 1} ∈ {A}_{L - 1}} [ \begin{matrix}- {λ}_{L - 1} c ( {s}_{L - 1} , {a}_{L - 1} ) + \\ {\sum }_{{s}_{L - 1}^{′} ∈ {S}_{L - 1}} p ( {s}_{L - 1}^{′} \vert {s}_{L - 1} , {a}_{L - 1} ) \\ V ( {s}_{1} , … , {s}_{L} , {s}_{1}^{′} , … , {s}_{L - 1}^{′} )\end{matrix} ]}_{layered DP operator at layer L - 1}\end{matrix} \} ,\end{matrix} \qquad ( 11 )$$

The output of the layered DP operator at layer L−1 is the state-value function V(s₁, . . . , s_{L},s′₁, . . . , s′_{L-2}), and optimal external action a*_{L}(s₁, . . . , s_{L},s′₁, . . . , s′_{L-2}). This decomposition can be performed until layer 1. At layer 1, the DP operator becomes

$$V ( {s}_{1} , … , {s}_{L} ) = \underbrace{{max}_{{a}_{1} ∈ {A}_{1}} \{ \begin{matrix}- {λ}_{1} c ( {s}_{1} , {a}_{1} ) + \\ \begin{matrix}{\sum }_{{s}_{1}^{′} ∈ {S}_{1}} p ( {s}_{1}^{′} \vert {s}_{1} , {a}_{1} ) \\ V ( {s}_{1} , … , {s}_{L} , {s}_{1}^{′} )\end{matrix}\end{matrix} \}}_{layered DP operator at layer 1} . \qquad ( 12 )$$

With this decomposition, each layer only solves a layered DP operator illustrated in Table 1.

TABLE 1
Layered DP operator at each layer.

| Layer | Layered DP operator at each layer | |
|---|---|---|
| L | ${V}_{L - 1} ( {s}_{1} , … , {s}_{L} , {s}_{1}^{′} , … , {s}_{L - 1}^{′} ) = {α}_{L} ε {A}_{L} , {b}_{L} ε {B}_{L} , {Z}_{L - 1} ε {}_{L - 1} ( {s}_{1} , … , {s}_{L - 1} ) \\ [ \begin{matrix}g ( {s}_{L} , {b}_{L} , {Z}_{L - 1} ) - {λ}_{L} c ( {s}_{L} , {a}_{L} ) + \\ γ {\sum }_{{s}_{L}^{′} ε {S}_{L}} p ( {s}_{L}^{′} \vert {s}_{L} , {a}_{L} , {b}_{L} , {Z}_{L - 1} ) V ( {s}_{1}^{′} , … , {s}_{L}^{′} )\end{matrix} ]$ | (13) |
| l ε {2, . . . | ${V}_{l - 1} ( {s}_{1} , … , {s}_{L} , {s}_{1}^{′} , … , {s}_{L - 1}^{′} ) = {max}_{{a}_{l} ε {A}_{l}} [ \begin{matrix}- {λ}_{l} {c}_{l} ( {s}_{l} , {a}_{l} ) + \\ {\sum }_{{s}_{l}^{′} ε {S}_{l}} p ( {s}_{l}^{′} \vert {s}_{l} , {a}_{l} ) {V}_{l} ( {s}_{1} , … , {s}_{L} , {s}_{1}^{′} , … , {s}_{l}^{′} )\end{matrix} ]$ | (14) |
| 1 | $V ( {s}_{1} , … , {s}_{L} ) = {max}_{{a}_{1} ε {A}_{1}} [ \begin{matrix}- {λ}_{1} {c}_{1} ( {s}_{1} , {a}_{1} ) + \\ {\sum }_{{s}_{1}^{′} ε {S}_{1}} p ( {s}_{1}^{′} \vert {s}_{1} , {a}_{1} ) {V}_{1} ( {s}_{1} , … , {s}_{L} , {s}_{1}^{′} )\end{matrix} ]$ | (15) |

Accordingly, DP operator at layer operates as follows:
DP operators at layer L:

The DP operator at layer L performs the sub-value iteration to find the optimal external action, internal action at layer L and QoS level provided by layer L−1. The computation is given in Eq. (10). Inputs to the DP operator at layer L include the QoS frontier [symbol] _{L-1} provided by layer L−1 and the transition probability p(s′_{L}|s_{L},a_{L},b_{L},Z_{L-1}) which is the information at layer L. The outputs of the DP operator at layer L include the state-value function V_{L-1}(s₁, . . . , s_{L},s′₁, . . . , s′_{L-1}) and optimal policies a_{L}^{l}(s₁, . . . , s_{L},s′₁, . . . , s′_{L-1}), b_{L}^{l}(s₁, . . . , s_{L},s′₁, . . . , s′_{L-1}), and Z_{L-1}^{l}(s₁, . . . , s_{L},s′₁, . . . , s′_{L-1}).

DP operators at layer l:

The DP operator at layer l performs the sub-value iteration to find the optimal external action at layer l. The computation is given in Eq. (11). Inputs to the DP operator at layer l include the state-value function Vₗ(s₁, . . . , s_{L},s′₁, . . . , s′ₗ) and the transition probability p(s′ₗ|sₗ,aₗ) which is the information at layer l. The outputs of the DP operator at layer l include the state-value function Vₗ₋₁(s₁, . . . , s_{L},s′₁, . . . , s′ₗ₋₁) and optimal policy aₗ^{l}(s₁, . . . , s_{L},s′₁, . . . , s′ₗ₋₁).

DP operators at layer 1:

The DP operator at layer 1 performs the sub-value iteration to find the optimal external action at layer 1. The computation is given in Eq. (12). Inputs to the DP operator at layer 1 include the state-value function V₁(s₁, . . . , s_{L}, s′₁) and the transition probability p(s′₁|s₁,a₁) which is the information at layer 1. The outputs of the DP operator at layer l include the state-value function V(s₁, . . . , s_{L}) and optimal policy a₁^{l}(s₁, . . . , s_{L}).

In order to perform the layered DP operator at each layer, message exchanges are required among layers. Specifically, the message exchanged from layer l+1 to layer l is the set of state values {Vₗ(s₁, . . . , s_{L},s′₁, . . . , s′ₗ)}, which represents the accumulated discounted future reward obtained at the layers {1, . . . , l} and is used to select the external actions at layer l. The message exchanges between layers are shown Table 2.

TABLE 2
Message exchanges between layers for layered DP operator

| Layer | Upward Message | | Downward Message | |
|---|---|---|---|---|
| L | | None | {V_{L - 1}(s′₁, . . . , s′_{L - 1})} | Expected |
| | | | | future |
| | | | | reward at |
| | | | | layer |
| | | | | L − 1 |
| l ε {2, . . . , L − 1} | [symbol] ₗ | QoS | {V_{l - 1}(s′₁, . . . , s′_{l - 1})} | Expected |
| | | level set | | future |
| | | provided | | reward at |
| | | to layer | | layer |
| | | l + 1 | | l − 1 |
| 1 | [symbol] ₁ | QoS | | None |
| | | level set | | |
| | | provided | | |
| | | to layer 2 | | |

In this layered DP operator, the optimal external action aₗ^{l}(s′₁, . . . , s′ₗ₋₁) is selected for each state (s′₁, . . . , s′ₗ₋₁) at the lower layers and the optimal QoS level Z_{L}^{l}(s′₁, . . . , s′_{L-1}) depends on the state (s′₁, . . . , s′_{L-1}). Then we have the following theorem.

Theorem 1: The state-value functions obtained in the layered DP operator satisfy the follow inequalities:

$$\begin{matrix}{V}_{L - 1} ( {s}_{1}^{′} , … , {s}_{L - 1}^{′} ) = {{max}_{{a}_{L} ∈ {A}_{L} ,}}_{{Z}_{L} ∈ {𝒵}_{L}} [ \begin{matrix}{R}_{in} ( {s}_{L} , {Z}_{L} ) - {λ}_{L}^{a} {c}_{L} ( {s}_{L} , {a}_{L} ) + \\ γ {\sum }_{{s}_{L}^{′} ∈ {𝒮}_{L}} p ( {s}_{L}^{′} \vert {s}_{L} , {Z}_{L} , {a}_{L} ) V ( {s}_{1}^{′} , … , {s}_{L}^{′} )\end{matrix} ] \geq {R}_{in} ( {s}_{L} , {Z}_{L}^{*} ) - {λ}_{L}^{a} {c}_{L} ( {s}_{L} , {a}_{L}^{*} ) + γ {\sum }_{{s}_{L}^{′} ∈ {𝒮}_{L}} p ( {s}_{L}^{′} \vert {s}_{L} , {Z}_{L}^{*} , {a}_{L}^{*} ) V ( {s}_{1}^{′} , … , {s}_{L}^{′} ) ; ∀ ( {s}_{1}^{′} , … , {s}_{L - 1}^{′} ) & ( 16 ) \\ and & \\ {V}_{l - 1} ( {s}_{1}^{′} , … , {s}_{l - 1}^{′} ) = {max}_{{a}_{l} ∈ {A}_{l}} [ \begin{matrix}- {λ}_{l}^{a} {c}_{l} ( {s}_{l} , {a}_{l} ) + \\ {\sum }_{{s}_{l}^{′} ∈ {𝒮}_{l}} p ( {s}_{l}^{′} \vert {s}_{l} , {a}_{l} ) {V}_{l} ( {s}_{1}^{′} , … , {s}_{l}^{′} )\end{matrix} ] \geq - {λ}_{l}^{a} {c}_{l} ( {s}_{l} , {a}_{l}^{*} ) + {\sum }_{{s}_{l}^{′} ∈ {𝒮}_{l}} p ( {s}_{l}^{′} \vert {s}_{l} , {a}_{l}^{*} ) {V}_{l} ( {s}_{1}^{′} , … , {s}_{l}^{′} ) ; ∀ ( {s}_{1}^{′} , … , {s}_{l - 1}^{′} ) , ∀ l = 1 , … , L - 1 & ( 17 )\end{matrix}$$

where the optimal external actions a*ₗ, ∀l and optimal QoS level Z*_{L} are obtained in the centralized DP operator.

Proof: The inequalities in Eqs. (16) and (17) result from the fact that a*ₗ, ∀l and Z*_{L} represent the feasible solution to the layered DP operator and hence, the state-value function obtained by the layered DP operator (which performs the maximization) is greater than or equal to the state-value function of any feasible solution.

Theorem 1 shows that the layered DP operator obtains higher state-value functions by performing the mixed actions at each layer, as explained below.

At layer l, given the next state (s′₁, . . . , s′ₗ₋₁) and current state s, the optimal external action aₗ^{l}(s′₁, . . . , s′ₗ₋₁) obtained in the layered DP operator is a pure action. However, the next state (s′₁, . . . , s′ₗ₋₁) is unknown at the current stage and has the probability distribution p(s′₁|s₁,a₁^{l})p(s′₂|s₂,a₂^{l}(s′)) . . . p(s′ₗ₋₁|sₗ₋₁,aₗ₋₁^{l}(s′ₗ, . . . , s′ₗ₋₁)) determined by the external actions performed at layers 1, . . . , l−1 and the environmental dynamics. Hence, the optimal external action aₗ^{m}(s) at layer l (computed without knowing the next states at layers 1, . . . , l−1) is a mixed action, whose elements aₗ^{l}(s′₁, . . . , s′ₗ₋₁) have the same probability distribution as that of (s′₁, . . . , s′ₗ₋₁), i.e. p(s′₁|s₁,a₁^{l})p(s′₂|s₂,a₂^{l}(s′)) . . . p(s′ₗ₋₁|sₗ₋₁,aₗ₋₁^{l}(s′₁, . . . , s′ₗ₋₁)). Then, we can represent the mixed external action at layer l as

$${a}_{l}^{m} ( s ) = {⋃}_{{s}_{1}^{′} ∈ {𝒮}_{1} , … , {s}_{l - 1}^{′} ∈ {𝒮}_{l - 1}} \{ \begin{matrix}p ( {s}_{1}^{′} \vert {s}_{1} , {a}_{1}^{𝓁} ) p ( {s}_{2}^{′} \vert {s}_{2} , {a}_{2}^{𝓁} ( {s}_{1}^{′} ) ) … \\ \begin{matrix}p ( {s}_{l - 1}^{′} \vert {s}_{l - 1} , {a}_{l - 1}^{𝓁} ( {s}_{1}^{′} , … , {s}_{l - 1}^{′} ) ) • \\ {a}_{l}^{𝓁} ( {s}_{1}^{′} , … , {s}_{l - 1}^{′} )\end{matrix}\end{matrix} \} , \qquad ( 18 )$$

where the operator “◯” indicates that action aₗ^{l}(s′₁, . . . , s′ₗ) is performed with the probability p(s′₁|s₁,a₁^{l})p(s′₂|s₂,a₂^{l}(s′₁)) . . . p(s′ₗ₋₁|sₗ₋₁,aₗ₋₁^{l}(s′₁, . . . , s′ₗ₋₁)). We use the union operator “∪” to compactly represent the mixed action. Similarly, the optimal QoS level at layer L is given by

$${Z}_{L}^{m} ( s ) = {⋃}_{{s}_{1}^{′} ∈ {𝒮}_{1} , … , {s}_{l - 1}^{′} ∈ {𝒮}_{l - 1}} \{ \begin{matrix}p ( {s}_{1}^{′} \vert {s}_{1} , {a}_{1}^{𝓁} ) p ( {s}_{2}^{′} \vert {s}_{2} , {a}_{2}^{𝓁} ( {s}_{1}^{′} ) ) … \\ \begin{matrix}p ( {s}_{L - 1}^{′} \vert {s}_{L - 1} , {a}_{L - 1}^{𝓁} ( {s}_{1}^{′} , … , {s}_{L - 1}^{′} ) ) • \\ {Z}_{L}^{𝓁} ( {s}_{1}^{′} , … , {s}_{L - 1}^{′} )\end{matrix}\end{matrix} \} \qquad ( 19 )$$

In summary, compared to the centralized DP operator in which the pure action is chosen for each current state s, the optimal pure action aₗ^{l}(s′₁, . . . , s′ₗ₋₁) in the layered DP operator is chosen for each current state s and next state (s′₁, . . . , s′ₗ₋₁). In other words, the layered DP operator takes into account the states' information at the next stage (i.e. (s′₁, . . . , s′₁₋₁)), and performs the mixed actions based on the distribution of the states (s′₁, . . . , s′₁₋₁). Hence, the optimal mixed actions can improve the state-value function.

As illustrated above, each layer l performs the layered DP operator to obtain the state-value function Vₗ₋₁(s₁, . . . , s_{L},s′₁, . . . , s′ₗ₋₁) and optimal action which is a function of (s₁, . . . , s_{L},s′₁, . . . , s′ₗ₋₁). The state value function Vₗ(s₁, . . . , s_{L},s′₁, . . . , s′ₗ₋₁) associated with the optimal policy obtained by the layered DP operators is not less than that of the optimal policy obtained by the centralized DP operator. Accordingly, the optimal policy obtained at layer l using layered DP operator is a function of the current states (s₁, . . . , s_{L}) of all the layers and the next states (s′₁, . . . , s′ₗ₋₁) of layers 1, . . . , l−1. This optimal policy is a stochastic policy because the optimal policy will probabilistically select the actions at the current states (s₁, . . . , s_{L}) based on the state transition probability

$${\prod }_{{l}^{′} = 1}^{l - 1} p ( {s}_{{l}^{′}}^{′} \vert {s}_{{l}^{′}} , {a}_{{l}^{′}} )$$

from the current states (s₁, . . . , sₗ₋₁) to the next states (s′₁, . . . , s′ₗ₋₁).

### E. Internal and External Actions Selection

In this section, we will illustrate how the internal and external actions are selected without knowing the states at the next stage in the layered DP operator. From Eqs. (18) and (19), the layered DP operator can only provide the mixed actions. The mixed action selection at each layer requires the transition probabilities at the lower layers. However, the exchange of transition probabilities (i.e. the dynamics model at that layer) leads to significantly increased information exchange and also requires each layer to access the internal parameters of other layers, thereby violating the OSI layer design. According to one embodiment of this disclosure, transition probabilities are not exchanged between layers. Rather, the optimal external action and optimal QoS level selection are selected as follows:

$$\begin{matrix}{a}_{1}^{†} = {a}_{1}^{𝓁} ; \\ {a}_{2}^{†} = {a}_{2}^{𝓁} ( arg {max}_{{s}_{1}^{′}} p ( {s}_{1}^{′} \vert {s}_{1} , {a}_{1}^{†} ) ) ; \\ ⋮ \\ {a}_{L}^{†} = {a}_{L}^{𝓁} ( \begin{matrix}arg {max}_{{s}_{1}^{′}} p ( {s}_{1}^{′} \vert {s}_{1} , {a}_{1}^{†} ) , … , \\ arg {max}_{{s}_{L - 1}^{′}} p ( {s}_{L - 1}^{′} \vert {s}_{L - 1} , {a}_{L - 1}^{†} )\end{matrix} ) \\ {Z}_{L}^{†} = {Z}_{L}^{𝓁} ( \begin{matrix}arg {max}_{{s}_{1}^{′}} p ( {s}_{1}^{′} \vert {s}_{1} , {a}_{1}^{†} ) , … , \\ arg {max}_{{s}_{L - 1}^{′}} p ( {s}_{L - 1}^{′} \vert {s}_{L - 1} , {a}_{L - 1}^{†} )\end{matrix} )\end{matrix} \qquad ( 20 )$$

From Eq. (20), the action and QoS level selection does not require the information of transition probability but rather the states which maximize the transition probability. This selection is an approximation to the optimal mixed action and QoS level. To select external action and QoS level, the lower layer l−1 needs to provide the information

$$( arg {max}_{{s}_{1}^{′}} p ( {s}_{1}^{′} \vert {s}_{1} , {a}_{1}^{†} ) , … , arg {max}_{{s}_{l - 1}^{′}} p ( {s}_{l - 1}^{′} \vert {s}_{l - 1} , {a}_{l - 1}^{†} ) )$$

to layer l. Given the approximated QoS level Z_{L}^{†}, we obtain the internal action b_{L}^{†} and the QoS level Z_{L-1}^{†} at layer L−1 which generate the QoS level Z_{L}^{†}. Similarly, given the QoS level Zₗ^{†}, layer l can find the internal action bₗ^{†} and the QoS level Zₗ₋₁^{†} for layer l−1. Hence, to select the internal action, layer l needs to provide the information Zₗ₋₁^{†} to layer l−1

TABLE 3
Message exchange for internal and external action selection

| | | | Downward Message | |
|---|---|---|---|---|
| Layer | Upward Message θ_{l,l+1} | | θ_{l,l+1} | |
| L | Ø | None | Z_{L-1}^{†} | The |
| | | | | optimal |
| | | | | QoS at |
| | | | | layer |
| | | | | L − 1 |
| l ε {2, . . ., L − 1} | $arg {max}_{{s}_{1}^{′}} p ( {s}_{1}^{′} \vert {s}_{1} , {a}_{1}^{†} )$ . . . $arg {max}_{{s}_{1}^{′}} p ( {s}_{1}^{′} \vert {s}_{1} , {a}_{1}^{†} )$ | The optimal next states at layers 1, . . ., l | Z_{L-1}^{†} | The optimal Qost at layer l − 1 |
| 1 | $arg {max}_{{s}_{1}^{′}} p ( {s}_{1}^{′} \vert {s}_{1} , {a}_{1}^{†} )$ | The optimal next state | Ø | None |

The external action selector in each layer selects the external action which only depends on the current state s=(s₁, . . . , s_{L}). From the layered DP operator, we note that the optimal policy at layer l is aₗ^{l}(s₁, . . . , s_{L},s′₁, . . . , s′ₗ₋) which depends on the current s=(s₁, . . . , s_{L}) as well as the future state (s′₁, . . . , s′ₗ₋₁). To do this, each layer performs the following operations:

### Layer 1:

Inputs: the optimal policy a₁^{l}(s₁, . . . , s_{L}) and transition probability p(s′₁|s₁,a₁)

Outputs: the optimal policy a₁^{†}(s₁, . . . , s_{L}) and the most likely future state s′₁^{†}.

Operations:

$${a}_{1}^{†} ( {s}_{1} , … , {s}_{L} ) = {a}_{1}^{𝓁} ( {s}_{1} , … , {s}_{L} )$$

$${s}_{1}^{′†} = arg {max}_{{s}_{1}^{′}} p ( {s}_{1}^{′} \vert {s}_{1} , {a}_{1}^{†} )$$

### Layer l:

Inputs: the optimal policy aₗ^{l}(s₁, . . . , s_{L},s′₁, . . . , s′ₗ₋₁), transition probability p(s′ₗ|sₗ,aₗ) and most likely future state s′₁^{†}, . . . , s′ₗ₋₁^{†}

Outputs: the optimal policy aₗ^{†}(s₁, . . . , s_{L}) and the most likely future state s′₁^{†}, . . . , s′ₗ^{†}.

Operations:

$${a}_{l}^{†} ( {s}_{1} , … , {s}_{L} ) = {a}_{l}^{𝓁} ( {s}_{1} , … , {s}_{L} , {s}_{1}^{′†} , … , {s}_{l - 1}^{′†} )$$

$${s}_{l}^{′†} = arg {max}_{{s}_{l}^{′}} p ( {s}_{l}^{′} \vert {s}_{l} , {a}_{l}^{†} )$$

### Layer L:

Inputs: the optimal policy a_{L}^{l}(s₁, . . . , s_{L},s′₁, . . . , s′_{L-1}), transition probability p(s′_{L}|s_{L},a_{L},b_{L},Z_{L-1}) and most likely future state s′₁^{†}, . . . , s′_{L-1}^{†}

Outputs: the optimal policy a_{L}^{†}(s₁, . . . , s_{L}), b_{L}^{†}(s₁, . . . , s_{L}) and Z_{L-1}^{†}(s₁, . . . , s_{L})

Operations:

a_{L}^{†}(s₁, . . . , s_{L})=a_{L}^{l}(s₁, . . . , s_{L},s′₁^{†}, . . . , s′_{L-1}^{†})

b_{L}^{†}(s₁, . . . , s_{L})=b_{L}^{l}(s₁, . . . , s_{L},s′₁^{†}, . . . , s′_{L-1}^{†}

Z_{L}^{†}(s₁, . . . , s_{L})=Z_{L}^{l}(s₁, . . . , s_{L},s′₁^{†}, . . . , s′_{L-1}^{†}

The optimal policy obtained at layer l using layered DP operator is a function of the current states (s₁, . . . , s_{L}) of all the layers and the next states (s′₁, . . . , s′ₗ₋₁) of layers 1, . . . , l−1. This optimal policy is a stochastic policy because the optimal policy will probabilistically select the actions at the current states (s₁, . . . , s_{L}) based on the state transition probability

$${\prod }_{{l}^{′} = 1}^{l - 1} p ( {s}_{{l}^{′}}^{′} \vert {s}_{{l}^{′}} , {a}_{{l}^{′}} )$$

from the current states (s₁, . . . , sₗ₋₁) to the next states (s′₁, . . . , s′ₗ₋₁). By knowing the information about the future states (s′₁, . . . , s′ₗ₋₁), the layered DP operators improve the state value functions at each layer. In the next section, we will discuss how we can approach this stochastic policy when the environmental dynamics are unknown.

Detailed operations of the exemplary communication node in FIGS. 4A and 4B are now described. For each iteration, at layer 1, QoS frontier generator 411 generates QoS frontier 1 based on state s1 and internal actions b1. QoS frontier 1 is provided to layer 2. At layer 2, QoS frontier generator 421 generates QoS frontier 2 based on state s2, internal actions b2 and QoS frontier 1. QoS frontier 2 is provided to the next upper layer, such as layer L. At layer L, DP operator 432 generates a state-value function 4 and an optimal policy 12 according to state transition probability 19, QoS frontier 3 provided by its next lower layer, and a state-value function 7 provided by layer 1, in a manner discussed earlier relating to layered DP operator. Information related to state-value function 4 is provided to the DP operator of the next lower layer, such as DP operator 422 of layer 2. In turn, DP operator 422 generates a state-value function 6 and an optimal policy 10 based on state transition probability 18 and state-value function 5 which is derived from state-value function 4 sent by layer L. Information related to state-value function 6 is provided to the DP operator 411 of layer 1. DP operator 411, based on state-value function 5 and state transition probability of layer 1, generates an optimal policy 8 in manners described earlier with respect to layered DP operator. DP operator 412 also calculates and provides information related to state-value function 7 to DP operator 432 at layer L.

After convergence, at layer 1, external action selector 413 selects an external action to optimize performance of layer 1 according to optimal policy 8, and calculates a most likely future state 9 based on the selected external action and state transition probability 17. Most likely future state 9 of layer 1 is then provided to layer 2.

At layer 2, external action selector 423 selects an external action to optimize performance of layer 2 according to optimal policy 10 determined by DP operator 422, and calculates a most likely future state 11 based on the selected external action, state transition probability 18 of layer 2, and most likely future state 9 of layer 1. Most likely future state 11 of layer 2 is then provided to layer L.

At layer L, external action selector 433 selects an external action to optimize performance of layer L according to optimal policy 12 determined by DP operator 432, and calculates a most likely QoS 13 based on the selected external action, state transition probability 18 of layer L and most likely future state 11 of layer 2. Most likely QoS 13 is then provided to layer 2 as an input of internal action selector 424. Based on most likely QoS 13, internal action selector 424 determines a suitable internal action and generates most likely QoS 14, which is provided as an input to internal action selector 414 of layer 1. Based on most likely QoS 14, internal action selector 414 of layer 1 determines a suitable internal action to be performed at layer 1, to achieve optimized performance of the exemplary communication node.

### F. On-Line Learning

As discussed earlier, when the environment dynamics are known, the optimal internal and external policies may be determined iteratively. Now, we further extend this layered MDP framework operating with unknown environment dynamics. A key challenge for a wireless user interacting with an unknown environment is how to effectively learn from its past experiences (past interactions with its environment) and how to determine its actions in different situations (i.e. states) such that its long-term reward is maximized. Moreover, in the considered cross-layer problem, an additional challenge is how each layer can learn from its own experience, and how the layers can cooperatively maximize the long-term utility defined for the wireless user, while adhering to the layered network architecture.

For delay-sensitive applications, such as multimedia streaming, the cross-layer transmission strategies need to be adapted to the environmental dynamics on the fly, such that the delay-constrained data can be delivered on time. Hence, online learning techniques need to be deployed in order to determine the optimal cross-layer strategy in real-time.

An exemplary communication node of this disclosure utilizes online reinforcement learning solutions to determine the optimal cross-layer strategy, which enables the multiple OSI layers to simultaneously learn the impact of their own transmission strategies at each layer on the future reward based on their own past experiences at that layer, as well as messages received from other layers. The reinforcement learning solution enables the wireless user to remain in compliance with the existing layered network architecture.

Based on the layered MDP framework discussed earlier, we develop a layered learning algorithm with information exchange across layers. For illustration purpose, as an example, an actor-critic online learning algorithm is used for the cross-layer optimization. It is understood that other types of online learning algorithms may be utilized to implement the concepts described herein. In an actor-critic online learning algorithm, the policy is stored separately from the state-value function and thus each layer is able to store its own policy, which makes it easy to satisfy the layered network architecture. Additionally, the actor-critic learning can learn an explicit stochastic policy which is important in competitive (e.g. in the multi-user environment) and non-Markov environments.

A layered actor-critic learning algorithm can be derived from a centralized learning algorithm, the operation of which is now described. In a centralized cross-layer optimization, the wireless user has to select the joint transmission strategy ξ^{k} of all the layers at time slot k. To perform the actor-critic learning algorithm, the wireless user needs to implement two components: the actor and the critic. The actor is assigned a policy representation ρ(s,ξ)ε [symbol] ₊, which indicates the tendency to select that action ξ at state s. The higher ρ(s,ξ) is, the larger the probability of selecting the action ξ at state s. At the beginning of each time slot, the actor generates an action to perform according to the stochastic policy, which is computed from the policy representation. The stochastic policy is computed according to the Gibbs softmax method:

$$π ( s , ξ ) = \frac{{e}^{ρ ( s , ξ )}}{{\sum }_{{ξ}^{′} ∈ {\prod }_{l = 1}^{L} {χ}_{l}} {e}^{ρ ( s , {ξ}^{′} )}} , \qquad ( 21 )$$

where π(s,ξ) represents the probability of performing action ξ at state s. π is a stochastic policy. The action to be performed is drawn from the mixed action π(s,ξ). Besides generating the action to be performed, the actor will also update the tendency (update the policy accordingly), which is similar to the policy improvement component in the policy iteration algorithm.

The critic is assigned a state value function V(s), which is used to evaluate the policy updated by the actor. The higher V(s) is, the higher long-term utility the policy will provide. To evaluate the policy, the critic constantly updates the state value function, which is similar to the policy evaluation in the policy iteration algorithm.

At a state s^{k}, the actor performs action ξ^{k} drawn from the mixed action π^{k}(s^{k},ξ^{k}), where π^{k} is the policy updated at time slot k. Then, the wireless user receives an immediate reward R(s^{k},ξ^{k}) and transits to next state s^{k+1}, which is associated with an estimated state-value function V^{k}(s^{k+1}). We can define a time-difference error δ^{k} to represent the difference of the state-value function V^{k}(s^{k}) estimated at the previous stage and the state-value function (R(s^{k},ξ^{k})+γV^{k}(s^{k+1})) estimated at current stage, i.e.

δ^{k}=R(s^{k},ξ^{k})+γV^{k}(s^{k+1})−V^{k}(s^{k}), (22)

where V^{k}(·) is the estimated future rewards for stage k. Thus, we can update the state-value function, given the current reward R(s^{k},ξ^{k}) as follows:

V^{k+1}(s^{k})←V^{k}(s^{k})+α^{k}δ^{k}, (23)

where α^{k}^{₁} is a positive step-size parameter and satisfies the conditions: Σₖα^{k}=∞ and Σₖ(α^{k})²<∞. The value of α^{k}(β^{k} in Eq. (24)) may be 1/k, or 1/k log k. The value of α^{k}(β^{k} in Eq. (24)) can be 1/k, or 1/k log k.

The time-difference error δ^{k} defined in Eq. (22) is also used to criticize the selected action. If the error δ^{k} is positive, it means that the selected action ξ^{k} generates a higher reward and the tendency to select action ξ^{k} should be strengthened in the future. If the error δ^{k} is negative, the tendency to select ξ^{k} should be weakened. The strengthening and weakening of the action can then be implemented by increasing or decreasing the tendency, as follows:

ρ^{k+1}(s^{k},ξ^{k})←ρ^{k}(s^{k},ξ^{k})+β^{k}δ^{k}, (24)

where β^{k} is a positive step-size parameter and reflects the learning rate for the tendency update. β^{k} satisfies the conditions of Σₖβ^{k}=∞ and Σₖ(β^{k})²<∞.

Based on the layered decomposition of the solution to the MDP problem discussed earlier, a layered actor-critic learning algorithm, which takes into account the current layered network architecture, is now described.

### QoS Frontier Generators:

As discussed earlier, in cross-layer optimization architecture, at the beginning of each time slot, each layer l (except layer L) computes optimal QoS frontier [symbol] ₗ(s₁, . . . , sₗ) using the QoS generator for each layer and forward the optimal QoS frontier to its upper layer. Then, layer L has the optimal QoS frontier [symbol] _{L-1}(s₁, . . . , s_{L-1}), which serves as the QoS space for the actor at layer L.

Critics:

From the layered decomposition of the MDP solutions, we can endow each layer l with a composite state (s₁, . . . , s_{L},s′₁, . . . , s′ₗ₋₁), which includes the current states of all the layers and the next states of the below layers. For each composite state, the critic at layer l has the state value function Vₗ₋₁(s₁, . . . , s_{L},s′₁, . . . , s′ₗ₋₁), which is used to evaluate the policy given by the actors. Details of the state-value function will be described shortly. Layer 1 has the composite state (s₁, . . . , s_{L}) and state value function V(s₁, . . . , s_{L}). The critic at layer l will update the state-value function.

Actors:

Since each layer does not know the next states of the layers below it when performing the transmission action, we focus on the stochastic policy which only depends on the current states (s₁, . . . , s_{L}). Hence, the actor at layer l(<L) has the tendency ρₗ(s₁, . . . , s_{L},aₗ) to update. The actor at layer L has the tendency ρₗ(s₁, . . . , s_{L},a_{L}b_{L},Z_{L-1}) to update. The policy at layer l is generated by

$${π}_{l} ( {s}_{1} , … , {s}_{L} , {a}_{l} ) = \frac{{e}^{{ρ}_{l} ( {s}_{1} , … , {s}_{L} , {a}_{l} )}}{{\sum }_{{a}_{l}^{′} ∈ {A}_{l}} {e}^{{ρ}_{l} ( {s}_{1} , … , {s}_{L} , {a}_{l}^{′} )}} , \qquad ( 25 )$$

and the policy at layer L is generated by

$${π}_{L} ( {s}_{1} , … , {s}_{L} , {a}_{L} , {b}_{L} , {Z}_{L - 1} ) = \frac{{e}^{{ρ}_{L} ( {s}_{1} , … , {s}_{L} , {a}_{L} , {b}_{L} , {Z}_{L - 1} )}}{{\sum }_{{a}_{L}^{′} ∈ {A}_{L} , {b}_{L}^{′} ∈ {B}_{L} , {Z}_{L}^{′} ∈ {𝒵}_{L - 1} ( {s}_{1} , … , {s}_{L - 1} )} {e}^{{ρ}_{L} ( {s}_{1} , … , {s}_{L} , {a}_{L}^{′} , {b}_{L}^{′} , {Z}_{L - 1}^{′} )}} . \qquad ( 26 )$$

The policies obtained at each layer from the tendency are stochastic policies.

### State-Value Function Update

In the centralized actor-critic learning algorithm, the time-difference error is used to update the state-value functions and criticize the selected actions. Similarly, we can define the time difference error δₗ^{k} for each layer. From Table 1, we can define the time-difference error at layer l as

$${δ}_{l}^{k} = \{ \begin{matrix}\begin{matrix}g ( {s}_{L}^{k} , {b}_{L}^{k} , {Z}_{L}^{k} ) - {λ}_{L} {c}_{L} ( {a}_{L}^{k} ) + \\ γ {V}^{k} ( {s}_{1}^{k + 1} , … , {s}_{L}^{k + 1} ) - \\ {V}_{L - 1}^{k} ( {s}_{1}^{k} , … , {s}_{L}^{k} , {s}_{1}^{k + 1} , … , {s}_{L - 1}^{k + 1} )\end{matrix} & l = L \\ \begin{matrix}- {λ}_{l} {c}_{l} ( {s}_{l}^{k} , {a}_{l}^{k} ) + \\ {V}_{l}^{k + 1} ( {s}_{1}^{k} , … , {s}_{L}^{k} , {s}_{1}^{k + 1} , … , {s}_{l}^{k + 1} ) - \\ {V}_{l - 1}^{k} ( {s}_{1}^{k} , … , {s}_{L}^{k} , {s}_{1}^{k + 1} , … , {s}_{l - 1}^{k + 1} )\end{matrix} & l = 2 , … , L - 1 \\ \begin{matrix}- {λ}_{1} {c}_{1} ( {s}_{1}^{k} , {a}_{1}^{k} ) + \\ {V}_{1}^{k + 1} ( {s}_{1}^{k} , … , {s}_{L}^{k} , {s}_{1}^{k + 1} ) - \\ {V}^{k} ( {s}_{1}^{k} , … , {s}_{L}^{k} )\end{matrix} & l = 1.\end{matrix} \qquad ( 27 )$$

From Eq. (27), the time-difference error at layer L is computed as the difference between the current estimated state-value function for the composite state (s₁^{k}, . . . , s_{L}^{k},s₁^{k+1}, . . . , s_{L-1}^{k+1}) i.e. g(s_{L}^{k},b_{L}^{k},Z_{L}^{k})−λ_{L}c_{L}(a_{L}^{k})+γV^{k}(s₁^{k+1}, . . . , s_{L}^{k+1}), and previously estimated state-value function V_{L-1}^{k}(s₁^{k}, . . . , s_{L}^{k},s₁^{k+1}, . . . , s_{L-1}^{k+1}). This time-difference error is used to update the state-value function V_{L-1}^{k}(s₁^{k}, . . . , s_{L}^{k}, s₁^{k+1}, . . . , s_{L-1}^{k+1}) and the tendency ρ(s₁^{k}, . . . , s_{L}^{k},a_{L}^{k},b_{L}^{k},Z_{L}^{k}) at layer L to criticize the selected external action a_{L}^{k}, internal action b_{L}^{k} and QoS level Z_{L-}^{k}. \

The updated state-value function V_{L-1}^{k}(s₁^{k}, . . . , s_{L}^{k},s₁^{k+1}, . . . , s_{L-1}^{k+1}) is then forwarded to layer L−1. The time difference error at layer l=2, . . . , L−1 is computed as the difference of the current estimated state-value function −λₗcₗ(sₗ^{k},aₗ^{k})+Vₗ^{k+1}(s₁^{k}, . . . , s_{L}^{k},s₁^{k+1}, . . . , sₗ^{k+1}) at layer l and the previously estimated state-value function Vₗ₋₁^{k}(s₁^{k}, . . . , s_{L}^{k},s₁^{k+1}, . . . , sₗ₋₁^{k+1}). The updated state-value function Vₗ₋₁^{k}(s₁^{k}, . . . , s_{L},s₁^{k+1}, . . . , sₗ₋₁^{k+1}) is then forwarded to layer l−1. At layer 1, the time difference error is computed as the difference of the current estimated state-value function −λ₁c₁(s₁^{k},a₁^{k})+V₁^{k}(s₁^{k}, . . . , s_{L}^{k},s₁^{k+1}) and the previously estimated state-value function V^{k}(s₁^{k}, . . . , s_{L}^{k}), which is the global state-value function. We also note that the state-value function V^{k}(s₁^{k}, . . . , s_{L}^{k}) will be forwarded to layer L for the update in the next time slot.

Similar to Eq. (23) Vₗ₋₁^{k}(s₁^{k}, . . . , s_{L}^{k},s₁^{k+1}, . . . , sₗ₋₁^{k+1}) is updated at layer l as

Vₗ₋₁^{k+1}(s₁^{k}, . . . , s_{L}^{k},s₁^{k+1}, . . . , sₗ₋₁^{k+1})←Vₗ₋₁^{k}(s₁^{k}, . . . , s_{L}^{k},s₁^{k+1}, . . . , sₗ₋₁^{k+1})+αₗ^{k}δₗ^{k},l=1, . . . , L (28)

where V₀(s₁, . . . , s_{L})=V(s₁, . . . , s_{L}) and αₗ^{k},l=1, . . . , L satisfy the conditions of Σₖαₗ^{k}=∞ and Σₖ(αₗ^{k})²<∞. The initial value of the state-value function Vₗ and tendency ρ_{L} can be zero.

### Policy Update

Given the state at each layer, the internal actions are independent of the environmental dynamics. As discussed earlier related to cross-layer optimization, each layer forwards to its upper layer the optimal QoS level set [symbol] ₗ, which only depends on the state s of that layer. Therefore, layer L can select the optimal QoS Z_{L-1}ε [symbol] _{L-1}(s₁, . . . , s_{L-1}). Similar to Eq. (24), the tendency at layer L is updated using the time-difference error δ_{L}^{k} to strengthen or weaken the currently selected action (including the internal and external actions), as follows:

ρ_{L}^{k+1}(s₁^{k}, . . . , s_{L}^{k},a_{L}^{k},b_{L}^{k},Z_{L-1}^{k})←ρ_{L}^{k}(s₁^{k}, . . . , s_{L}^{k},a_{L}^{k},b_{L}^{k},Z_{L-1}^{k})+β_{L}^{k}δ_{L}^{k} (29)

Similarly, the tendency at layer l is updated as

ρₗ^{k+1}(s₁^{k}, . . . , s_{L}^{k},aₗ^{k})←ρₗ^{k}(s₁^{k}, . . . , s_{L}^{k},aₗ^{k})+βₗ^{k}δₗ^{k},l=1, . . . , L−1 (30)

In Eqs. (29) and (30), βₗ^{k},l=1, . . . , L satisfy the conditions of Σₖβₗ^{k}=∞ and Σₖ(βₗ^{k})²<∞.

From Eqs. (25) and (26), it is noted that, given the tendency, the policy at each layer is also determined. Then, by updating the tendency as in Eq. (29) and (30), the policy at each layer is also updated. Hence, we also refer to Eqs. (29) and (30) as the policy update.

### Convergence Analysis for Layered Learning

In this section, we prove that the proposed layered learning algorithm converges to the optimal policy at each layer. In Lemma 2 below, we will show that the state-value function at each layer converges to the optimal state-value function associated with the given policy [π₁(s₁, . . . , s_{L},a₁), . . . , π_{L}(s₁, . . . , s_{L},a_{L},b_{L},Z_{L-1})]. In Lemma 3, we further prove that, the updated policy (i.e. tendency) will converge to the optimal policy if, at each stage, the optimal state-value function at each layer associated with the current policy is available. In Theorem 2, we show that simultaneous update of the state-value function and policy at each layer will also converge to the optimal state-value function and optimal policy.

Lemma 2: Using the update in Eq. (28), the state value function Vₗ₋₁^{k}(s₁^{k}, . . . , s_{L}^{k},s₁^{k+1}, . . . , sₗ₋^{k+1}) (l=1, . . . , L) converges to the optimal state value function V*ₗ₋₁(s₁, . . . , s_{L},s′₁, . . . , s′ₗ₋₁), which corresponds to the policy [π₁(s₁, . . . , s_{L},a₁), . . . , π_{L}(s₁, . . . , s_{L},a_{L},b_{L},Z_{L-1})].

### Proof:

Let \tilde{s}ₗ=(s₁, . . . , s_{L},s′₁, . . . , s′ₗ₋₁) be the composite state at layer l. Given the composite state \tilde{s}ₗ, we define a mapping F^{\tilde{s}}^{ₗ} at layer l as for l=L:

$${F}^{{\tilde{s}}_{L}} ( {π}_{L} , V ) = {\sum }_{\begin{matrix}{a}_{L} ∈ {A}_{L} {b}_{L} ∈ {B}_{L} , \\ {Z}_{L - 1} ∈ {𝒵}_{L - 1} ( {s}_{1} , … , {s}_{L - 1} )\end{matrix}} {π}_{L} ( {s}_{1} , … , {s}_{L} , {a}_{L} , {b}_{L} , {Z}_{L - 1} ) \times [ \begin{matrix}g ( {s}_{L} , {b}_{L} {Z}_{L - 1} ) - {λ}_{L} c ( {s}_{L} , {a}_{L} ) + \\ γ {\sum }_{{s}_{L}^{′} ∈ {S}_{L}} p ( {s}_{L}^{′} \vert {s}_{L} , {a}_{L} , {b}_{L} , {Z}_{L - 1} ) V ( {s}_{1}^{′} , … , {s}_{L}^{′} )\end{matrix} ] ; \qquad ( 31 )$$

for l=1, . . . , L−1

$${F}^{{\tilde{s}}_{l}} ( {π}_{l} , {V}_{l} ) = {\sum }_{{a}_{l} ∈ {A}_{l}} {π}_{l} ( {s}_{1} , … , {s}_{L} ) [ \begin{matrix}- {λ}_{l} {c}_{l} ( {s}_{l} , {a}_{l} ) + \\ {\sum }_{{s}_{l}^{′} ∈ {𝒮}_{l}} p ( {s}_{l}^{′} \vert {s}_{l} , {a}_{l} ) {V}_{l} ( {s}_{1} , … , {s}_{L} , {s}_{1}^{′} , … , {s}_{l}^{′} )\end{matrix} ] . \qquad ( 32 )$$

It is easy to verify that, for fixed πₗ, the following contraction condition holds:

$${‖ {F}^{{\tilde{s}}_{l}} ( {π}_{l} , {V}_{l} ) - {F}^{{\tilde{s}}_{l}} ( {π}_{l} , {V}_{l}^{′} ) ‖}_{∞} \{ \begin{matrix}\leq {‖ {V}_{l} - {V}_{l}^{′} ‖}_{∞} & if l = 1 , … , L - 1 \\ \leq γ {‖ {V}_{L} - {V}_{L}^{′} ‖}_{∞} & if l = L .\end{matrix} \qquad ( 33 )$$

This contraction guarantees that the following iteration converges:

$$\begin{matrix}{V}_{L - 1}^{k + 1} ( {\tilde{s}}_{L} ) = {F}^{{\tilde{s}}_{L}} ( {π}_{L} , {V}^{k} ) \\ {V}_{L - 2}^{k + 1} ( {\tilde{s}}_{L - 1} ) = {F}^{{\tilde{s}}_{L - 1}} ( {π}_{L - 1} , {V}_{L - 1}^{k + 1} ) \\ ⋮ \\ {V}^{k + 1} ( {\tilde{s}}_{1} ) = {F}^{{\tilde{s}}_{1}} ( {π}_{1} , {V}_{1}^{k + 1} ) .\end{matrix} \qquad ( 34 )$$

The solution the above iteration converges to the optimal state value function corresponding to the given policy. Based on the iteration form in Eq. (34), the update in Eq. (28) can be rewritten as

$$\begin{matrix}{V}_{L - 1}^{k + 1} ( {\tilde{s}}_{L} ) = {V}_{L - 1}^{k} ( {\tilde{s}}_{L} ) + {α}_{L}^{k} ( {F}^{{\tilde{s}}_{L}} ( {π}_{L} , {V}^{k} ) - {V}_{L - 1}^{k} ( {\tilde{s}}_{L} ) ) + {α}_{L}^{k} {M}_{L}^{k} \\ ⋮ \\ {V}^{k + 1} ( {\tilde{s}}_{1} ) = {V}^{k} ( {\tilde{s}}_{1} ) + {α}_{1}^{k} ( {F}^{{\tilde{s}}_{1}} ( {π}_{1} , {V}_{1}^{k + 1} ) - {V}^{k} ( {\tilde{s}}_{1} ) ) + {α}_{1}^{k} {M}_{1}^{k} ,\end{matrix} \qquad ( 35 )$$

where M₁^{k}, . . . , M_{L}^{k} are the Martingale processes satisfy E[Mₗ^{k+1}|V_{l′-1}^{k′},M_{l′}^{k′},k′≦k,l′=1, . . . , L,]=0. The form in Eq. (35) is referred to the stochastic approximation. The stochastic approximation is often used to prove the convergence of the distributed and asynchronous optimization. It has been proven that the stochastic approximation approaches the solution of the linear iteration in Eq. (34).

Lemma 3: Assume that Vₗ₋₁^{π}^{^{k}}(\tilde{s}ₗ) is the optimal state value function at layer l=1, . . . , L associated with the policy [π₁^{k}, . . . , π_{L}^{k}], then the policy update in Eqs. (29) and (30) enables the updated policy to converge to the optimal stochastic policy.

### Proof:

We define the mapping at each layer l as follows: for l=L

$$\begin{matrix}{G}_{L}^{s , {a}_{L} , {b}_{L} , {Z}_{L - 1}} ( {ρ}_{L} ) = {ρ}_{L} ( s , {a}_{L} , {b}_{L} , {Z}_{L - 1} ) + [ \begin{matrix}g ( {s}_{L} , {b}_{L} , {Z}_{L - 1} ) - {λ}_{L} c ( {s}_{L} , {a}_{L} ) + \\ γ {\sum }_{{s}_{L}^{′} ∈ {S}_{L}} p ( {s}_{L}^{′} \vert {s}_{L} , {a}_{L} , {b}_{L} , {Z}_{L - 1} ) {V}^{π} ( {\tilde{s}}_{1}^{′} ) - {V}_{L - 1}^{π} ( {\tilde{s}}_{L} )\end{matrix} ] ; \\ for l = 1 , … , L - 1 , & ( 36 ) \\ {G}_{l}^{s , {a}_{l}} ( {ρ}_{l} ) = {ρ}_{l} ( s , {a}_{l} ) + [ - {λ}_{l} {c}_{l} ( {s}_{l} , {a}_{l} ) + {\sum }_{{s}_{l}^{′} ∈ {𝒮}_{l}} p ( {s}_{l}^{′} \vert {s}_{l} , {a}_{l} ) {V}_{l}^{π} ( {\tilde{s}}_{l} ) - {V}_{l - 1}^{π} ( {\tilde{s}}_{l - 1} ) ] . & ( 37 )\end{matrix}$$

From the proof of Lemma 2, it is known that Vₗ^{π} is characterized by a linear system of Eq. (34). It depends smoothly on the policy πₗ, hence on the tendency ρₗ. It is easy to show that the iteration using the mapping defined in Eqs. (36) and (37) will converge to the optimal policy. Then, using this mapping, we can rewrite the policy updates as the following stochastic approximation forms:

$$\begin{matrix}{ρ}_{L}^{k + 1} ( {s}_{1}^{k} , … , {s}_{L}^{k} , {a}_{L}^{k} , {b}_{L}^{k} , {Z}_{L - 1}^{k} ) = {ρ}_{L}^{k} ( {s}_{1}^{k} , … , {s}_{L}^{k} , {a}_{L}^{k} , {b}_{L}^{k} , {Z}_{L - 1}^{k} ) + {β}_{L}^{k} ( \begin{matrix}{G}_{L , {s}_{1} , … , {s}_{L} , {a}_{L}^{k} , {b}_{L}^{k} , {Z}_{L - 1}^{k}} ( {ρ}_{L}^{k} ) - \\ {ρ}_{L}^{k} ( {s}_{1}^{k} , … , {s}_{L}^{k} , {a}_{L}^{k} , {b}_{L}^{k} , {Z}_{L - 1}^{k} )\end{matrix} ) + {β}_{L}^{k} {N}_{L}^{k} , & ( 38 ) \\ {ρ}_{l}^{k + 1} ( {s}_{1}^{k} , … , {s}_{L}^{k} , {a}_{l}^{k} ) = {ρ}_{l}^{k} ( {s}_{1}^{k} , … , {s}_{L}^{k} , {a}_{l}^{k} ) + {β}_{l}^{k} ( {G}_{L , {s}_{1} , … , {s}_{L} , {a}_{l}^{k}} ( {ρ}_{l}^{k} ) - {ρ}_{l}^{k} ( {s}_{1}^{k} , … , {s}_{L}^{k} , {a}_{l}^{k} ) ) + {β}_{l}^{k} {N}_{l}^{k} , \\ l = 1 , … , L - 1 & ( 39 )\end{matrix}$$

where N₁^{k}, . . . , N_{L}^{k} are the Martingale processes that satisfy E[Nₗ^{k+1}|ρ_{l′}^{k′},N_{l′}^{k′},k′≦k,l′=1, . . . , L,]=0. It has been proven that the stochastic approximation approaches the optimal policy.

Theorem 2. With probability one, the update of the state-value function and policy listed in Eqs. (28), (29) and (30) converges to {(V*_{L-1}, . . . , V*₁,V*,π*_{L}, . . . , π*₁,ρ*_{L}, . . . , ρ*₁)}, where π*ₗ is the optimal stationary policy, ρ*ₗ is the optimal tendency generating π*ₗ, and V*ₗ₋₁(l=1, . . . , L and V*₀=V*) are the optimal state value functions corresponding to the optimal policy

$$π = [ {π}_{1}^{*} , … , {π}_{L}^{*} ] , if {lim}_{k \to ∞} \frac{{β}_{{l}^{′}}^{k}}{{α}_{l}^{k}} = 0 , ∀ l , {l}^{′} .$$

Proof: In the discussions related to Lemma 2 and Lemma 3, it is shown that both the state-value function update and policy update can be rewritten as the stochastic approximation forms in Eqs. (35) and (38). The stochastic approximation in Eq. (35) is to track the optimal state-value function associated with the policy at each layer updated at the current time. The stochastic approximation in Eq. (38) is to track the optimal policy at each layer. Then, the stochastic approximation in Eq. (35) serves as an inner loop and the one in Eq. (38) serves as an outer loop. With the condition

$${lim}_{k \to ∞} \frac{{β}_{{l}^{′}}^{k}}{{α}_{l}^{k}} = 0 ,$$

∀l, l′, the inner loop moves on a faster time scale than the outer loop. Using the “two-time-scale” stochastic approximation, we can show that the state-value function update and policy update converge to the optimal state-value function and corresponding optimal policy.

In the proof of convergence, it was assumed that the environmental dynamics are stationary and Markovian. In reality, however, the dynamics at different layers may not be exactly stationary or may even be non-Markovian. Nevertheless, the layered actor-critic learning algorithms can learn an explicitly stochastic policy (that is, they can learn the optimal probabilities of selecting various actions) and are equally usable in competitive and non-Markov cases. The other solution dealing with the non-stationary environmental dynamics is to set the constant update step size (i.e. αₗ^{k},βₗ^{k} being constant) in order to track the dynamics.

### Implementation of Layered Learning

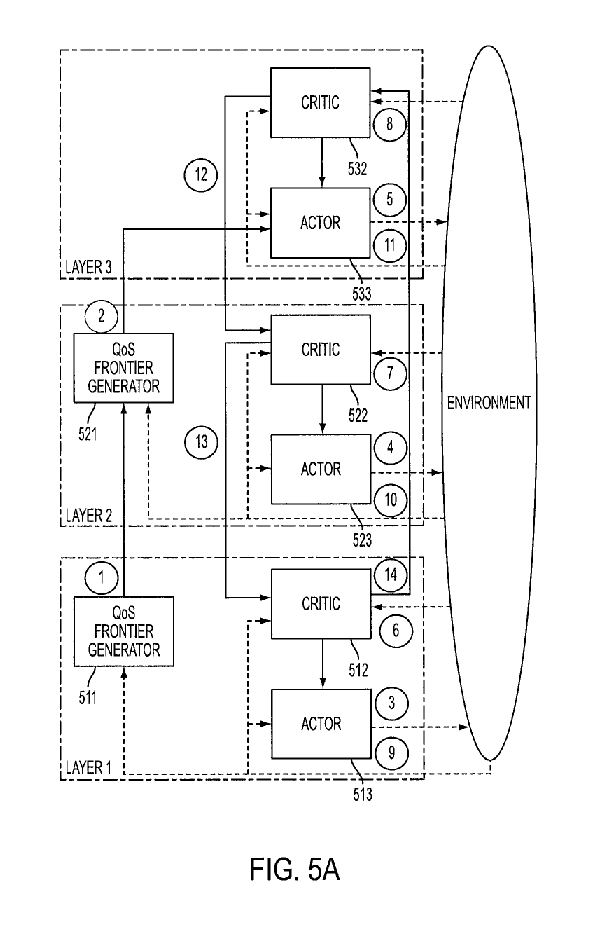

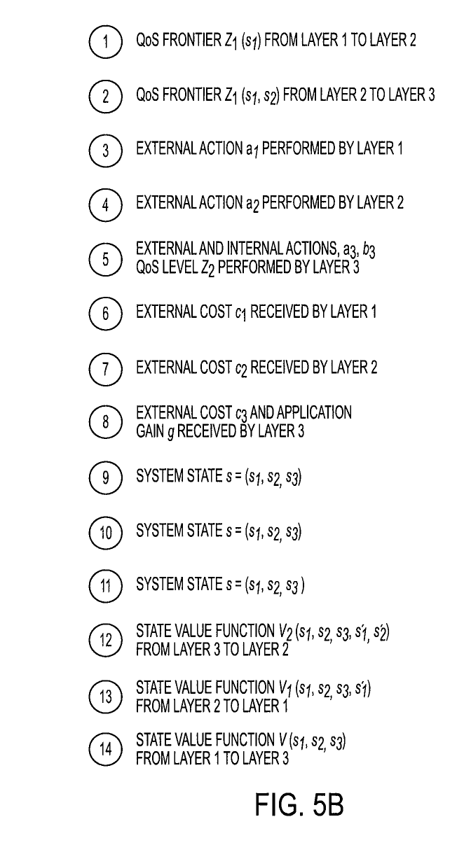

FIGS. 5A and 5B are a schematic block diagram of an exemplary communication node implementing layered learning adaptive to changes in environmental dynamics. For simplicity of illustration, FIGS. 5A and 5B only show operations of an upper layer 3, such as the APP layer, a lower layer 1, such as the PHY layer, and an intermediate layer 2, such as MAC layer. It is understood that multiple intermediate layers may be implemented and operable under the same architecture in a manner similar to the illustrated layer 2.

As shown in FIGS. 5A and 5B, layer 1 is provided with a QoS frontier generator 511, an actor element 513 and a critic element 512. Layer 2 is provided with a QoS frontier generator 521, an actor element 523 and a critic element 522. Layer 3 is provided with a critic element 532 and an actor element 533. The QoS frontier generators, critic elements and actor elements may be implemented using one or more controllers in combination with instruction codes which, upon execution by the controller, control the communication node to perform actions prescribed by the instruction codes.

At the beginning of each time slot, each layer l (except layer L) will compute optimal QoS frontier [symbol] ₗ(s₁, . . . , sₗ) using the QoS generator for that layer in manners described above and forward the optimal QoS frontier to its upper layer. QoS frontier generator 511 is configured to generate optimal QoS frontier 1 based on system state 9, in manners described earlier. Optimal QoS frontier is sent to layer 2. QoS frontier generator 521 in layer 2 generates optimal QoS frontier 2 based on QoS frontier 1 provided by layer 1 and current states of all layers 1, 2 and 3. Optimal QoS frontier 2 is sent to layer 3 as an input of actor element 533. Layer 3 now has the optimal QoS frontier 12, which serves as the QoS space for the actor at layer 3.

As discussed earlier, each layer is provided with information related to a composite system state (s₁, . . . , s_{L},s′₁, . . . , s′ₗ₋₁), which includes the current states of all the layers and the next states of the below layers. Each actor element at layer l(<L) has the tendency ρₗ(s₁, . . . , s_{L},aₗ) to update, and actor element 533 at layer L has the tendency ρₗ(s₁, . . . , s_{L},a_{L},b_{L},Z_{L-1}) to update. The policies at layers 1 and 2 are generated by actor elements 513, 523 using equation (40) and the policy at layer 3 is generated by actor element 533 according to equation (41).

Based on the calculated policies, actor element 533 at layer 3 selects and performs suitable internal and external actions 5, to transmit data, and actor element 513, 523 select and perform suitable external actions. In response to the performed actions 5, costs and system gain 6 is calculated and sent to critic element 533; and responsive to the performed actions 3, 4, external costs 6, 7 are received by layers 1, 2.

For each composite state, the critic element at layer l utilizes a state-value function Vₗ₋₁(s₁, . . . , s_{L},s′₁, . . . , s′ₗ₋₁) to evaluate the effects of policy given by the actor elements.

As discussed earlier, a time difference error δₗ^{k} for each layer is defined in equation (27). From Eq. (27), the time-difference error at layer L, such as layer 3, is computed as the difference between the current estimated state-value function for the composite state (s₁^{k}, . . . , s_{L}^{k},s₁^{k+1}, . . . , s_{L-1}^{k+1}) i.e. g(s_{L}^{k},b_{L}^{k},Z_{L}^{k})−λ_{L}c_{L}(a_{L}^{k})+γV^{k}(s₁^{k+1}, . . . , s_{L}^{k+1}) and previously estimated state-value function V_{L-1}^{k}(s₁^{k}, . . . , s_{L}^{k},s₁^{k+1}, . . . , s_{L-1}^{k+1}). This time-difference error is used to update the state-value function V_{L-1}^{k}(s₁^{k}, . . . , s_{L}^{k},s₁^{k+1}, . . . , s_{L-1}^{k+1}) and the tendency ρ(s₁^{k}, . . . , s_{L}^{k},a_{L}^{k},b_{L}^{k},Z_{L}^{k}) at layer 3 to criticize the selected external action, internal action and QoS level received from lower levels. Actor elements 533 adjusts external and internal actions based on the time difference error. The updated state-value function V_{L-1}^{k}(s₁^{k}, . . . , s_{L}^{k},s₁^{k+1}, . . . , s_{L-1}^{k+1}) 12 forwarded to layer 2.

The time difference error at layer 2 is computed as the difference of the current estimated state-value function −λₗcₗ(sₗ^{k},aₗ^{k})+Vₗ^{k+1}(s₁^{k}, . . . , s_{L}^{k},s₁^{k+1}, . . . , sₗ^{k+1}) at layer 2 and the previously estimated state-value function Vₗ₋₁^{k}(s₁^{k}, . . . , s_{L}^{k}, s₁^{k+1}, . . . , sₗ₋₁^{k+1}). Similar level 3, the calculated time difference error at layer 2 is used to update the state-value function 13, which is forwarded to layer 1.

At layer 1, the time difference error is computed as the difference of the current estimated state-value function −λ₁c₁(s₁^{k},a₁^{k})+V₁^{k}(s₁^{k}, . . . , s_{L}^{k},s₁^{k+1}) and the previously estimated state-value function V^{k}(s₁^{k}, . . . , s_{L}^{k}), which is the global state-value function. The calculated time difference is sent to actor element 513, based on which actor element 513 adjusts the external action for the next time slot. The updated state-value function V^{k}(s₁^{k}, . . . , s_{L}^{k}) 14 forwarded to layer L for the update in the next time slot.

Similar to Eq. (23), Vₗ₋₁^{k}(s₁^{k}, . . . , s_{L}^{k},s₁^{k+1}, . . . , sₗ₋₁^{k+1}) is updated at layer l as

Vₗ₋₁^{k+1}(s₁^{k},s_{L}^{k},s₁^{k+1}, . . . , sₗ₋₁^{k+1})←Vₗ₋₁^{k}(s₁^{k}, . . . , s_{L}^{k},s₁^{k+1}, . . . , sₗ₋₁^{k+1})+αₗ^{k}δₗ^{k},l=1, . . . , L

where V₀(s₁, . . . , s_{L})=V(s₁, . . . , s_{L}) and αₗ^{k}, l=1, . . . , L satisfy the conditions of Σₖαₗ^{k}=∞ and Σₖ(αₗ^{k})²<∞.

Given the state at each layer, the internal actions are independent of the environmental dynamics. Each layer forwards to its upper layer the optimal QoS level set [symbol] ₗ, which only depends on the state S and hence, layer L can select the optimal QoS Z_{L-1}ε [symbol] _{L-1}(s₁, . . . , s_{L-1}). Similar to Eq. (24), the tendency at layer L is updated using the time-difference error δ_{L}^{k} to strengthen or weaken the currently selected action (including the internal and external actions), as follows:

ρ_{L}^{k+1}(s₁^{k}, . . . , s_{L}^{k},a_{L}^{k},b_{L}^{k},Z_{L-1}^{k})←ρ_{L}^{k}(s₁^{k}, . . . , s_{L}^{k},a_{L}^{k},b_{L}^{k},Z_{L-1}^{k})+β_{L}^{k}δ_{L}^{k}

Similarly, the tendency at layer l is updated as

ρₗ^{k+1}(s₁^{k}, . . . , s_{L}^{k},aₗ^{k})←ρₗ^{k}(s₁^{k}, . . . , s_{L}^{k},aₗ^{k})+βₗ^{k}δₗ^{k}, l=1, . . . , L−1

In the equations, βₗ^{k},l=1, . . . , L satisfy the conditions of Σₖβₗ^{k}=∞ and Σₖ(βₗ^{k})²<∞.

At each layer, given the tendency, the policy at each layer is determined. By updating the tendency, the policy at each layer is also updated.

Accordingly, based on the exemplary architecture and message exchanges between layers illustrated in FIGS. 5A and 5B, each layer is allowed to independently determine a suitable action in light of environment dynamics experienced by that layer. Any changes in the environment dynamics and reactions/costs associated with performed actions are feedback to each layer, to further adjust actions to be performed by each layer, to achieved optimized performance.

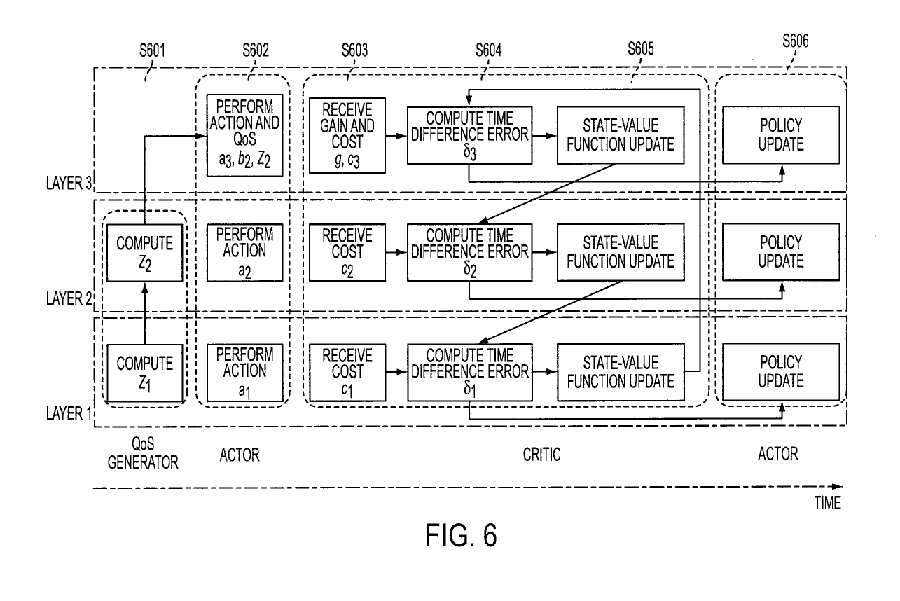

FIG. 6 is a schematic flow chart showing the operations of the system of FIGS. 5A and 5B, with time reference. In step 601, optimal frontier QoS are calculated by QoS generators 511, 521 for layers 1 and 2. The optimal frontier QoS generated by level 2 is sent to actor element 533 of level 3. In Step 602, actor elements 513, 523 for levels 1 and 2 perform selected actions a1 and a2, while actor element 533 of level 3 performs selected actions a3, b3 and sends QoS level Z2 performed by level 3. In Step 603, level 3 receives gain and cost associated with the performed actions, and levels 1 and 2 receive information of costs related to the performed actions. In Step 604, time difference errors are calculated for levels 1, 2, 3, based on the costs associated with actions performed by each layer. The time difference errors gauge how well the performed actions are. In Step 605, state-value functions for the layers are updated according to the calculated time difference errors. In Step 606, policies for the actor elements are updated according to the calculated time difference errors. The updated policies are used to generate preferred actions for future time slots.

### Cross-Layer Optimization and Dynamic Learning for Delay-Sensitive Applications

Embodiments of cross-layer optimization and dynamic learning for delay-sensitive applications, such as multimedia streaming, are now described. For delay-sensitive applications, such as video streaming applications, each data unit (DU) may be one frame, part of a frame, or one group of pictures. Each DU may comprise one or more data packets. The DUs may be independently decoded or interdependently decoded. An optimal packet scheduling strategy transmits a group of packets to minimize the consumed energy, while satisfying their common delay deadline.

Unique techniques are developed to determine the optimal scheduling action, such as optimal starting transmission time (STX) and ending transmission time (ETX) for each data unit (DU) of the delay-sensitive applications at the application layer. Based on the determined scheduled time, optimal transmission actions at lower layers are determined. Cross-layer optimization is performed to minimize distortions experienced by the delay-sensitive application. Operations of the exemplary system are adaptive to changes in environment dynamics, such that optimized performances may be achieved even in a constantly-changing environment, with known or even unknown network conditions.

According to one embodiment of this disclosure, operations of the exemplary system are formulated as a non-linear constrained optimization problem by assuming complete knowledge of the application characteristics and the underlying network conditions. The constrained cross-layer optimization is decomposed into several cross-layer optimization subproblems for each DU and two master problems. These two master problems correspond to the resource price update implemented at the lower layer (e.g. physical layer, MAC layer) and the impact factor update for neighboring DUs implemented at the application layer, respectively. The term resource price represents an assessment of consumption or a usage cost of system resource at each layer associated with transmission of the data units. Examples of resources of each layer include transmission power at application layer, transmission time at MAC layer, etc. The decomposition determines the necessary message exchanges between layers for achieving the optimal cross-layer solution and explicitly considers how the cross-layer strategies selected for one DU will impact its neighboring DUs and DUs dependent thereon. In one embodiment, the resource price is a signal representing how much higher or lower consumed resource is associated with the transmission of a data unit relative to a budgeted resource for such transmission. If the consumed system resource associated with the transmission of a respective data unit is larger than a budgeted system resource for such transmission, then the resource price associated with the transmission of the respective data unit is high. On the other hand, if the consumed system resource associated with the transmission of a respective data unit is lower than a budgeted system resource for such transmission, then the resource price associated with the transmission of the respective data unit is low.

Generally, data units attributes are used to describe characteristics of data units. Attributes of data units include the attributes of the data units include at least one of a delay deadline, a distortion impact from the loss of each data unit, data units available for transmission, and size information of each data unit for transmission, etc. Attributes (e.g. distortion impact, delay deadline etc) of future DUs and network conditions often are unknown in real-time applications. The impact of current cross-layer actions on future DUs may be characterized by a state-value function in the Markov decision process (MDP) framework. In one embodiment, a low-complexity cross-layer optimization algorithm using online learning is applied to each DU transmission. The online optimization utilizes information about previous transmitted DUs and network conditions experienced in the past. This optimization algorithm may be implemented real-time applications to cope with unknown source characteristics, network dynamics and resource constraints.

In the exemplary communication node, cross-layer optimization decisions is performed for each DU. Both independently decodable DUs, which are decoded independently without requiring the knowledge of other DUs, and interdependent DUs, which require information of DUs that they depend on when decoded, are considered. A non-linear constrained optimization problem is formulated by assuming complete knowledge of attributes of the application DUs and the underlying network conditions, such as the time ready for transmission, delay deadlines, DU size and distortion impact and DAG-based dependencies, etc. This is the case, for instance, when the multimedia data was pre-encoded and hinting files were created before transmission time. On the other hand, in the real-time encoding, these attributes are known just in time when the packets are deposited in the streaming buffer, which will be addressed in the later part of this disclosure.

As discussed earlier, for each DU, cross-layer optimization is formulated and performed. This cross-layer optimization for each DU is referred to herein as Per-DU Cross-Layer Optimization (DUCLO). For interdependent DUs, the DUCLOs are solved iteratively in a round-robin style. Additionally, as described earlier, during the cross-layer optimization for delay-sensitive applications, the exemplary system considers two master problems associated with the optimization. The first master problem is called Price Update (PU), which evaluates costs of used resources. For instance, an exemplary PU may correspond to the Lagrange multiplier (i.e. price or cost of the resource) update associated with the considered resource constraint imposed at the lower layer, such as energy constraint. A second master problem is called Neighboring Impact Factor Update (NIFU), which is implemented at the application layer. A neighboring impact represents an impact from the transmission of a specific data unit to available resources that can be allocated to a data unit neighboring the specific data unit. The available resources may include transmission scheduling, such as transmission time available for transmitting the neighboring data unit, power, available memory space, available spectrum or bandwidth, or any other resources needed with transmitting a data unit that is known to people skilled in the art.

In one embodiment, the neighboring impact is formulate to represent an impact from the transmission scheduling of a respective data unit to the transmission scheduling of a data unit neighboring the respective data unit and to be transmitted subsequent to the respective data unit.

In one embodiment, the NIFU may be in the form of the update of the Lagrange multipliers (called Neighboring Impact Factors, NIFs) associated with the DU scheduling constraints between neighboring DUs (consecutive packets generated by the source codec in the encoding/decoding order). It is clear that the decision granularity is one DU for DUCLO, two neighboring DUs for the NIFU, and all the DUs for the PU.

The DUCLO for each DU may be further divided into two optimizations: (1) optimization to determine the optimal scheduling time, which includes the time at which the transmission should start and when it should be interrupted; and (2) optimization to determine the corresponding optimal transmission strategies at the lower layers, such as considering energy allocation at the physical layer, DU retransmission or FEC at the MAC layer. Information related to the optimal scheduling time is forwarded to the lower layers, such as the MAC layer, such that the lower layer can interrupt the transmission of the current packet and move to the next packet. A packet should be interrupted either because the DU's delay deadline has expired or because the next DU has higher precedence for transmission than the current DU due to its higher distortion impact.

In delay-sensitive real-time applications, the wireless user often is not allowed or cannot know the attributes of future DUs and corresponding network conditions. In other words, it only knows the attributes of previous DUs, and past experienced network conditions and transmission results. However, when the distribution of the attributes and network conditions of DUs fulfil the Markov property, the cross-layer optimization can be formulated as a MDP. Then impacts from the cross-layer action of a current DU on future unknown DUs may be characterized by a state-value function which quantifies the impact from the current DU's cross-layer action on future DUs' distortion. Based on the decomposition principles developed for the online cross-layer optimization discussed earlier in this disclosure, a low-complexity algorithm may be developed utilizing only available (causal) information to solve the online cross-layer optimization for each DU, and updating the resource price and the state-value function used to evaluate impacts to neighboring DU. An exemplary communication node implemented according to this disclosure explicitly takes into account both the application characteristics and network dynamics, and determines decomposition principles for cross-layer optimization which adheres to the existing layered network architecture.

Methodologies for DU-based cross-layer optimization are now described. Assuming a wireless user is engaged in streaming M DUs with individual delay constraints and different distortion impacts. Independently decodable DUs are described first. Independently decidable DUs will be discussed shortly. The time that DUs are ready for transmission is denoted by tᵢ,i=1, . . . , M. The delay deadline of each DU i, which indicates the time before which the DUs must be received by the destination, is denoted by dᵢ. The following constraint needs to be satisfied: dᵢ≧tᵢ. The DUs are transmitted in the First In First Out (FIFO) fashion, such as the same as the encoding/decoding order. The size of each DU i is assumed to be lᵢ bits. Each DU i also has the distortion impact qᵢ on the application. This distortion impact represents the decrease on the quality of the application when the entire DU is dropped. Hence, each DU i is associated with an attribute tuple ψᵢ={qᵢ,lᵢ,tᵢ,dᵢ}. We will first assume that these attributes are known a priori for all DUs, and will later discuss the case in which the attributes of all the future DUs are unknown to the wireless user, as is the case in live encoding and transmission scenarios.

During the transmission, DU i is delivered over the duration from time xᵢ to time yᵢ(yᵢ≧x_{z}), where xᵢ represents the starting transmission time (STX) and yᵢ represents the ending transmission time (ETX). xᵢ and yᵢ are collectively referred to as scheduling parameters for each data unit. The choice of xᵢ and yᵢ represents the scheduling action of DU 2, which is determined in the application layer. The scheduling action is denoted by (xᵢ, yᵢ) satisfying the condition of tᵢ≦xᵢ≦yᵢ≦dᵢ. At the lower layer (which can be one of the physical, MAC and network layers or combination of them), the wireless user experiences an average network condition cᵢε [symbol] ₊ during the transmission duration. For simplicity, the average network condition is assumed to be independent from the scheduled time (xᵢ,yᵢ), which can be the case when the network condition is slowly changing. The wireless user can deploy the transmission action aᵢεA based on the experienced network condition. The set A represents the possible transmission actions that the wireless user can choose. The transmission action at the lower layer can be, for example, the number of DU transmission retry (e.g. ARQ) at the MAC layer, energy allocation at the physical layer, etc.

For simplicity of illustration, exemplary cross-layer optimization will be explained using examples of finding optimal scheduling parameters (Xᵢ, yᵢ). However, it is understood that scheduling parameters are just a type of transmission parameters that may be adjusted to achieve optimal performance of a communication node. Processes performed to optimize the scheduling parameters are applicable to determine optimized values of other transmission parameters and associated actions.

When the wireless user deploys the transmission action aᵢ under the network condition Cᵢ the expected distortion of DU i due to the imperfect transmission in the network is represented by Qᵢ(xᵢ,yᵢ,aᵢ)=qᵢpᵢ(xᵢ,yᵢ,aᵢ), where pᵢ(xᵢ,yᵢ,aᵢ) can be the probability that DU i is lost or the distortion decaying function due to partial data of DU i being received. The expected distortion takes various attributes into consideration, including sizes of data units and network conditions, such as distortion impact, data unit size, etc. It is assumed that the distortion of the independently decodable DUs is not affected by other DUs. The distortion decaying function represents the fraction of the distortion remained after the (partial) data are successfully transmitted. For example, when the source is encoded in a scalable way, the distortion function is given by D=Ke^{-θR} when R bits has been received. In this case, the distortion decaying function is given as pᵢ(xᵢ,yᵢ,aᵢ)=e^{-θ}^{ᵢ}^{R}^{ᵢ}^{(x}^{ᵢ}^{,y}^{ᵢ}^{,a}^{ᵢ}⁾ and qᵢ=K.

The resource cost incurred by the transmission is represented by wᵢ(xᵢ,yᵢ,aᵢ)ε [symbol] ₊. Additionally, it is assumed that the functions pᵢ(xᵢ,yᵢ,aᵢ) and wᵢ(xᵢ,yᵢ,aᵢ) satisfy the following conditions:

C1 (Monotonicity): pᵢ(xᵢ, yᵢ, aᵢ) is a non-increasing function of the difference yᵢ−xᵢ and the transmission action aᵢ.
C2 (Convexity): pᵢ(xᵢ, yᵢ, aᵢ) and wᵢ (xᵢ, yᵢ, aᵢ) are convex functions of the difference yᵢ−Xᵢ and the transmission action aᵢ.

Condition C1 means that the expected distortion will be reduced by increasing the difference yᵢ−xᵢ, since this result in a longer transmission time which increases the chance that DU i will be successfully transmitted. In condition C2, the convexities of pᵢ and Wᵢ are assumed to simplify the analysis. This assumption is satisfied in most scenarios.

Based on the description above, the cross-layer optimization for the delay-sensitive application over the wireless network is to find the optimal scheduling action (i.e. determining the optimal STX xᵢ and ETX yᵢ for each DU) at the application layer. According to the scheduled time, the optimal transmission action aᵢ at the lower layer is determined. The goal of the cross-layer optimization is to minimize the expected average distortion experienced by the delay-sensitive application. This cross-layer optimization may also be constrained on the available resources at the lower layer, such as energy or power at the physical layer. Consequently, the cross-layer optimization for DUs with complete knowledge (referred to as CK-CLO) can be formulated as:

$$\begin{matrix}{min}_{{x}_{i} , {y}_{i} , {a}_{i} i = 1 , … , M} \frac{1}{M} {\sum }_{i = 1}^{M} {Q}_{i} ( {x}_{i} , {y}_{i} , {a}_{i} ) \\ s . t . {x}_{i} \leq {y}_{i} , {x}_{i} \geq {t}_{i} , {y}_{i} \leq {d}_{i} , {x}_{i + 1} \geq {y}_{i} , {a}_{i} ∈ A , \\ \frac{1}{M} {\sum }_{i = 1}^{M} {w}_{i} ( {x}_{i} , {y}_{i} , {a}_{i} ) \leq W .\end{matrix} \qquad ( CK \text{-} CLO )$$

where the constraint xᵢ₊₁≧yᵢ indicates that DU i+1 has to be transmitted after DU i is transmitted (i.e. FIFO), and the last line in the CK-CLO problem indicates the resource constraint in which W is the average resource budget, such as available energy for transmission.

We now describe how the cross-layer optimization in the CK-CLO problem is decomposed using duality theory, what information has to be updated among DUs at each layer, and what messages have to be exchanged across multiple layers, to achieve cross-layer optimization for DUs.

First, the constraints in the CK-CLO problem are relaxed by introducing the Lagrange multiplier λ≧0 associated with the resource constraint and Lagrange multiplier vector μ=[μ₁, . . . , μ_{M-1}]^{T}≧0, whose elements are associated with the constraint xᵢ₊₁≧yᵢ, ∀ᵢ. The corresponding Lagrange function is given as

$$L ( x , y , a , λ , μ ) = \frac{1}{M} {\sum }_{i = 1}^{M} {Q}_{i} ( {x}_{i} , {y}_{i} , {a}_{i} ) + λ ( \frac{1}{M} {\sum }_{i = 1}^{M} {w}_{i} ( {x}_{i} , {y}_{i} , {a}_{i} ) - W ) + {\sum }_{i = 1}^{M - 1} {μ}_{i} ( {y}_{i} - {x}_{i + 1} ) , \qquad ( 42 )$$

where x=[x₁, . . . , x_{M}], y=[y₁, . . . , y_{M}] and a=[a₁, . . . , a_{M}].

Then, the Lagrange dual function is given by

$$g ( λ , μ ) = {{min}_{{x}_{i} , {y}_{i} , {a}_{i} ,}}_{i = 1 , … , M} \{ \begin{matrix}\frac{1}{M} {\sum }_{i = 1}^{M} {Q}_{i} ( {x}_{i} , {y}_{i} , {a}_{i} ) + \\ λ ( \frac{1}{M} {\sum }_{i = 1}^{M} {w}_{i} ( {x}_{i} , {y}_{i} , {a}_{i} ) - W ) + \\ {\sum }_{i = 1}^{M - 1} {μ}_{i} ( {y}_{i} - {x}_{i + 1} )\end{matrix} \} \\ s . t . {x}_{i} \leq {y}_{i} , {x}_{i} \geq {t}_{i} , {y}_{i} \leq {d}_{i} , {a}_{i} ∈ A , i = 1 , … , M \qquad ( 43 )$$

The dual problem (referred to as CK-DCLO) is then given by

$${max}_{λ \geq 0 , μ \geq 0} g ( λ , μ ) ( CK - DCLO )$$

where it μ≧0 denotes the component-wise inequality. The CK-DCLO dual problem can be solved using the subgradient method as shown next.

The subgradients of the dual function are given by

$${h}_{λ} = ( \frac{1}{M} {\sum }_{i = 1}^{M} {w}_{i} ( {x}_{i} , {y}_{i} , {a}_{i} ) - W )$$

with respect to the variable λ and h_{μ}_{ᵢ}=(yᵢ−xᵢ₊₁) with respect to the variable μᵢ. The CK-DCLO problem can then be iteratively solved using the subgradients to update the Lagrange multipliers as follows.

### Price-Updating:

$${λ}^{k + 1} = {( {λ}^{k} + {α}^{k} ( \frac{1}{M} {\sum }_{i = 1}^{M} {w}_{i} ( {x}_{i} , {y}_{i} , {a}_{i} ) - W ) )}^{+} \qquad ( 44 )$$

### and NIF Updating:

μᵢ^{k+1}=(μᵢ^{k}+βᵢ^{k}(yᵢ−xᵢ₊₁))⁺, (45)

where z⁺=max {z,0} and αₖ and βᵢ^{k} are the update step sizes and satisfy the following conditions:

$${\sum }_{k = 1}^{∞} {α}^{k} = ∞ , {\sum }_{k = 1}^{∞} {( {α}^{k} )}^{2} < ∞ and {\sum }_{k = 1}^{∞} {β}_{i}^{k} = ∞ , {\sum }_{k = 1}^{∞} {( {β}_{i}^{k} )}^{2} < ∞ .$$

These conditions are required to enforce the convergence of the subgradient method. The choice of α^{k} and βᵢ^{k} trades off the speed of convergence and performance obtained. One example is α^{k}=βᵢ^{k}=1/k.

From the subgradient method, we note that the Lagrange multiplier λ is updated based on the consumed resource and available budget, which is interpreted as the “price” of the resource and it is determined at the lower layer. The Lagrange multiplier vector μ is updated based on the scheduling time of the neighboring DUs, which is interpreted as the neighboring impact factors and is determined at the application layer.

Since the CK-CLO problem is a convex optimization, the duality gap between the CK-CLO and CK-DCLO problems is zero. Based on the multiplier update given in Eqs. (44) and (45), it is known that update of the Lagrange multipliers λ and μ can be performed separately in different layers, thereby automatically adhering to the layered network architecture.

Given the Lagrange multipliers λ and μ the dual function shown in Eq. (43) is separable and can be decomposed into M DUCLO problems:
DUCLO problem iε{1, . . . , M}:

$${min}_{{x}_{i} , {y}_{i} , {a}_{i}} \frac{1}{M} {Q}_{i} ( {x}_{i} , {y}_{i} , {a}_{i} ) + \frac{λ}{M} {w}_{i} ( {x}_{i} , {y}_{i} , {a}_{i} ) - {μ}_{i - 1} {x}_{i} + {μ}_{i} {y}_{i} \\ s . t . {x}_{i} \leq {y}_{i} , {x}_{i} \geq {t}_{i} , {y}_{i} \leq {d}_{i} , {a}_{i} ∈ A \qquad ( 46 )$$

where μ₀=0 and μ_{M}=0. Given the Lagrange multipliers λ and μ, each DUCLO problem is independently optimized.

If details of data units needed for transmission are known, the neighboring impact, according to one embodiment, is calculated as a linear function of a starting transmission time and an ending transmission time of a respective data unit. In one embodiment, the linear function is −μᵢ₋₁xᵢ+μᵢyᵢ, where i is an index of data units; xᵢ is the starting transmission time of data unit i, yᵢ is the ending transmission time of data unit i; μ is an impact factor vector each element μᵢ of which represents the amount of impacts incurred by data unit i to other data units when decreasing the starting transmission time xᵢ or increasing the stopping time yᵢ; and the update of μᵢ is given by μᵢ^{k+1}=max(μᵢ^{k}+βᵢ^{k}(yᵢ−xᵢ₊₁),0), where βᵢ^{k} is a positive real number satisfying

$${\sum }_{k = 1}^{∞} {β}_{i}^{k} = ∞ , {\sum }_{k = 1}^{∞} {( {β}_{i}^{k} )}^{2} < ∞ ,$$

where k is an iteration index.

From Eq. (46), it is noted that all the DUCLO problems share the same Lagrange multiplier λ, because the budget constraint imposed at the lower layer is applicable to all DUs. It is also noted that each DUCLO problem i shares the same Lagrange multiplier μᵢ₋₁ with DUCLO problem i−1 and μᵢ with DUCLO problem i+1. Compared to the traditional myopic algorithm in which each DU is transmitted without considering its impact on future DUs, the DUCLO presented herein automatically takes into account the impact of the scheduling for the current DU on its neighbors.

Since the impact between independently decodable DUs takes place only through the Lagrange multipliers λ and μ, it is possible to separately find the cross-layer actions for each DU by estimating the Lagrange multipliers λ and μ, which will be used in the online implementation discussed shortly.

The separation of the DUCLO problem into two layered subproblems is not described. Additionally, messages need to exchanged between layers will be identified.

Given the Lagrange multipliers λ and μ, the DUCLO in Eq. (46) can be rewritten as

$$\begin{matrix}{min}_{{x}_{i} , {y}_{i}} \{ {min}_{{a}_{i} ∈ A} \{ \frac{1}{M} {Q}_{i} ( {x}_{i} , {y}_{i} , {a}_{i} ) + \frac{λ}{M} {w}_{i} ( {x}_{i} , {y}_{i} , {a}_{i} ) \} - {μ}_{i - 1} {x}_{i} + {μ}_{i} {y}_{i} \} \\ s . t . {x}_{i} \leq {y}_{i} , {x}_{i} \geq {t}_{i} , {y}_{i} \leq {d}_{i} ,\end{matrix} \qquad ( 47 )$$

The inner optimization in Eq. (47) is performed at the lower layer and aims to find the optimal transmission action a*ᵢ, given STX xᵢ and ETX yᵢ. This optimization is referred to as LOWER_OPTIMIZATION:

$$f ( {x}_{i} , {y}_{i} ) = {min}_{{a}_{i} ∈ A} \frac{1}{M} {Q}_{i} ( {x}_{i} , {y}_{i} , {a}_{i} ) + \frac{λ}{M} {w}_{i} ( {x}_{i} , {y}_{i} , {a}_{i} ) \qquad ( 48 )$$

The LOWER_OPTIMIZATION requires the information of prospective scheduling time (xᵢ, yᵢ), distortion impact qᵢ and DU size lᵢ which are obtained from the upper layer and the information of transmission actions aᵢ and price of resource λ, which are obtained at the lower layer.

The outer optimization in Eq. (47) is performed at the upper layer and aims to find the optimal STX xᵢ and ETX yᵢ, according to the solution to the lower optimization in Eq. (48).

This optimization is referred to as the UPPER_OPTIMIZATION:

$${min}_{{x}_{i} , {y}_{i}} f ( {x}_{i} , {y}_{i} ) - {μ}_{i - 1} {x}_{i} + {μ}_{i} {y}_{i} \\ s . t . {x}_{i} \leq {y}_{i} , {x}_{i} \geq {t}_{i} , {y}_{i} \leq {d}_{i} , \qquad ( 49 )$$

The UPPER_OPTIMIZATION requires information of ƒ(xᵢ,yᵢ), which can be interpreted as the best response to (xᵢ,yᵢ) performed at the lower layer, and information of μᵢ₋₁ and μᵢ which are obtained at the upper layer. Best response represents a result of optimization at the lower level by taking an optimal action.

Therefore, for transmitting a respective data unit, the operation of the exemplary system is as follows:

At each of at least one lower protocol layer: determine a best response ƒ(xᵢ,yᵢ) and an optimal action aᵢ of the lower protocol layer according to prospective scheduling parameters (xᵢ,yᵢ) for transmitting the data unit. An optimal action, as used throughout this section, is an action of adjusting parameters of a lower protocol layer to achieve optimization at the lower protocol layer,

At the upper protocol layer: determine optimal scheduling parameters for transmitting the respective data unit based on the determined best response ƒ(xᵢ,yᵢ); and initiate transmission of the data unit according to the optimal scheduling parameters.

Hence, given message {qᵢ,lᵢ,xᵢ,yᵢ}, the LOWER_OPTIMIZATION can derive expected distortion Qᵢ(xᵢyᵢ,aᵢ) and determines an optimal action a*ᵢ and best response function ƒ(xᵢ,yᵢ) associated with the lower layer. Given the best response function ƒ(xᵢ,yᵢ), the UPPER_OPTIMIZATION determines optimal STX x*ᵢ and ETX y*ᵢ. Since Qᵢ(xᵢ,yᵢ,aᵢ) and wᵢ(xᵢ,yᵢ,aᵢ) are convex functions of the difference yᵢ−xᵢ and aᵢ, the LOWER_OPTIMIZATION and UPPER_OPTIMIZATION are both convex optimization problems and can be efficiently solved using well-known convex optimization algorithms such as the interior-point methods. While the illustrate example derives derive expected distortion Qᵢ(xᵢ,yᵢ,aᵢ) of data units based on size of each DU i (lᵢ) and distortion impact qᵢ on the application, it is understood that additional or different types of attributes may be used to derive expected distortion Qᵢ(xᵢ,yᵢ,aᵢ).

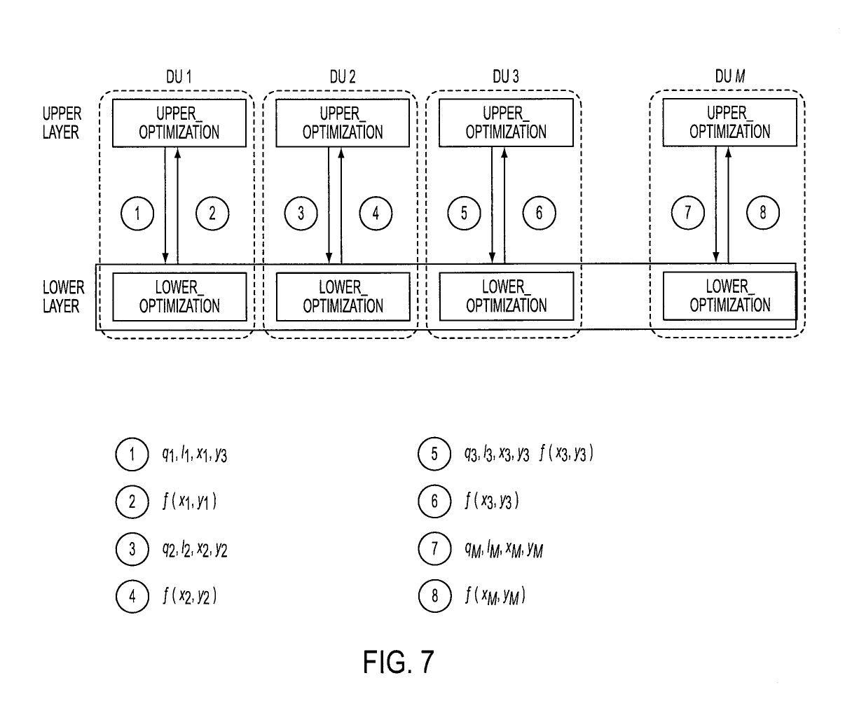

FIG. 7 illustrates operations of the lower optimization and upper optimization. As shown in FIG. 7, cross-layer optimization is performed for each DU. For DU 1, the upper layer provides the lower layer with a set of information 1 including scheduling time (xᵢ,yᵢ), distortion impact qᵢ and DU size lᵢ. Based on the information provided by the upper layer, the lower layer determines an optimal action a*ᵢ by performing the lower optimization based on scheduling time (xᵢ,yᵢ) distortion impact qᵢ and DU size lᵢ which are obtained from the upper layer, and price of resource λ, which is obtained at the lower layer. The value of λ is updated according to (xᵢ,yᵢ) and optimal action a*ᵢ. The lower layer then sends a result of the lower optimization 2, which is the best response to (xᵢ,yᵢ) performed at the lower layer, to the upper layer. In response, the upper layer calculates optimal STX x*ᵢ and ETX y*ᵢ according to best response function ƒ(xᵢ,yᵢ) provided by the lower layer, and information of μᵢ₋₁ and μᵢ are obtained at the upper layer. The value of μᵢ is updated based on the optimal STX x*ᵢ and ETX y*ᵢ. STX x*ᵢ and ETX y*ᵢ are correlatively referred to as optimal scheduling parameters. Similar processes are performed for DU 2, DU 3 . . . DU M.

This layered solution for each DU provides the necessary message exchanges between the upper layer and lower layer, and illustrates the role of each layer in the cross-layer optimization. Specifically, the application layer works as a “guide” which determines the optimal STX and ETX by taking into account the best response ƒ(xᵢ, yᵢ) of the lower layer, while the lower layer works as a “follower”, which only needs to determine the best response ƒ(xᵢ,yᵢ), given the scheduling time (xᵢ,yᵢ) determined by the upper layer.

The algorithm for solving the CK-CLO problem is illustrated in Algorithm 2

Algorithm 2: Algorithm for solving the CK-CLO
problem for the independently decodable DUs

Initialize λ⁰, μ⁰, λ¹, μ¹, ε, k = 1
While (|λ^{k} − λ^{k-1}| + ∥μ^{k} − μ^{k-1}∥ > ε or k = 1)

For i = 1,..., M

Layered solution to DUCLO for DU i

End
Compute λ^{k+1}, μ^{k+1} as in Eqs. (44) and (45).
k ← k + 1

End

k is the index of each iteration, i is the index of data units, and ε is a threshold value for determining necessity for renewed iteration.

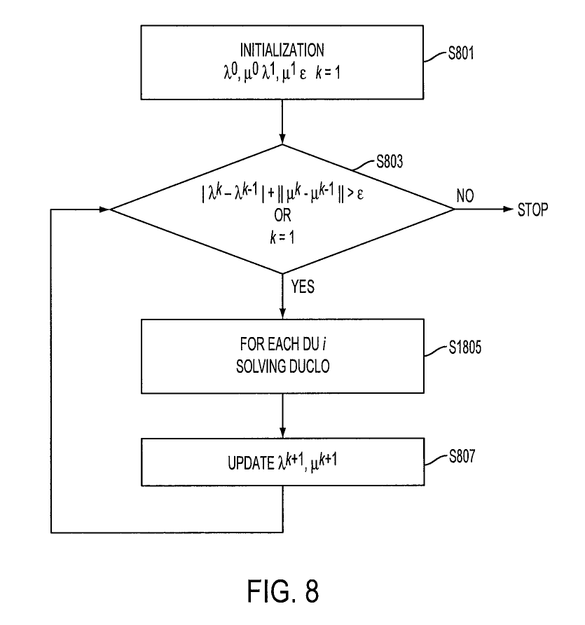

FIG. 8 is a flow chart showing steps performed for solving the CK-CLO problem for independent DUs using algorithm 2. In step S801, initial values are provided for various parameters. Step S803 determines whether iteration is needed. If it is determined that convergence has achieved, then operation stops. On the other hand, if it is determined that convergence has not achieved or first iteration is to be performed, then the operation proceeds to Step S805. In Step S805, DUCLO for each data unit is solved according to discussions related to equation (50). After optimal scheduling parameters are obtained, the system updates values for λ^{k+1},μ^{k+1} as in Eqs. (44) and (45), for use in next iteration, if necessary. After Step S807, the system proceeds performing step S803 again to determine whether new iteration is needed. If necessary, steps S805, S807, S803 are repeated until convergence is reached.

### Cross-Layer Optimization for Interdependent DUs

Techniques for cross-layer optimization for independent DUs also are applicable to interdependent DUs. Embodiments of cross-layer optimization for interdependent DUs are now described.

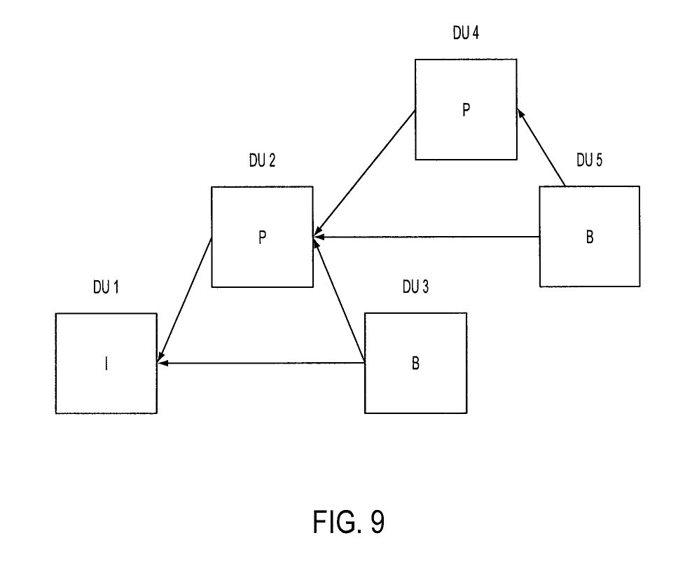

The interdependencies between DUs can be expressed using a directed acyclic graph (DAG). An exemplary DAG for video frames is shown in FIG. 9. Each node of the graph represents one DU and each edge of the graph directed from DU i to DU i′ represents the dependence of DU i on DU i′. This dependency means that the distortion impact of DU i depends on the amount of successfully received data in DU i′. We can further define the partial relationship between two DUs which may not be directly connected, for which we write i′ [symbol] i if DU i′ is an ancestor of DU i or equivalently DU i is a descendant of DU i′ in the DAG. The relationship i′ [symbol] i means that the distortion (or error) is propagated from DU i′ to DU i. The error propagation function from DU i′ to DU i is represented by e_{i′}(x_{i′},y_{i′},a_{i′})ε[0,1] which is assumed to be a decreasing convex function of the difference y_{i′}−x_{i′} and a_{i′}. In general, the error propagation function e_{i′}(x_{i′},y_{i′},a_{i′}) DU i′ also depends on which DU it will affect. For simplicity, we assume the error propagation function only depends on the current DU and does not depend on the DU it will affect. To simplify the analysis, we do not consider the impact of error concealment strategies. Such strategies could be used in practice, and this will not affect the proposed methodology for cross-layer optimization.

Then, the distortion impact of DU i can be computed as

$${Q}_{i} ( {x}_{i} , {y}_{i} , {a}_{i} ) = {q}_{i} - {q}_{i} ( ( 1 - {p}_{i} ( {x}_{i} , {y}_{i} , {a}_{i} ) ) {\prod }_{k ≺ i} ( 1 - {e}_{k} ( {x}_{k} , {y}_{k} , {a}_{k} ) ) ) . \qquad ( 51 )$$

If DU i cannot be decoded because one of its ancestor is not successfully received and pᵢ(xᵢ,yᵢ,aᵢ) represents the loss probability of DU i, then eᵢ(xᵢ,yᵢ,a₂)=pᵢ(xᵢ,yᵢ,aᵢ).

The primary problem of the cross-layer optimization for the interdependent DUs is the same as in the CK-CLO problem by replacing Qᵢ(xᵢ,yᵢ,aᵢ) with the formula in Eq. (51). The difference from the CK-CLO problem is that Qᵢ(xᵢ,yᵢ,aᵢ) here depends on the cross-layer actions of its ancestors and Qᵢ(xᵢ,yᵢ,aᵢ) may not be a convex function of all the cross-layer actions (xₖ,yₖ,aₖ)∀k [symbol] i, although eₖ(xₖ,yₖ, aₖ) is a convex function of (xₖ,yₖ,aₖ). However, we note that, give (xₖ,yₖ,aₖ)∀k [symbol] i, Qᵢ(xᵢ,yᵢ,aᵢ) is a convex function of (xᵢ,yᵢ,aᵢ). We will use this property to develop a dual solution for the original non-convex problem and we will quantify the duality gap in the simulation section.

The derivative of the dual problem is the same as that discussed earlier relative to independent DUs. By replacing Qᵢ(xᵢ,yᵢ, aᵢ) with the formula in Eq. (51), the Lagrange dual function shown in Eq. (43) becomes

$$g ( λ , μ ) = {min}_{{x}_{i} , {y}_{i} , {a}_{i} , i = 1 , … , M} \{ \begin{matrix}\frac{1}{M} {\sum }_{i = 1}^{M} ( \begin{matrix}{q}_{i} - {q}_{i} ( 1 - {p}_{i} ( {x}_{i} , {y}_{i} , {a}_{i} ) ) \\ {\prod }_{k ≺ i} ( 1 - {e}_{k} ( {x}_{k} , {y}_{k} , {a}_{k} ) )\end{matrix} ) + \\ λ ( \frac{1}{M} {\sum }_{i = 1}^{M} {w}_{i} ( {x}_{i} , {y}_{i} , {a}_{i} ) - W ) + \\ {\sum }_{i = 1}^{M - 1} {μ}_{i} ( {y}_{i} - {x}_{i + 1} )\end{matrix} \} \\ s . t . {x}_{i} \leq {y}_{i} , {x}_{i} \geq {t}_{i} , {y}_{i} \leq {d}_{i} , {a}_{i} ∈ A , i = 1 , … , M . \qquad ( 52 )$$

Due to the interdependency, this dual function cannot be simply decomposed into the independent DUCLO problems as shown in Eq. (46). However, the dual function can be computed DU by DU assuming the cross-layer actions of other DUs is given. Specifically, given the Lagrange multipliers λ,μ, the objective function in Eq. (52) is denoted as G((x₁,y₁,a₁), . . . , (x_{M},y_{M},a_{M}),λ,μ). When the cross-layer actions of all DUs except DU i are fixed, the DUCLO for DU i is given by

$$\begin{matrix}{min}_{{x}_{i} \leq {y}_{i} , {x}_{i} \geq {t}_{i} , {y}_{i} \leq {d}_{i} , {a}_{i} ∈ A} G ( \begin{matrix}( {x}_{1} , {y}_{1} , {a}_{1} ) , … , ( {x}_{i} , {y}_{i} , {a}_{i} ) , \\ … , ( {x}_{M} , {y}_{M} , {a}_{M} ) , λ , μ\end{matrix} ) = {min}_{{x}_{i} \leq {y}_{i} , {x}_{i} \geq {t}_{i} , {y}_{i} \leq {d}_{i} , {a}_{i} ∈ A} ( \begin{matrix}\frac{1}{M} {Q}_{i}^{′} ( {x}_{i} , {y}_{i} , {a}_{i} ) + \\ \frac{λ}{M} {w}_{i} ( {x}_{i} , {y}_{i} , {a}_{i} ) - {μ}_{i - 1} {x}_{i} + {μ}_{i} {y}_{i}\end{matrix} ) + {θ}_{i} & ( 53 ) \\ where & \\ {Q}_{i}^{′} ( {x}_{i} , {y}_{i} , {a}_{i} ) = \frac{1}{M} {q}_{i} {p}_{i} ( {x}_{i} , {y}_{i} , {a}_{i} ) {\prod }_{k ≺ i} ( 1 - {e}_{k} ( {x}_{k} , {y}_{k} , {a}_{k} ) ) - \frac{1}{M} ( 1 - {e}_{i} ( {x}_{i} , {y}_{i} , {a}_{i} ) ) ( {\sum }_{{i}^{′} ≺ i} {q}_{{i}^{′}} ( 1 - {p}_{{i}^{′}} ( {x}_{{i}^{′}} , {y}_{{i}^{′}} , {a}_{{i}^{′}} ) ) {{\prod }_{k ≺ {i}^{′}}}_{k \neq i} ( 1 - {e}_{k} ( {x}_{k} , {y}_{k} , {a}_{k} ) ) ) , & ( 54 )\end{matrix}$$

and θᵢ represents the remaining part in Eq. (52), which does not depend on the cross-layer action (xᵢ, yᵢ, aᵢ). It is easy to show that the optimization over the cross-layer action of DU i in Eq. (53) is a convex optimization, which can be solved in a layered fashion as discussed earlier.

Q′ᵢ(xᵢ,yᵢ,aᵢ) represents the sensitivity to, or impact of, the imperfect transmission of DU i, that is, the amount by which the expected distortion will increase if the data of DU i is not fully received, given the cross-layer actions of other DUs. Unlike the solutions for the independently decodable DUs which do not require the knowledge of other DUs, the DUCLO for DU i is solved only by fixing the cross-layer actions of other DUs.

The optimization in Eq. (52) can be solved using the block coordinate descent method. Given the current optimizer ((x₁ⁿ,y₁ⁿ,a₁ⁿ), . . . , (x_{M}ⁿ,y_{M}ⁿ,a_{M}ⁿ)) at iteration n, the optimizer at iteration n+1, ((x₁ⁿ⁺¹,y₁ⁿ⁺¹,a₁ⁿ⁺¹), . . . , (x_{M}ⁿ⁺¹,y_{M}ⁿ⁺¹,a_{M}ⁿ⁺¹)) is generated according to the iteration

$$( {x}_{i}^{n + 1} , {y}_{i}^{n + 1} , {a}_{i}^{n + 1} ) = arg {min}_{{x}_{i} \leq {y}_{i} , {x}_{i} \geq {t}_{i} , {y}_{i} \leq {d}_{i} , {a}_{i} ∈ A} G ( \begin{matrix}( {x}_{1}^{n + 1} , {y}_{1}^{n + 1} , {a}_{1}^{n + 1} ) , … , \\ ( {x}_{i - 1}^{n + 1} , {y}_{i - 1}^{n + 1} , {a}_{i - 1}^{n + 1} ) , ( {x}_{i} , {y}_{i} , {a}_{i} ) , \\ ( {x}_{i + 1}^{n} , {y}_{i + 1}^{n} , {a}_{i + 1}^{n} ) , … , \\ ( {x}_{M}^{n} , {y}_{M}^{n} , {a}_{M}^{n} ) , λ , μ\end{matrix} ) \qquad ( 55 )$$

At each iteration, the objective function is decreased compared to that of the previous iteration and the objective function is lower bounded (greater than zero). Hence, this block coordinate descent method converges to the locally optimal solution to the optimization in Eq. (52), given the Lagrange multipliers λ and μ.

The process for separating the DUCLO problem for interdependent DUs into layered solutions is now described. Given the Lagrange multipliers λ and μ, the optimization in Eq. (56) can be rewritten as

$$\begin{matrix} {min}_{{x}_{i} , {y}_{i}} \{ \begin{matrix}{min}_{{a}_{i} ∈ A} \{ \frac{1}{M} {Q}_{i}^{′} ( {x}_{i} , {y}_{i} , {a}_{i} ) + \frac{λ}{M} {w}_{i} ( {x}_{i} , {y}_{i} , {a}_{i} ) \} - \\ {μ}_{i - 1} {x}_{i} + {μ}_{i} {y}_{i}\end{matrix} \} \\ s . t . {x}_{i} \leq {y}_{i} , {x}_{i} \geq {t}_{i} , {y}_{i} \leq {d}_{i} , & ( 57 ) \\ where & \\ {Q}_{i}^{′} ( {x}_{i} , {y}_{i} , {a}_{i} ) = \frac{1}{M} {q}_{i} {p}_{i} ( {x}_{i} , {y}_{i} , {a}_{i} ) {\prod }_{k ≺ i} ( 1 - {e}_{k} ( {x}_{k}^{n + 1} , {y}_{k}^{n + 1} , {a}_{k}^{n + 1} ) ) - \frac{1}{M} ( 1 - {e}_{i} ( {x}_{i} , {y}_{i} , {a}_{i} ) ) ( \begin{matrix}{\sum }_{{i}^{′} ≻ i} {q}_{{i}^{′}} ( 1 - {p}_{{i}^{′}} ( {x}_{{i}^{′}}^{n} , {y}_{{i}^{′}}^{n} , {a}_{{i}^{′}}^{n} ) ) \\ \begin{matrix}{{\prod }_{k ≺ {i}^{′}}}_{k < i} ( 1 - {e}_{k} ( {x}_{k}^{n + 1} , {y}_{k}^{n + 1} , {a}_{k}^{n + 1} ) ) \\ {{\prod }_{k ≺ {i}^{′}}}_{k > i} ( 1 - {e}_{k} ( {x}_{k}^{n} , {y}_{k}^{n} , {a}_{k}^{n} ) )\end{matrix}\end{matrix} ) , & ( 58 )\end{matrix}$$

Q′ᵢ(xᵢ,yᵢ,aᵢ) can be interpreted as the sensitivity to, or impact of, the imperfect transmission of DU i, such as the amount by which the expected distortion will increase if the data of DU i is not fully received, given the cross-layer actions of other DUs. The DUCLO for DU i is solved by fixing the cross-layer actions of other DUs, unlike the solutions for the independently decodable DUs which do not require the knowledge of other DUs.

The inner optimization in Eq. (47) is performed at the lower layer and aims to find the optimal transmission action a*ᵢ, given STX xᵢ and ETX yᵢ. This optimization is referred to as

### LOWER_OPTIMIZATION:

$$f ( {x}_{i} , {y}_{i} ) = {min}_{{a}_{i} ∈ A} \frac{1}{M} {Q}_{i} ( {x}_{i} , {y}_{i} , {a}_{i} ) + \frac{λ}{M} {w}_{i} ( {x}_{i} , {y}_{i} , {a}_{i} ) \qquad ( 59 )$$

In one embodiment, Q′ᵢ(xᵢ,yᵢ,aᵢ) takes into account of the prospective scheduling time (xᵢ,yᵢ), distortion impact qᵢ and DU size lᵢ. Therefore, the LOWER_OPTIMIZATION may be full characterized with information of the prospective scheduling time (Xᵢ,yᵢ), distortion impact qᵢ, DU size lᵢ, the information of transmission actions aᵢ, and price of resource. Distortion impact qᵢ and DU size lᵢ may be obtained from the upper layer and information of transmission actions aᵢ and price of resource λ may be obtained at the lower layer.

The outer optimization in Eq. (47) is performed at the upper layer and aims to find optimal scheduling parameters STX xᵢ and ETX yᵢ, given the solution to the lower optimization in Eq. (48). This optimization is referred to as the

### UPPER_OPTIMIZATION:

$${min}_{{x}_{i} , {y}_{i}} f ( {x}_{i} , {y}_{i} ) - {μ}_{i - 1} {x}_{i} + {μ}_{i} {y}_{i} \\ s . t . {x}_{i} \leq {y}_{i} , {x}_{i} \geq {t}_{i} , {y}_{i} \leq {d}_{i} , \qquad ( 60 )$$

The UPPER_OPTIMIZATION needs information of ƒ(xᵢ,yᵢ), which can be interpreted as the best response to (Xᵢ, yᵢ) performed at the lower layer, and information of μᵢ₋₁ and μᵢ which are obtainable from the upper layer.

Hence, given the message {qᵢ,lᵢ,xᵢ,yᵢ}, the LOWER_OPTIMIZATION can optimally provide a*ᵢ and the best response function ƒ(xᵢ,yᵢ). Given the function ƒ(xᵢ,yᵢ), the UPPER_OPTIMIZATION tries to find the optimal STX x*ᵢ and ETX y*ᵢ.

The algorithm for solving the CK-CLO problem for the interdependent DUs is illustrated in Algorithm 3

Algorithm 3: Algorithm for solving the
CK-CLO problem for interdependent DUs

Initialize λ⁰, μ⁰, λ¹, μ¹, ε, k = 1 // for outer iteration
While (|λ^{k} − λ^{k-1}| + ∥μ^{k} − μ^{k-1}∥ > ε or k = 1)

Initialize : xᵢ⁰^{,} yᵢ⁰, aᵢ⁰, i = 1,..., M , Δ, δ , n = 1 . //for inner

iteration

While (Δ > δ or n = 1)

For i = 1,..., M

Layered solution to DUCLO for DU i as in Eq. (55).

End
Δ = G((xᵢⁿ, yᵢⁿ, aᵢⁿ), i = 1,..., M, λ^{k}, μ^{k}) −
G((xᵢⁿ⁻¹, yᵢⁿ⁻¹, aᵢⁿ⁻¹), i = 1,..., M, λ^{k}, μ^{k})
(xᵢⁿ⁺¹, yᵢⁿ⁺¹, aᵢⁿ⁺¹) ← (xᵢⁿ, yᵢⁿ, aᵢⁿ), i = 1,..., M
n ← n + 1

End
Update λ^{k+1}, μ^{k+1} as in Eqs. (44) and (45).

k ← k + 1

End

K is the index of each iteration; and ε and Δ are threshold values for ending iteration or calculation.

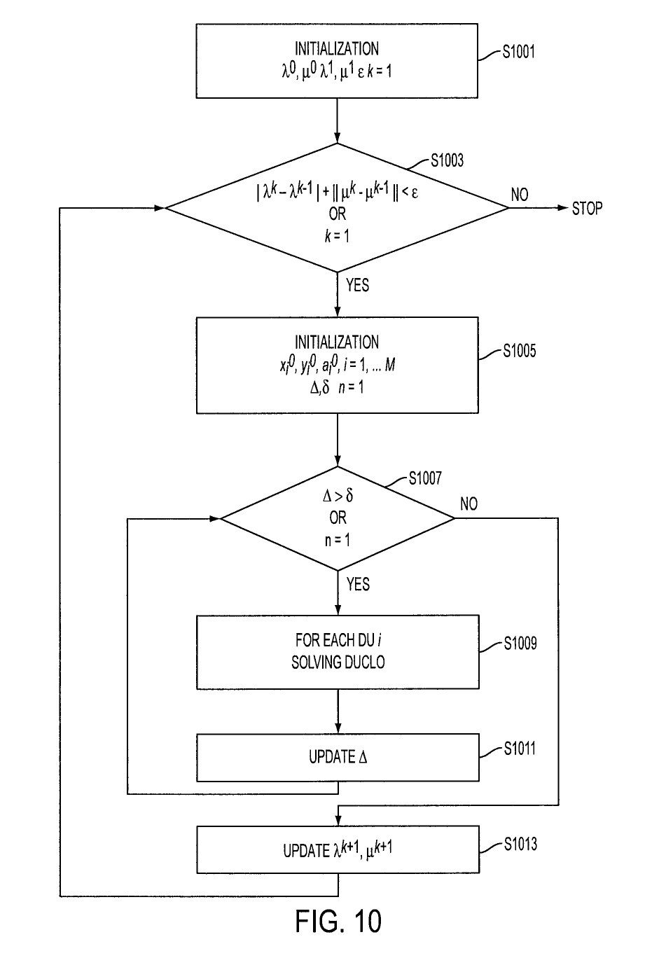

FIG. 10 is a flow chart showing steps performed for solving the CK-CLO problem for independent DUs using algorithm 3. In step S1001, initial values are provided for various parameters for outer iteration. Step S1003 determines whether iteration needs to be performed. If it is determined that convergence has achieved, then operation stops. On the other hand, if it is determined that convergence has not achieved or first iteration is to be performed, then the operation proceeds to Step S1005. For the new iteration, S1005 sets up initial values for various parameters needed in optimization calculations for inner iteration.

In Step S1007, the system determines whether convergence has achieved. If the determination is affirmative, then the system performs Step S1013 to λ^{k+1},μ^{k+1} as in Eqs. (44) and (45), for use in next outer iteration, if necessary. Then, the process flow proceeds to Step S1003.

If, on the other hand, the determination in Step S1007 is negative, then the process flow proceeds to Step S1009. In Step S1009, DUCLO for each data unit is solved according to discussions related to equation (61). After optimal scheduling parameters are obtained, the system updates values for Δ as in algorithm 3 and λ^{k+1},μ^{k+1} as in Eqs. (44) and (45), for use in next iteration, if necessary. After Step S1011, the system proceeds performing step S1007 again to determine whether new inner iteration is needed. If necessary, steps S1009, S1011, S1007 are repeated until convergence of inner iteration is reached.

From Eq. (53), cross-layer optimization for interdependent DU i is determined based on resource price λ, NIF μᵢ₋₁,μᵢ, the interdependencies with other DUs (such as expressed by the DAG), and values of pₖ(xₖ,yₖ,aₖ) and eₖ(xₖ,yₖ,aₖ) of all DUs k connected with DU i.

Online Cross-Layer Optimization with Incomplete Knowledge

The cross-layer optimization discussed earlier assumes complete a-priori knowledge of DUs' attributes and the network conditions. However, in real-time or online applications, this knowledge sometimes is only available just before the DUs are transmitted. Embodiments of a low-complexity online cross-layer optimization are now described.

### A. Online Optimization Using Learning for Independent DUs

In this section, we assume that the DUs can be independently decoded and that the attributes and network conditions dynamically change over time. The random versions of the time the DU is ready for transmission, delay deadline, data unit size, distortion impact and network condition are denoted by Tᵢ,Dᵢ,Lᵢ,Qᵢ,Cᵢ, respectively, as used in the examples discussed earlier. We assume that both the inter-arrival interval (i.e. Tᵢ₊₁−Tᵢ) and the life time (i.e. Dᵢ−Tᵢ) of the DUs are i.i.d. Other attributes of each DU and the experienced network condition also are i.i.d. random variables independent of other DUs. We further assume that the user has an infinite number of DUs to transmit. Then, the cross-layer optimization with complete knowledge presented in the CK-CLO problem becomes cross-layer optimization with incomplete knowledge (referred to as ICK-CLO) as shown below:

$${min}_{{x}_{i} , {y}_{i} , {a}_{i} , ∀ i} {lim}_{N \to ∞} \frac{1}{N} {\sum }_{i = 1}^{N} {E}_{{T}_{i} , {D}_{i} , {L}_{i} , {𝒬}_{i} , {C}_{i}} {Q}_{i} ( {x}_{i} , {y}_{i} , {a}_{i} ) \\ s . t . max ( {y}_{i - 1} , {T}_{i} ) \leq {x}_{i} \leq {y}_{i} \leq {D}_{i} , {a}_{i} ∈ A , ∀ i \\ {lim}_{N \to ∞} \frac{1}{N} {\sum }_{i = 1}^{N} {E}_{{T}_{i} , {D}_{i} , {L}_{i} , {𝒬}_{i} {C}_{i}} {w}_{i} ( {x}_{i} , {y}_{i} , {a}_{i} ) \leq W \qquad ( ICK \text{-} CLO )$$

The optimization in the ICK-CLO problem is the same as the CK-CLO problem except that the ICK-CLO problem minimizes the expected average distortion for the infinite number of DUs over the expected average resource constraint. However, the solution to the ICK-CLO problem is quite different from the solution to the CK-CLO problem. In the following, we will first present the optimal solution to the ICK-CLO problem, and then we will compare this solution with that of the CK-CLO problem. Finally, we will develop an online cross-layer optimization for each DU.

### 1. MDP Formulation of the Cross-Layer Optimization for Infinite DUs

Similar to the dual problem relative to the off-line scenarios, the dual problem (referred to as ICK-DCLO) corresponding to the ICK-CLO problem is given by the following optimization.

$${max}_{λ \geq 0} g ( λ ) , \qquad ( ICK \text{-} DCLO )$$

where g (λ) is computed by the following optimization.

$$g ( λ ) = {min}_{{x}_{i} \geq max ( {y}_{i - 1} , {T}_{i} ) , {y}_{i} \leq {D}_{i} , {a}_{i} ∈ A , ∀ i , ∀ i} {lim}_{N \to ∞} \frac{1}{N} {\sum }_{i = 1}^{N} {E}_{{Ψ}_{i} , {C}_{i}} ( {Q}_{i} ( {x}_{i} , {y}_{i} , {a}_{i} ) + λ {w}_{i} ( {x}_{i} , {y}_{i} , {a}_{i} ) ) - λ W , \qquad ( 62 )$$

where the Lagrange multiplier λ is associated with the expected average resource constraint, which is the same as the one in Eq. (42). Once the optimization in Eq. (62) is solved, the Lagrange multiplier is then updated as follows:

$${λ}^{k + 1} = {\{ {λ}^{k} + {α}^{k} ( {lim}_{N \to ∞} \frac{1}{N} {\sum }_{i = 1}^{N} {E}_{{T}_{i} , {D}_{i} , {L}_{i} , {𝒬}_{i} , {C}_{i}} {w}_{i} ( {x}_{i} , {y}_{i} , {a}_{i} ) - W ) \}}^{+} . \qquad ( 63 )$$

Hence, in the following, we focus on the optimization in Eq. (62).

From the assumption presented at the beginning of this section, we note that Tᵢ₊₁−Tᵢ, Dᵢ−Tᵢ, Cᵢ and other attribute of DU i are i.i.d. random variables. Hence, for the independently decodable DUs, if we know the value of Tᵢ, the attributes and network conditions of all the future DUs (including DU i) are independent of the attributes and network conditions of previous DUs. DU i −1 will impact the cross-layer action selection of DU i only through ETX yᵢ₋₁ since xᵢ=max(yᵢ₋₁,tᵢ). In other words, DU i−1 brings forward or postpones the transmission of DU i by determining its ETX yᵢ₋₁. If we define a state for DU i as sᵢ=max(yᵢ₋₁−tᵢ,0), then, the impact from previous DUs is fully characterized by this state. Knowing the state sᵢ, the cross-layer optimization of DU i is independent of the previous DUs. This observation motivates us to model the cross-layer optimization for the time-varying DUs as a MDP in which the state transition from state sᵢ to state sᵢ₊₁ is determined only by the ETX yᵢ of DU i and the time tᵢ₊₁ DU i+1 is ready for transmission, i.e. sᵢ₊₁=max (yᵢ−tᵢ₊₁, 0). The action in this MDP formulation is the STX xᵢ, ETX yᵢ and the action aᵢ. The STX is automatically set xᵢ=max(yᵢ₋₁−tᵢ). The immediate cost by performing the cross-layer action is given by Qᵢ(xᵢ,yᵢ,aᵢ)+λwᵢ(xᵢ,yᵢ,aᵢ).

Given the resource price λ, the optimal policy (i.e. the optimal cross-layer action at each state) for the optimization in Eq. (62) satisfies the dynamic programming equation, which is given by

$$V ( s ) = {E}_{D , L , 𝒬 , C , T} \{ {{{max}_{x = s + t}}_{y < D}}_{a ∈ A} [ \begin{matrix}Q ( x , y , a ) + λ w ( x , y , a ) + \\ V ( max ( y - T , 0 ) )\end{matrix} ] \} - β \qquad ( 64 )$$

where V (S) represents a state-value function at state s, which evaluates the accumulated total cost for all future DUs starting from a state s; and the difference V(s)−V(0) represents the total impact that the previous DU impose on all the future DUs by delaying the transmission of the next DU by s seconds; t is the time the current DU is ready for transmission; and β is the optimal average cost. It is easy to show that V(S) is a non-decreasing function of s because the larger the state s, the larger the delay in transmission of the future DUs, and therefore the larger the distortion.

There is a well-known relative value iteration algorithm (RVIA) for solving the dynamic programming equation in Eq. (64), which is given by

$${V}_{n + 1} ( s ) = {E}_{D , 𝒬 , L , C , T} \{ {max}_{x = s + t , y < D , a ∈ A} [ Q ( x , y , a ) + λ w ( x , y , a ) + {V}_{n} ( max ( y - T , 0 ) ) ] \} - {V}_{n} ( 0 ) \qquad ( 65 )$$

where Vₙ(·) is the state-value function obtained at the iteration n.

### 2. Comparison of the Solutions to CK-CLO and ICK-CLO

In this section, we discuss the similarity and difference between the solutions to CK-CLO and ICK-CLO. We note that both solutions are based on the duality theory and solve dual problems instead of the original constrained problems. Hence, both solutions use the resource price to control the amount of resource used for each DU.

In the CK-CLO problem, the solution is obtained assuming complete knowledge about the DUs' attributes and the experienced network conditions, which is not available for the ICK-CLO problem. Hence, in the DUCLO for the CK-CLO problem, the impact on the neighboring DUs is fully characterized by scalar numbers μᵢ₋₁ and μᵢ. The cross-layer action selection for each DU is based on the assumption that the cross-layer actions for neighboring DUs (previous and future DUs) are fixed. However, in the RVIA for the ICK-CLO problem, the cross-layer action selection for each DU is based on the assumption that the cross-layer actions for the previous DUs are fixed (i.e. the sate s is fixed) and the future DUs (and the cross-layer actions for them) are unknown. The impact from the previous DUs is characterized by the state s and the impact on future or subsequent DUs is characterized by the state value function V(s).

Hence, the solution to the CK-CLO problem cannot be generalized to the online DUCLO which has no exact information about the future DUs. However, the solution to the ICK-CLO problem can be easily extended to the online cross-layer optimization for each DU, since it takes into account the stochastic information about the future DUs once it has the state value function V(s). In the next section, we will focus on developing the learning algorithm for updating the state-value function V(s).

### 3. Online Cross-Layer Learning

In this section, we develop an online learning to update the state-value function V(s) and the resource price λ. Assume that, for DU i, the estimated state-value function and resource price are denoted by Vᵢ(s) and λᵢ, then the cross-layer optimization for DU i+1 given by

$${min}_{{x}_{i} , {y}_{i} , {a}_{i}} {Q}_{i} ( {x}_{i} , {y}_{i} , {a}_{i} ) + {λ}_{i} {w}_{i} ( {x}_{i} , {y}_{i} , {a}_{i} ) + {V}_{i} ( max ( {y}_{i} - {t}_{i + 1} , 0 ) ) \\ s . t . {x}_{i} = {s}_{i} + {t}_{i} , {y}_{i} \leq {d}_{i} , {a}_{i} ∈ A \qquad ( 66 )$$

A state value function Vᵢ(sᵢ) is a function mapping a state sᵢ of data unit i to the total impacts of the current data unit i to subsequent data units. The state sᵢ can be any parameters that capture necessary information for performing current cross-layer optimization for data unit i and satisfy the Markov property. One example of state sᵢ is an amount of transmission time of data unit i occupied by previous data unit and is computed as sᵢ=max(yᵢ₋₁−tᵢ,0). The state-value function comes from the Bellman's equation:

$$V ( s ) = {{{max}_{x = s + t}}_{y < D}}_{a ∈ A} \{ {E}_{D , L , 𝒬 , C , T} [ \begin{matrix}Q ( x , y , a ) + λ w ( x , y , a ) + \\ V ( max ( y - T , 0 ) )\end{matrix} ] \} - β$$

which is the solution to the cross-layer optimization with incomplete knowledge, β is the optimal average cost, and Tᵢ,Dᵢ, Lᵢ,Zᵢ, Cᵢ are random versions of the time the DU is ready for transmission, delay deadline, data unit size, distortion impact and network condition, respectively.

The state-value function represents an estimation of the total cost of all future data units. The state-value function can be stored using look-up table. Each entry of the table is updated as follows:

$${V}_{i + 1} ( s ) = \{ \begin{matrix}{V}_{i + 1} ( {s}_{i} ) = ( 1 - {γ}_{i} ) {V}_{i}^{old} ( {s}_{i} ) & if s = {s}_{i} \\ + {γ}_{i} \{ {V}_{i}^{new} ( {s}_{i} ) \} & \\ {V}_{i} ( s ) & if s \neq {s}_{i}\end{matrix} ,$$

where Vᵢ^{old} is the state-value estimated before the data unit i, and Vᵢ^{new} is the state-value estimated based on the transmission of data unit i. The initial value of V₀(s₀) can be any positive real number. sᵢ is the state that data unit i experiences and s is the possible state that data unit can experience. Vᵢ(s) is the state-value function of data unit i evaluated at the state s. The parameter γⱼ is a positive real number satisfying the following conditions:

$${\sum }_{j = 1}^{∞} {γ}_{j} = ∞ , {\sum }_{j = 1}^{∞} {( {γ}_{j} )}^{2} < ∞ .$$

One example of γⱼ is γⱼ=1/j.

This optimization can be solved as in the off-line scenario discussed earlier. The remaining question is how we can choose the right price of resource λᵢ when DUi is transmitted and estimate the state-value function Vᵢ(s).

From the theory of stochastic approximation, we know that the expectation in Eq. (65) can be removed and the state-value function can be updated as follows:

$${V}_{i + 1} ( {s}_{i} ) = ( 1 - {γ}_{i} ) {V}_{i} ( {s}_{i} ) + {γ}_{i} \{ \begin{matrix}{max}_{{x}_{i} = {s}_{i} , {y}_{i} < {d}_{i} , {a}_{i} ∈ A} [ \begin{matrix}{Q}_{i} ( {x}_{i} , {y}_{i} , {a}_{i} ) + \\ λ {w}_{i} ( {x}_{i} , {y}_{i} , {a}_{i} ) + \\ {V}_{i} ( max ( {y}_{i} - {t}_{i + 1} , 0 ) )\end{matrix} ] - \\ {V}_{i} ( 0 )\end{matrix} \} , \\ and {V}_{i + 1} ( s ) = {V}_{i} ( s ) , if s \neq {s}_{i} \qquad ( 67 )$$

where γᵢ is a learning rate satisfying

$${\sum }_{j = 1}^{∞} {γ}_{j} = ∞ , {\sum }_{j = 1}^{∞} {( {γ}_{j} )}^{2} < ∞$$

and is used to average between the previous estimated state-value function and the new state-value function. We should note that, in this proposed learning algorithm, the cross-layer action of each DU is optimized based on the current estimated state-value function and resource price. Then the state-value function is updated based on the current optimized result. Hence, this learning algorithm does not explore the whole cross-layer action space like the Q-learning algorithm and may only converge to the local solution. However, in the simulation section, we will show that it can achieve the similar performance as the CK-CLO with M=10, which means that the proposed online learning algorithm can forecast the impact of current cross-layer action on the future DUs by updating the state-value function.

Since Vᵢ(s) is a function of the continuous state s, the formula in Eq. (67) cannot be used to update state-value function for each state. To overcome this obstacle, we use a function approximation method to approximate the state-value function by a finite number of parameters. Then, instead of updating the state-value function at each state, we use the formula in Eq. (67) to update the finite parameters of the state-value function. Specifically, the state-value function V(s) is approximated by a linear combination of the following set of feature functions:

$$V ( s ) \approx \{ \begin{matrix}{\sum }_{k = 1}^{K} {r}^{k} {v}^{k} ( s ) & if s \geq 0 \\ 0 & o . w .\end{matrix} \qquad ( 68 )$$

where r=[r¹, . . . , r^{K}]′ is the parameter vector; v(s)=[v¹(s), . . . , v^{K}(s)]′ is a vector function with each element being a scalar feature function of s; and K is the number of feature functions used to represent the impact function. The feature functions should be linearly independent. In general, the state-value function V(s) may not be in the space spanned by these feature functions. The larger the value K, the more accurate this approximation. However, the large K requires more memory to store the parameter vector. Considering that the state-value function V(s) is non-decreasing we choose

$$v ( s ) = {[ {s}^{1} , … , \frac{{s}^{K}}{K !} ]}^{′}$$

as the feature functions. Using these feature functions, the parameter vector r=[r¹, . . . , r^{K}]′ is then updated as follows:

$${r}_{i + 1}^{k} = ( 1 - {γ}_{i} ) {r}_{i}^{k} + {γ}_{i} \{ {max}_{{x}_{i} = {s}_{i} , {y}_{i} < {d}_{i} , {a}_{i} ∈ A} [ \begin{matrix}{Q}_{i} ( {x}_{i} , {y}_{i} , {a}_{i} ) + \\ λ {w}_{i} ( {x}_{i} , {y}_{i} , {a}_{i} ) + \\ {V}_{i} ( max ( {y}_{i} - {t}_{i + 1} , 0 ) )\end{matrix} ] - {V}_{i} ( 0 ) \} / ( {Kv}^{k} ( {s}_{i} ) ) \qquad ( 69 )$$

Similar to the price update discussed earlier, the online update for λ is given as follows:

$${λ}_{i + 1} = {( {λ}_{i} + {k}_{i} ( \frac{1}{i} {\sum }_{j = 1}^{i} {w}_{j} - W ) )}^{+} , \qquad ( 70 )$$

where kᵢ is a learning rate satisfying

$${\sum }_{j = 1}^{∞} {k}_{j} = ∞ , {\sum }_{j = 1}^{∞} {( {k}_{j} )}^{2} < ∞ , {lim}_{j \to ∞} \frac{{k}_{j}}{{γ}_{j}} = 0.$$

In Eqs. (69) and (70), iterating on the state-value function V(y) and the resource price λ at different timescales ensures that the update rates of the state-value function and resource price are different. The resource price is updated on a slower timescale (lower update rate) than the state-value function. This means that, from the perspective of the resource price, the state-value function V(y) appears to converge to the optimal value corresponding to the current resource price. On the other hand, from the perspective of the state-value function, the resource price appears to be almost constant.

A cross-layer operation process based on equation (71) is now described. Given the Lagrange multipliers λᵢ, the DUCLO based on equation (72) is given as:

$${min }_{{x}_{i} , {y}_{i}} {min }_{{a}_{i}} {Q}_{i} ( {x}_{i} , {y}_{i} , {a}_{i} ) + {λ}_{i} {w}_{i} ( {x}_{i} , {y}_{i} , {a}_{i} ) + {V}_{i} ( max ( {y}_{i} - {t}_{i + 1} , 0 ) ) \\ s . t . {x}_{i} = {s}_{i} + {t}_{i} , {y}_{i} \leq {d}_{i} , {a}_{i} ∈ A \qquad ( 73 )$$

The inner optimization in Eq. (47) is performed at the lower layer and aims to find the optimal transmission action a*ᵢ, given STX xᵢ and ETX yᵢ. This optimization is referred to as

LOWER_OPTIMIZATION:

$$f ( {x}_{i} , {y}_{i} ) = {min}_{{a}_{i} ∈ A} {Q}_{i} ( {x}_{i} , {y}_{i} , {a}_{i} ) + {λ}_{i} {w}_{i} ( {x}_{i} , {y}_{i} , {a}_{i} ) \qquad ( 74 )$$

The LOWER_OPTIMIZATION requires information of prospective scheduling time (xᵢ,yᵢ), and expected distortion Qᵢ(xᵢ,yᵢ,aᵢ), which takes into account of attributes including distortion impact qᵢ and DU size lᵢ (both of which may be calculated by the upper layer), and information of transmission actions aᵢ and price of resource λᵢ, which may be obtained at the lower layer.

The outer optimization in Eq. (47) is performed at the upper layer and aims to find the optimal STX xᵢ and ETX yᵢ, given the solution to the lower optimization in Eq. (48). This optimization is referred to as the

UPPER_OPTIMIZATION:

$${min}_{{x}_{i} , {y}_{i}} f ( {x}_{i} , {y}_{i} ) + {V}_{i} ( max ( {y}_{i} - {t}_{i + 1} , 0 ) ) \\ s . t . {x}_{i} = {s}_{i} + {t}_{i} , {y}_{i} \leq d \qquad ( 75 )$$

The UPPER_OPTIMIZATION requires information of ƒ(xᵢ,yᵢ), which can be interpreted as the best response to (Xᵢ,yᵢ) performed at the lower layer.

Hence, given the message {qᵢ,lᵢ,xᵢ,yᵢ}, the LOWER_OPTIMIZATION determines an optimal action a*ᵢ and the best response function ƒ(xᵢ,yᵢ) associated with the lower layer. Given the function ƒ(xᵢ,yᵢ), the UPPER_OPTIMIZATION determines optimal STX x*ᵢ and ETX y*ᵢ.

The algorithm for the exemplary cross-layer online optimization using learning is illustrated in Algorithm 4

Algorithm 4: online optimization using learning

Initialize λ₁, r₁ = 0, s₁ = 0, i = 1
For each DU i

Observe attributes and network condition of DU i and the time tᵢ₊₁ at

which DU i + 1 is ready for transmission;

Layered solution to the DUCLO given in Eq. (66);
Update Sᵢ₊₁ = max(yᵢ −tᵢ₊₁, 0), λᵢ₊₁ as in Eq. (70) and rᵢ₊₁

as in Eq. (69);

i ← i + 1

End

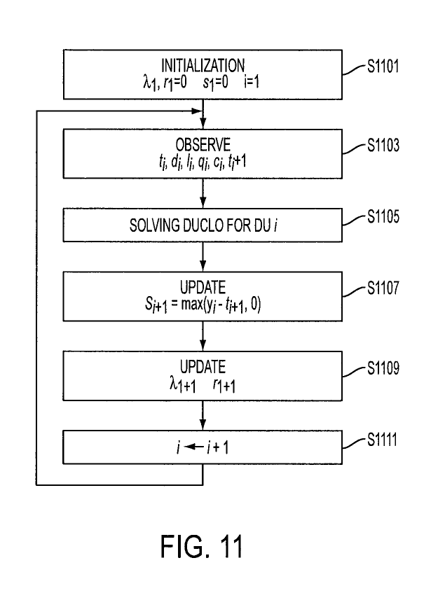

A flow chart showing the operation for online optimization using learning is provided in FIG. 11. Optimization of transmission parameters for each data unit is performed on the fly. As shown in FIG. 11, in step S1101, initial values are provided for various parameters for outer iteration. In Step S1103, the exemplary node obtains various parameters related to network dynamics, such as random versions of the time the DU is ready for transmission, the time the next DU is ready for transmission, delay deadline, data unit size, distortion impact and network condition. A function estimating expected distortions from network dynamics is formulated.

In Step 1105, DUCLO for the respective data unit is solved according to discussions related to equation (66). After optimal scheduling parameters are obtained, the system updates sᵢ₊₁=max(yᵢ−tᵢ₊₁,0), λᵢ₊₁ as in Eq. (70) and rᵢ₊₁ as in Eq. (69) (Steps S1107, S1109). In Step S1111, steps S1103-S1109 are repeated for the next data unit.

### B. Online Optimization for Interdependent DUs

In this section, we consider the online cross-layer optimization for the interdependent DUs. In order to take into account the dependencies between DUs, we assume that the DAG of all DUs is known a priori. This assumption is reasonable since, for instance, the GOP structure in video streaming is often fixed. When optimizing the cross-layer action (xᵢ,yᵢ,aᵢ) of DU i, the transmission results pₖ(x*ₖ,y*ₖ,a*ₖ) and eₖ(x*ₖ,y*ₖ,a*ₖ) of DUs with index k<i are known. Then, the sensitivity Q′ᵢ(xᵢ,yᵢ,aᵢ) of DU i is computed, based on the current knowledge, as follows:

$${Q}_{i}^{′} ( {x}_{i} , {y}_{i} , {a}_{i} ) = {q}_{i} {p}_{i} ( {x}_{i} , {y}_{i} , {a}_{i} ) {\prod }_{k ≺ i} ( 1 - {e}_{k} ( {x}_{k}^{*} , {y}_{k}^{*} , {a}_{k}^{*} ) ) - ( 1 - {e}_{i} ( {x}_{i} , {y}_{i} , {a}_{i} ) ) ( {\sum }_{{i}^{′} ≻ i} {\tilde{q} }_{{i}^{′}} ( 1 - {\tilde{p} }_{{i}^{′}} ) {\prod }_{{j ≺ {i}^{′}}_{j \neq i}} ( 1 - {\tilde{e}}_{j} ( {x}_{j} , {y}_{j} , {a}_{j} ) ) ) , \qquad ( 76 )$$

where \tilde{q}_{i′}(1−\tilde{p}_{i′}) is the estimated distortion impact of DU i′. The term eₖ(x*ₖ,y*ₖ,a*ₖ) is the error propagation function of DU k<i, which is already known. If i<i, \tilde{e}ⱼ(xⱼ,yⱼ,aⱼ)=eⱼ(x*ⱼy*ⱼ,a*ⱼ), otherwise \tilde{e}ⱼ(xⱼ,yⱼ,aⱼ)=0 by that DU j can be successfully received. In other words, if DU k is transmitted, the transmitted results pₖ(x*ₖ,y*ₖ,a*ₖ) and eₖ(x*ₖ,y*ₖ,a*ₖ) are used, otherwise DU k is assumed to be successfully received in the future.

Similar to the online cross-layer optimization for independent DUs, the online optimization for the interdependent DUs is given as follows:

$$min {Q}_{i}^{′} ( {x}_{i} , {y}_{i} , {a}_{i} ) + {λw}_{i} ( {x}_{i} , {y}_{i} , {a}_{i} ) + {V}_{i} ( max ( {y}_{i} - {t}_{i + 1} , 0 ) ) \\ s . t . {x}_{i} = {s}_{i} + {t}_{i} , {y}_{i} \leq {d}_{i} , {a}_{i} ∈ A \qquad ( 77 )$$

The update of the parameter vector r and the resource price λ is the same as in Eqs. (69) and (70). Cross-layer optimization process for each data unit can be formulated and performed in a manner similar to those discussed earlier relative to online cross-layer optimization for independent DUs.

The above discussions show that the DUCLO for each DU i is solved by LOWER_OPTIMIZATION performed at the upper layer and UPPER_OPTIMIZATION performed at each lower layer. LOWER_OPTIMIZATION is fully characterized with information of the prospective scheduling time (xᵢ,yᵢ) and expected distortion associated with the prospective scheduling time. In one embodiment, the expected distortion may be characterized by considering distortion impact qᵢ, DU size lᵢ, information of transmission actions aᵢ, and price of resource. Distortion impact qᵢ and DU size lᵢ may be obtained from the upper layer and information of transmission actions aᵢ and price of resource λ may be obtained at the lower layer. Given the message {qᵢ,lᵢ,xᵢ,yᵢ}, the LOWER_OPTIMIZATION can optimally provide a*ᵢ and the best response function ƒ(xᵢ,yᵢ). Given the function ƒ(xᵢ,yᵢ), the UPPER_OPTIMIZATION tries to find the optimal STX x*ᵢ and ETX y*ᵢ. With the specified message exchange, the exemplary communication node achieves cross-layer optimization of data units of delay-sensitive applications, without violation of the layered architecture.

In the previous descriptions, numerous specific details are set forth, such as specific materials, structures, processes, etc., in order to provide a thorough understanding of the present disclosure. However, as one having ordinary skill in the art would recognize, the present disclosure can be practiced without resorting to the details specifically set forth. In other instances, well known processing structures have not been described in detail in order not to unnecessarily obscure the present disclosure.

Only the illustrative embodiments of the disclosure and examples of their versatility are shown and described in the present disclosure. It is to be understood that the disclosure is capable of use in various other combinations and environments and is capable of changes or modifications within the scope of the inventive concept as expressed herein.

What is claimed is:

1. A communication node in a network system for transmitting multiple data units, the communication node comprising:
a controller configured to operate according to a multi-layer protocol hierarchy including an upper protocol layer and at least one lower protocol layer hierarchically below the upper layer; and the controller is configured to:
for transmitting a respective data unit:
(a) at each of the at least one lower protocol layer:
determine an optimal action that adjusts parameters of the lower protocol layer to achieve optimized performance of the communication node, according to prospective transmission parameters for transmitting the respective data unit; and
(b) generate a best response corresponding to the prospective transmission parameters, wherein the best response represents a result of optimization by taking the optimal action at the lower protocol layer; and
(c) at the upper protocol layer:
determine optimal transmission parameters for transmitting the respective data unit based on the best response; and
initiate transmission of the data unit according to the optimal transmission parameters;
and
a communications device configured to transmit the data unit according to the optimal transmission parameters.

2. The communication node of claim 1, wherein for each respective data unit, the controller calculates a neighboring impact representing an influence from transmission of the respective data unit to transmission of at least one data unit to be transmitted subsequent to the respective data unit.

3. The communication node of claim 2, wherein the controller is further configured to:
calculate a neighboring impact representing an influence to the respective data unit from transmission of a previous data unit to be transmitted prior to the respective data unit;
calculate a neighboring impact representing an influence from transmission of the respective data unit to a subsequent data unit to be transmitted subsequent to the respective data unit; and
determine the optimal transmission parameters for transmitting the respective data unit based on the best response, the neighboring impact from the previous data unit and the neighboring impact to the subsequent data unit.

4. The communication node of claim 1, wherein:
at the lower protocol level, the controller determines the optimal action based on the prospective transmission parameters and expected distortions resulting from the prospective transmission parameters; and
the expected distortions are calculated based on a predefined distortions function and the prospective transmission parameters.

5. The communication node of claim 2, wherein:
attributes describing characteristics of the data units are known;
the controller is configured to calculate optimal transmission parameters of each of the data units through at least one iteration;
in each iteration, the controller calculates a complete set of optimal transmission parameters for all data units;
after each iteration, the controller updates the neighboring impact and a resource price representing an assessment of consumption of system resource at the layer, associated with the calculated transmission parameters of the data units.

6. The communication node of claim 5, wherein the attributes include at least one of a delay deadline, a distortion impact from the loss of each data unit, data units available for transmission, and size information of each data unit for transmission.

7. The communication node of claim 1, wherein the controller assigns the calculated optimal transmission parameters as the prospective transmission parameters and repeat steps (a) through (c).

8. The communication node of claim 1, wherein the transmission parameters include scheduling parameters specifying a starting time for transmitting each data unit and an ending time for transmitting each data unit.

9. The communication node of claim 1, wherein:
the data units include a group of interdependently decodable data units;
attributes describing characteristics of the data units are known; and
the controller, for transmitting interdependently decodable data unit in the group, is configured to:
at each of the at least one lower protocol layer:
for each respective interdependently decodable data unit, determine the best response and the optimal action of the lower protocol layer according to (1) the prospective transmission parameters for transmitting the interdependently decodable data unit determined by the upper protocol layer, and (2) preset prospective transmission parameters for transmitting other interdependently decodable data unit in the group;
and
at the upper protocol layer:
determine the optimal transmission parameters for transmitting the interdependently decodable data unit based on the determined best response; and
initiate transmission of the interdependently decodable data unit according to the optimal transmission parameters.

10. The communication node of claim 9, wherein the attributes of the data units include at least one of a delay deadline, a distortion impact from the loss of each data unit, data units available for transmission, and size information of each data unit for transmission.

11. The communication node of claim 9, wherein for each group of two consecutive data units, the controller calculates a neighboring impact representing an influence from transmission of a first data unit of the group to a second data unit subsequent to the first data unit.

12. The communication node of claim 11, wherein the controller is further configured to:
calculate a neighboring impact to the respective data unit from transmission scheduling of a previous data unit to be transmitted prior to the respective data unit;
calculate a neighboring impact from transmission scheduling of the respective data unit to a subsequent data unit to be transmitted subsequent to the respective data unit; and
determine the optimal transmission parameters for transmitting the respective data unit based on the best response, the neighboring impact from the previous data unit and the neighboring impact to the subsequent data unit

13. The communication node of claim 12, wherein the optimal transmission parameters are determined based on the best response, the neighboring impact from the previous data unit, the neighboring impact to the subsequent data unit, information of interdependencies with other data units, and values of error propagation functions and functions of lost probability for all data units connected to the respective data unit.

14. The communication node of claim 9, wherein the transmission parameters include scheduling parameters specifying a starting time for transmitting each data unit and an ending time for transmitting each data unit.

15. The communication node of claim 1, wherein:
for each respective data unit, the optimal transmission parameters are determined on the fly without knowing complete attributes describing characteristics of data units to be transmitted subsequent to the respective data unit; and
the controller, at the higher layer, determines the optimal transmission parameters for transmitting the respective data unit based on (1) the best response and (2) an estimation function for estimating an impact to subsequent data units from transmission scheduling of the respective data unit.

16. The communication node of claim 15, wherein the attributes of the data units include at least one of a delay deadline, a distortion impact from the loss of each data unit, data units available for transmission, and size information of each data unit for transmission.

17. The communication node of claim 15, wherein the controller estimates an impact from transmission scheduling of data unit i−1 to transmission scheduling of a subsequent data unit i based on a state sᵢ=max(yᵢ₋₁−tᵢ,0), where yᵢ₋₁ is the time when the transmission of data unit i−1 is completed, and t is the time when data unit i is ready for transmission.

18. The communication node of claim 17, wherein:
the controller, after the optimal transmission parameters are determined:
updates the state according to the optimal transmission parameters;
updates a resource price representing an assessment of consumption of system resource at the layer, associated with the optimal transmission parameters of the data units; and
updates the estimation function according to the optimal transmission parameters and the state.

19. The communication node of claim 17, wherein the estimation function is approximated by a linear combination of feature functions, each feature function is a scalar feature function of the state.

20. The communication node of claim 17, wherein at the lower protocol level, the controller determines the optimal action based on the prospective transmission parameters and expected distortions associated with the prospective transmission parameters.

21. The communication node of claim 15, wherein the transmission parameters include scheduling parameters specifying a starting time for transmitting each data unit and an ending time for transmitting each data unit.

22. A cross-optimization method for transmitting multiple data units in a network system comprising multiple communication nodes, wherein each communication nodes includes a controller operating according to a multi-layer protocol hierarchy including an upper protocol layer and at least one lower protocol layer hierarchically below the upper layer, the method comprising:
for transmitting a respective data unit:
(a) at each of the at least one lower protocol layer:
determining, by the controller, an optimal action adjusting parameters of the lower protocol layer to achieve optimization at the lower layer, according to prospective transmission parameters for transmitting the respective data unit;
(b) generating, by the controller, a best response representing a result of optimization at the lower level by taking the optimal action;
(c) at the upper protocol layer:
determining, by the controller, optimal transmission parameters for transmitting the respective data unit based on the determined best response; and
(d) transmitting, by a communications device, the data unit according to the optimal transmission parameters.
